(19) United States
(12) Patent Application Publication
(10) Pub. No.: US 2023/0332307 A1
(43) Pub. Date: Oct. 19, 2023

(54) SYSTEM AND METHODS FOR LOW-VOLTAGE BIPOLAR HYDROGEN PRODUCTION FROM ALDEHYDES AND WATER

(71) Applicant: IOWA STATE UNIVERSITY RESEARCH FOUNDATION, INC., Ames, IA (US)

(72) Inventors: Wenzhen LI, Ames, IA (US); Hengzhou LIU, Ames, IA (US); Yifu CHEN, Ames, IA (US)

(21) Appl. No.: 18/106,436

(22) Filed: Feb. 6, 2023

Related U.S. Application Data
(60) Provisional application No. 63/330,508, filed on Apr. 13, 2022.

(51) Int. Cl. C25B 11/052; C25B 1/02; C25B 1/50; C25B 9/19; C25B 11/061; C25B 11/031; C25B 11/089; C25B 11/081; C25B 11/054; C25B 11/065

(52) U.S. Cl. CPC C25B 11/052; C25B 1/02; C25B 1/50; C25B 9/19; C25B 11/061; C25B 11/031; C25B 11/089; C25B 11/081; C25B 11/054; C25B 11/065

(57) ABSTRACT

The present disclosure relates to a system for generating hydrogen (H₂) from an aldehyde, where the system comprises an anode comprising a metal-based alloy catalyst, a cathode comprising Ni₂P or Pt/C, and a separator positioned between the anode and the cathode. Also disclosed is a method of producing hydrogen (H₂). This method involves providing a system described herein and adding an aldehyde to the system under conditions effective to produce hydrogen (H₂) from electrocatalytic oxidative dehydrogenation of the aldehyde at the anode and water reduction at the cathode.

This application claims the priority benefit of U.S. Provisional Patent Application Ser. No. 63/330,508, filed Apr. 13, 2022, which is hereby incorporated by reference in its entirety.

This invention was made with government support under CBET1947435 awarded by National Science Foundation and 2021-67021-34650 awarded by United States Department of Agriculture/National Institute of Food and Agriculture. The government has certain rights in the invention.

### FIELD OF THE INVENTION

Disclosed herein are systems and methods for low-voltage bipolar hydrogen production from aldehydes and water.

### BACKGROUND OF THE INVENTION

Hydrogen can serve as an energy carrier in clean, efficient, sustainable, and cost-attractive energy systems (Turner et al., “Renewable Hydrogen Production,” Int. J. Energy Res. 32(5):379-407 (2008)). The full environmental benefit of moving toward a hydrogen society is to realize its production from renewable resources including water or biomass (Navarro et al., “Hydrogen Production Reactions From Carbon Feedstocks: Fossil Fuels and Biomass,” Chem. Rev. 107(10):3952-3991 (2007); Huber et al., “Ni—Sn Catalyst for H2 Production From Biomass-derived Hydrocarbons,” Science 300(5628):2075-2077 (2003)). “Green H₂” produced from renewable energy sources can then be used in fuel cells to supply electricity for stationary and transportation applications (Turner et al., “Renewable Hydrogen Production,” Int. J. Energy Res. 32(5):379-407 (2008)).

Biomass-derived aldehydes are an excellent candidate as the energy and H-source for H₂ production (Navarro et al., “Hydrogen Production Reactions From Carbon Feedstocks: Fossil Fuels and Biomass,” Chem. Rev. 107(10):3952-3991 (2007)). The effectiveness of aldehyde conversion to H₂ depends on the discovery of catalytic/electrocatalytic processes, and catalytic materials to enable such processes. Catalytic H₂ generation from biobased aldehydes can also be accompanied by the production of valuable by-products, such as carboxylic acids. In the past years, the transformation of aldehydes to carboxylic acids along with H₂ evolution was reported from several non-Faradaic reactions, including base—(Ashby et al., “Concerning the Formation of Hydrogen in Nuclear Waste. Quantitative Generation of Hydrogen via a Cannizzaro Intermediate,” J. Am. Chem. Soc. 115(3):1171-1173 (1993); Kapoor et al., “Kinetics of Hydrogen Formation from Formaldehyde in Basic Aqueous Solutions,” J. Phys. Chem. 99(18):6857-6863 (1995)), heterogeneous—(Zhang et al., “Additive-Free, Robust H₂ Production from H₂O and DMF by Dehydrogenation Catalyzed by Cu/Cu₂O Formed In Situ,” Angew. Chem. Int. Ed. 56(28):8245-8249 (2017); Chen et al., “Base-free Hydrogen Generation from Formaldehyde and Water Catalyzed by Copper Nanoparticles Embedded on Carbon Sheets,” Catal. Sci. Technol. 9(3):783-788 (2019); Liang et al., “In situ Generated Electron-deficient Metallic Copper as the Catalytically Active Site for Enhanced Hydrogen Production from Alkaline Formaldehyde Solution,” Catal. Sci. Technol. 9(19):5292-5300 (2019)), and homogeneous-(Heim et al., “Selective and Mild Hydrogen Production Using Water and Formaldehyde,” Nat. Commun. 5(1):1-8 (2014); Trincado et al., “Homogeneously Catalysed Conversion of Aqueous Formaldehyde to H₂ and Carbonate,” Nat. Commun. 8(1):1-11 (2017); Wang et al., “Additive-free Ruthenium-catalyzed Hydrogen Production from Aqueous Formaldehyde With High Efficiency and Selectivity,” ACS Catal. 8(9):8600-8605 (2018); Kar et al., “Catalytic Furfural/5-Hydroxymethyl Furfural Oxidation to Furoic Acid/Furan-2, 5-dicarboxylic Acid with H₂Production Using Alkaline Water as the Formal Oxidant,” J. Am. Chem. Soc. 144(3):1288-1295 (2022)) catalyzed processes (RXN 3, infra). However, these reactions generally require either high concentration of base (>>1 M OH⁻) or elevated temperature (>100° C.) with both aldehyde and H₂O as the proton source in the formation of H₂. The condition of high alkalinity/temperature is prone to favor aldehyde degradation toward humin-based polymers, largely suppressing the selectivity towards desirable acid and H₂ (Kar et al., “Catalytic Furfural/5-Hydroxymethyl Furfural Oxidation to Furoic Acid/Furan-2, 5-dicarboxylic Acid with H₂ Production Using Alkaline Water as the Formal Oxidant,” J. Am. Chem. Soc. 144(3):1288-1295 (2022); May and Biddinger, “Strategies to Control Electrochemical Hydrogenation and Hydrogenolysis of Furfural and Minimize Undesired Side Reactions,” ACS Catal. 10(5):3212-3221 (2020)). Another aldehyde-based chemical process, namely, electroless deposition (ELD) of metals (e.g., Cu, RXN 4, infra) onto conductive or nonconductive substrates, has been applied to recycle metals or develop flexible printed circuits (Kondo et al., Copper Electrodepositionfor Nanofabrication of Electronics Devices. Springer: Vol. 171 (2014); Ghosh, S., “Electroless Copper Deposition: A Critical Review.” Thin Solid Films 669:641-658 (2019); Hsu et al., “Electroless Copper Deposition for Ultralarge-scale Integration,” J. Electrochem. Soc. 148(1):C47 (2001)). This non-Faradaic autocatalytic reaction occurs by reducing metal salts in solutions where the electrons are supplied from the reducing agents, e.g., formaldehyde (HCHO), and H₂ was co-produced through aldehyde oxidation catalyzed by in-situ reduced metallic Cu (Nakahara and Okinaka, “Microstructure and Ductility of Electroless Copper Deposits,” Acta Metall. 31(5):713-724 (1983)). However, due to the non-Faradaic nature of these reactions, they are unsuitable to replace the anodic oxygen evolution reaction (“OER”) for bipolar H₂ generation in the electrolytic cell.

Alternatively, Wang et al. recently reported an electrocatalytic oxidative dehydrogenation (“EOD”) pathway on Cu foam, in which the aldehyde oxidation cogenerated H₂ and carboxylic acid (RXN 1, infra) at anodic potentials near 0 V (vs. RHE) (Wang et al., “Combined Anodic and Cathodic Hydrogen Production from Aldehyde Oxidation and Hydrogen Evolution Reaction,” Nat. Catal. 5(1):66-73 (2022); Wang et al., “Transforming Electrocatalytic Biomass Upgrading and Hydrogen Production from Electricity Input to Electricity Output,” Angew. Chem. Int. Ed. 61(12): e202115636 (2022)). The EOD process is fundamentally distinct from conventional electrochemical oxidation (“ECO”) (RXN 2, infra) of aldehydes, which requires higher anodic potentials and forms acid and protons (Nam et al., “Copper-based Catalytic Anodes to Produce 2, 5-furandicarboxylic Acid, a Biomass-derived Alternative to Terephthalic Acid,” Acs Catal. 8(2):1197-1206 (2018); You et al., “A General Strategy for Decoupled Hydrogen Production From Water Splitting by Integrating Oxidative Biomass Valorization,” J Am. Chem. Soc. 138(41):13639-13646 (2016); Poerwoprajitno et al., “Faceted Branched Nickel Nanoparticles with Tunable Branch Length for High-Activity Electrocatalytic Oxidation of Biomass,” Angew. Chem. Int. Ed. 59(36):15487-15491 (2020); Cha and Choi, “Combined Biomass Valorization and Hydrogen Production in a Photoelectrochemical Cell,” Nat. Chem. 7(4):328-333 (2015); Liu et al., “Paired Electrolysis of 5-(hydroxymethyl) Furfural in Flow Cells With a High-performance Oxide-derived Silver Cathode.” Green Chem. 23:5056-5063 (2021); Bajada et al., “A Precious-Metal-Free Hybrid Electrolyzer for Alcohol Oxidation Coupled to CO₂-to-Syngas Conversion,” Angew. Chem. 132(36):15763-15771 (2020)). Enabled by the facile kinetics of EOD reaction, it can pair with hydrogen evolution reaction (“HER”) at low cell voltages. Despite the successful demonstrations, the fundamental understanding on why Cu is unique to EOD (as compared to other metals, i.e., Pt and Au) remains elusive. Some detailed mechanistic questions remain. For example, in strong alkaline solutions, non-Faradaic Cannizzaro transformation from aldehydes (RXN 5, infra) as a major side reaction cannot be ignored (Birdja and Koper, “The Importance of Cannizzaro-type Reactions During Electrocatalytic Reduction of Carbon Dioxide,” J. Am. Chem. Soc. 139(5):2030-2034 (2017)); however, how it competes with EOD reaction is still unknown. In addition, engineering challenges on the rational design of Cu-based electrocatalysts with higher activity and durability, and development of effective bipolar H₂ production systems with higher rates and lower cost, are needed to address in order to practical implement such process.

Electrochemical, Faradaic Half-Reactions:

EOD: 2R—C [symbol] O+4OH⁻=2R—COO⁻+2H₂O+2e⁻+ [symbol] ₂ (RXN 1)

ECO: R—CHO+3OH⁻=R—COO⁻+2H₂O+2e⁻ (RXN 2)

Thermocatalytic, Non-Faradaic Overall Reactions:

R—C [symbol] O+OH⁻=R—COO⁻+ [symbol] +H(H₂) (RXN 3)

ELD: Cu²⁺+2RCHO+4OH⁻→Cu+2RCOO⁻+2H₂O+H₂ (RXN 4)

Chemical Redox Reaction:

2R—CHO+OH⁻=R—COO⁻+R—CH₂OH (RXN 5)

In addition to producing H₂ from biobased chemicals, water electrolysis is still the most attractive and sustainable approach for future H₂ generations (Turner et al., “Renewable Hydrogen Production,” Int. J. Energy Res. 32(5):379-407 (2008); Buttler and Spliethoff, “Current Status of Water Electrolysis for Energy Storage, Grid Balancing and Sector Coupling Via Power-to-gas and Power-to-liquids: A Review,” Renew. Sustain. Energy Rev. 82:2440-2454 (2018)); however, current water eletrolyzers are limited by their high cost, largely due to the thermodynamically unfavorable and kinetically sluggish OER (You and Sun, “Innovative Strategies for Electrocatalytic Water Splitting,” Acc. Chem. Res. 51(7):1571-1580 (2018); McCrory et al., “Benchmarking Hydrogen Evolving Reaction and Oxygen Evolving Reaction Electrocatalysts for Solar Water Splitting Devices,” J. Am. Chem. Soc. 137(13):4347-4357 (2015)). In addition, the gas crossover between unbalanced gas pressures of cathodic H₂ (two-electron transfer) and anodic 02 (four-electron transfer), can induce explosive H₂/O₂ mixtures, and the produced reactive oxygen species could damage the membranes, leading to safety issues that limited its industrial applications (You et al., “Electrocatalytic and Photocatalytic Hydrogen Evolution Integrated With Organic Oxidation,” Chem. Comm. 54(47):5943-5955 (2018); Feng et al., “A Review of Proton Exchange Membrane Water Electrolysis on Degradation Mechanisms and Mitigation Strategies,” Journal of Power Sources 366:33-55 (2017)). Expensive ion-exchange membranes are commonly used to separate gaseous products (Varcoe et al., “Anion-exchange Membranes in Electrochemical Energy Systems,” Energy Environ. Sci. 7(10):3135-3191 (2014)); nevertheless, developing suitable low-cost, easy-to-manufacture membrane materials is still in need (Varcoe et al., “Anion-exchange Membranes in Electrochemical Energy Systems,” Energy Environ. Sci. 7(10):3135-3191 (2014); Lees et al., “Gas Diffusion Electrodes and Membranes for CO₂ Reduction Electrolysers,” Nat. Rev. Mater. 1-10 (2021)). One strategy to address the above-mentioned problems is to replace OER with ECO of organics (e.g., aldehydes, alcohols, RXN 2, supra) that are thermodynamically favorable and economically more attractive with valuable carboxylic acids being co-produced (Liu and Li, “Recent Advances in Paired Electrolysis of Biomass-derived Compounds Toward Cogeneration of Value-added Chemicals and Fuels,” Curr. Opin. Electrochem. 30:100795 (2021)). Despite significant progress developing organic electrolyzers for H₂ production, the electrolytic voltage of >1.0 V on non-noble metal catalysts is still required (You et al., “A General Strategy for Decoupled Hydrogen Production From Water Splitting by Integrating Oxidative Biomass Valorization,” J. Am. Chem. Soc. 138(41):13639-13646 (2016); Chen et al., “Low-voltage Electrolytic Hydrogen Production Derived From Efficient Water and Ethanol Oxidation on Fluorine-modified FeOOH Anode,” ACS Catal. 8(1):526-530 (2018); Liu et al., “Efficient Electrochemical Production of Glucaric Acid and H₂ Via Glucose Electrolysis,” Nat. Commun. 11(1):1-11 (2020); You et al., “Efficient H₂ Evolution Coupled with Oxidative Refining of Alcohols Via a Hierarchically Porous Nickel Bifunctional Electrocatalyst,” Acs Catal. 7(7):4564-4570 (2017); Zhang et al., “Coupling Glucose-Assisted Cu (I)/Cu (II) Redox with Electrochemical Hydrogen Production,” Adv. Mater. 2104791 (2021)). Moreover, limited by mass transport of organics, the current density is usually <100 mA cm⁻² (You et al., “A General Strategy for Decoupled Hydrogen Production from Water Splitting by Integrating Oxidative Biomass Valorization,” J. Am. Chem. Soc. 138(41):13639-13646 (2016); Liu and Li, “Recent Advances in Paired Electrolysis of Biomass-derived Compounds Toward Cogeneration of Calue-added Chemicals and Fuels,” Curr. Opin. Electrochem. 30:100795 (2021)), severely restricting their industrial-relevant applications.

The present disclosure is directed to overcoming limitations in the art.

### SUMMARY OF THE INVENTION

One aspect of the present disclosure relates to a system for generating hydrogen (H₂) from an aldehyde, where the system comprises an anode comprising a metal-based alloy catalyst, a cathode comprising Ni₂P or Pt/C, and a separator positioned between the anode and the cathode.

Another aspect of the present disclosure relates to a method of producing hydrogen (H₂). This method involves providing a system comprising an anode comprising a metal-based alloy catalyst; a cathode comprising Ni₂P or Pt/C; and a separator positioned between the anode and the cathode. An aldehyde is added to the system under conditions effective to produce hydrogen (H₂) from electrocatalytic oxidative dehydrogenation of the aldehyde at the anode and water reduction at the cathode.

In the present disclosure, the EOD reaction was deep studied, and combined with cathodic hydrogen evolution reaction (HER) for bipolar “green H₂” production at ultra-low cell voltages. Furfural was selected as the model aldehyde for EOD reaction because the conversion of inedible lignocellulose to furfural in the industry was established decades ago, currently on a scale of 0.43 million tons/year (Lange et al., “Furfural—A Promising Platform for Lignocellulosic Biofuels,” ChemSusChem 5(1):150-166 (2021); Mariscal et al., “Furfural: A Renewable and Versatile Platform Molecule for the Synthesis of Chemicals and Fuels,” Energy Environ. Sci. 9(4):1144-1189 (2016), which are hereby incorporated by reference in their entirety). The oxidative carboxylic acid (e.g., 2-furoic acid (2-FA)) is a crucial precursor for renewable polymer polyethylene furanoate (PEF) in drinking bottle manufacturing (Global Plastic Bottles Market-Growth, Analysis, Forecast to (2017-2022) (2016), which is hereby incorporated by reference in its entirety).

Experimental and computational results revealed a reasonable barrier for C—H dissociation on the Cu surface, mainly through a diol intermediate, competing with the Cannizzaro reaction and showing potential-dependent properties. This unique EOD reaction on metallic Cu electrodes can be linked to an autocatalytic reaction by the mixed potential theory (MPT): Cu oxides reduction by aldehydes along with H₂ evolution at the metal-liquid interface. Since EOD reaction on Cu electrode is driven by anodic potentials with onsets as low as ˜0.1 V_{RHE}, a galvanic replacement method was further used to etch Cu foam to create a highly roughed CuAg catalyst to facilitate EOD kinetics. Driven by surface reconstruction and protected by the Ag layers, the catalyst stability was significantly increased during the electrolysis under harsh conditions.

Moreover, a membrane-electrode assembly (“MEA”)-based electrolysis system for bipolar H₂ production with a combined faradaic efficiency (“FE”) of ˜200% was developed. Taking advantage of the facile kinetics on CuAg catalysts and increased mass transport resulting from the porous substrate and rough catalyst layer, the maximum anodic partial current density of H₂ (j_{A-H2}) of 248 mA cm⁻² at cell voltage of 0.4 V was demonstrated. Considering H₂ was co-produced from both cathode and anode without H₂/O₂ mixing issues, an inexpensive, easy-to-manufacture dialysis membrane was demonstrated to separate organic reactant and substitute the costly anion exchange membrane (“AEM”). Techno-economic analysis (“TEA”) suggests the bipolar H₂ production process with co-generation of carboxylic acid could have potential economic feasibilities.

Electrocatalytic oxidative dehydrogenation (EOD) of aldehydes enables ultra-low voltage, bipolar H₂ production with co-generation of carboxylic acid. Herein, is reported a simple galvanic replacement method to prepare CuM (M=Pt, Pd, Au, and Ag) bimetallic catalysts to improve EOD of furfural to reach industrially-relevant current density. The redox potential difference between Cu/Cu²⁺ and a noble metal M/M^{y+} can incorporate noble metal on Cu surface and enlarge its surface area. Particularly, dispersing Pt into Cu (CuPt) exhibits a unique synergistic effect for furfural EOD via efficient C—H cleavage on Cu and favorable furfural binding on Pt. The CuPt anode-based flow electrolyzer achieved a record-high current density of 498 mA cm⁻² for bipolar H₂ production at a low cell voltage of 0.6 V and faradaic efficiency of >80% to H₂. The bimetallic catalysts hold potential for future distributed manufacturing of green hydrogen and carbon chemicals with practical rates and low-carbon footprints.

In addition, Cu-based electrocatalysts were developed by galvanic replacement methods for EOD and achieved highly selective and active H₂ generation under ultra-low anodic potentials versus RHE. The standard potential difference between Cu/Cu^{x+} and MI/M^{y+} (M=Ag, Au, Pd, and Pt) as the driving force fully etched Cu foam substrate and oxidized its surface, resulting in a great increase in the surface roughness. Specifically, dispersing Pt atoms into porous Cu (i.e., CuPt/Cu) exhibited a strong synergistic effect for EOD, which systematically combines Pt's favorable binding of furfural with low activation barrier and Cu's moderate barrier for C—H cleavage and intermediate H binding. As a result, the CuPt/Cu delivers the highest roughness-factor (RF) normalized partial current density of anodic H₂ (RF-j_{A-H}_{₂}) and the maximum j_{A-H}_{₂} of 357 mA cm⁻² at 0.4 V_{RHE} among four bimetallic catalysts. When implementing this CuPt/Cu catalyst into a zero-gap MEA-based flow cell, the high EOD activity enables a bipolar H₂ production to achieve an industrially relevant partial current density of 498 mA cm⁻² at a low cell voltage of 0.6 V. Such a process allows for the faradaic efficiencies (FEs) of both cathodic and anodic H₂ of ˜100%, and a co-generation of 2-FA from the anode.

### BRIEF DESCRIPTION OF THE DRAWINGS

FIGS. 1A-C are graphs showing results of EOD reaction on Cu foam. FIG. 1A shows LSV (2 d cycle) on pre-cleaned Cu foam (1 cm²) with or without 200 mM furfural in 1 M KOH electrolyte. FIG. 1B shows Faradaic efficiency (left y-axis) and passed charge (right y-axis), and FIG. 1C shows product for half-hour electrolysis in 1 M KOH with 200 mM furfural at open circuit voltages or different potentials.

FIGS. 2A-C show comparison of various electrochemical and thermochemical systems of aldehydes oxidation. FIGS. 2A-2B are a schematic illustration showing embodiments of a direct (FIG. 2A) and a Cu(I)/Cu(II) redox-mediated (FIG. 2B) process for electrooxidation of aldehyde toward carboxylic acid without H₂ evolution. FIG. 2C is a schematic illustration of an embodiment of an EOD reaction toward carboxylic acid and H₂ that was catalyzed by metallic Cu. It is unified with a chemical looping reaction: Cu oxides reduction by aldehydes along with H₂ evolution.

FIGS. 3A-H show the results of EOD reaction on CuAg_{glv}/Cu in an H-type cell. FIG. 3A is a schematic illustration of an embodiment of galvanic replacement method and SEM images of Cu foam and as-synthesized CuAg_{glv}/Cu. FIG. 3B shows XRD patterns of Cu foam and as-synthesized CuAg_{glv}/Cu. FIG. 3C shows Cu LM spectrum of as-synthesized CuAg_{glv}/Cu. FIG. 3D shows linear sweep voltammetry (2^{nd} cycle) on Cu-based electrodes, including Cu NPs/Cu, OD-Cu, OD-CuAg_{glv}/Cu, with or without 200 mM furfural in 1 M KOH electrolyte. The current density was normalized on roughness factor (RF). FIG. 3E shows Faradaic efficiency (left y-axis) and passed charge (right y-axis) in 1 M KOH with 200 mM furfural at different applied potentials on CuAg_{glv}/Cu for half-hour electrolysis. The geometric area for the electrode was 1 cm². FIG. 3F-3G show DEMS signals at m/z=2, 3 and 4 via applying a typically pulsed potential of 0.4 V_{RHE} on CuAg_{glv}/Cu electrode. Two deuterated electrolytes were performed: 200 mM furfural in D₂O with 1 M NaOD (FIG. 3F) and furfural-d4 in H₂G with 1 M NaOH (FIG. 3G). FIG. 3H shows H₂ production rate at different cycles of independent half-hour electrolysis among different Cu-based electrodes: OD-Cu, CuAg_{glv}/Cu, and CuAg_{dep}/Cu. Fresh electrolyte was replaced after each half-hour electrolysis. The slopes compared their degradation rate.

FIGS. 4A-B show electrokinetics on CuAg_{glv}/Cu in H-type cell. FIG. 4A shows dependence of partial current density of H₂ on furfural concentration. FIG. 4B shows produced acid from EOD and Cannizzaro reactions at OCV and different anodic potentials for half hours.

FIGS. 5A-D show bipolar H₂ production in the MEA-based flow cells (1 cm² active area). FIG. 5A is a schematic illustration of one embodiment of a flow cell set-up and the reaction equations for bipolar H₂ production. FIG. 5B shows linear sweep voltammetry on different electrodes for different combined reactions. FIG. 5C shows partial current density of H₂ at different cell voltages with 40 ml and 250 ml electrolyte. HER and EOD reaction were conducted on Pt/C and CuAg_{glv}/Cu, respectively (FIG. 5D).

FIGS. 6A-C show bipolar H₂ production in the system with dialysis membrane. FIG. 6A is a schematic illustration of one embodiment of a flow cell with size-exclusive dialysis membrane. FIG. 6B shows a comparison between dialysis membrane and AEM. FIG. 6C shows partial current density of H₂ at different cell voltages with 250 ml electrolyte.

FIG. 7 is a schematic illustration of the experimental setup for EOD of furfural, including the H-type cell for electrochemical tests, on-line GC for H₂ quantification, and HPLC for off-line quantification of furfuryl alcohol, 2-FA and furfural.

FIG. 8 shows SEM images of plain Cu foam.

FIG. 9A-C show results of EOD reaction on Ag foil. FIG. 9A shows results of LSV (2^{nd} cycle) on Ag foil (1 cm²) with or without 200 mM furfural in 1 M KOH electrolyte. FIG. 9B shows Faradaic efficiency (left y-axis) and passed charge (right y-axis), and FIG. 9C shows detected products for half-hour electrolysis in 1 M KOH with 200 mM furfural at 0.4 V_{RHE}.

FIGS. 10A-E show results of EOD reaction on different metal foils/foams. FIG. 10A shows LSV (2^{nd} cycle) on Pd foil, FIG. 10B relates to Pt foil, FIG. 10C relates to Au foil, and FIG. 10D relates to Ni foam with or without 200 mM furfural in 1 M KOH electrolyte. FIG. 10E is a table summarizing the charge and produced H₂ for half-hour electrolysis on different metals.

FIGS. 11A-C show NMR for identification (FIG. 11A, furfural in H₂O; FIG. 11B, furfural in 0.1 M KOH) and quantification of diols at different base solutions (FIG. 11C). ¹H NMR (600 MHz, H₂O+D₂O) δ 9.40 (s, 1H), 7.82 (s, 1H), 7.48 (d, J=3.7 Hz, 1H), 6.66 (dd, J=3.9, 1.9 Hz, 1H).

FIGS. 12A-D show CuOx (50 mg) reduction by aldehydes with H₂ evolution. FIG. 12A shows H₂ production rate and FIG. 12B shows produced product on various Cu-based nanoparticles for half-hour reaction. It is noted that, to avoid the oxidation of Cu NPs under air, the catalyst preparation was operated under inter gas in the glove box. FIG. 12C shows XRD patterns on oxidized Cu NPs before and after chemical looping reaction. The XRD intensity was normalized to Cu(111) peak at ˜43.3°. These H₂ evolution reaction was all conducted in 1 M KOH with 200 mM furfural. FIG. 12D shows DEMS signals for chemical looping reaction on oxidized Cu NPs in the solution with 200 mM furfural in 1 M NaOD and D₂O.

FIGS. 13A-B show CuOx reduction by aldehydes with H₂ evolution on Cu-based electrodes (1 cm²) under OCV. FIG. 13A shows H₂ production rate. FIG. 13B shows XRD spectra of oxidized Cu foam. Unlike the hysteresis behavior of H₂ evolution on copper oxides powders (FIGS. 12A-D), H₂ was instantly evolved when the oxidized Cu foam was contacted with the furfural containing solution, which suggested a much more efficient electron-transfer. This results from the direct electric contact between copper and copper oxides (similar to a heterojunction) with an established electrical connection, which largely avoided a diffusion-controlled reduction of Cu oxides to Cu as seeds at the early stage of the reaction.

FIG. 14 shows Ag₂O (50 mg) reduction by aldehydes with H₂ evolution. The H₂ evolution reaction was conducted in 1 M KOH with 200 mM furfural. It was noticed that H₂ was instantly evolved after adding Ag₂O to the solution, and it was fully evolved with a shorter time than that on CuOx, likely resulting from the more favorable thermodynamic free energy of Ag₂O reduction in aldehyde (Table 5).

FIGS. 15A-E show SEM-EDS analysis of as-synthesized CuAg_{glv}/Cu electrode. FIG. 15A shows SEM image and FIGS. 15B-15E show EDS analysis of the as-synthesized CuAg_{glv}/Cu. It showed a Cu₂O-enriched and metallic Ag broadly distributed micro-porous surface. Combining SEM and EDS, it indicated Ag nanoparticles are mostly distributed underneath the Cu surface. Atomic analysis showed the Cu:O ratio of ˜2:1 in most detected areas, indicating the formation of Cu₂O on the surface.

FIGS. 16A-C show XPS of as-synthesized CuAg_{glv}/Cu electrode. FIG. 16A shows Cu 2p_{3/2}, FIG. 16B shows Auger Cu LM, and FIG. 16C shows Ag 2p spectra on as-synthesized CuAg/Cu foam.

FIG. 17 are images showing HRETM and HAADF-STEM-EDS mapping of CuAg_{glv}/Cu electrode. HRTEM images showed the lattice spacing of Cu and Cu₂O, which agreed with the calculated lattice spacing from Fourier transform (FFT). The HADDF-EDX pattern showed a uniformly distributed Ag (red color) on Cu substrate (green color).

FIGS. 18A-B are graphs showing ex-situ XRD pattern (FIG. 18A) and auger peak of Cu LM spectra of CuAg_{glv}/Cu (FIG. 18B) before and after electroreduction at −0.1 V_{RHE} for 3 min. The reduction of CuAg_{glv}/Cu was performed in the electrolyte with 200 mM furfural in 1 M KOH. After reduction, the intensity of Cu₂O peaks from XRD has decreased. Meanwhile, Cu LM spectra showed a shifted kinetic energy from 916.8 eV to 918.0 eV, also suggesting the surface has been reduced to metallic Cu. Both results indicated the in-situ transformation from a Cu₂O-dominated surface to an oxide-derived CuAg_{glv}/Cu surface.

FIGS. 19A-F show roughness factors on Cu-based electrodes. Cyclic voltammograms (CV, 2^{nd} cycle) on Cu based electrodes: FIG. 19A shows Cu foam, FIG. 19B shows CuAg_{glv}/Cu, FIG. 19C shows OD-Cu, and FIG. 19D shows Cu NPs/Cu. FIG. 19E shows double-layer capacitance (C_{dl}) calculated for Cu-based electrodes at non-Faradaic regions (Note: current densities as a function of scanning rates with the corresponding slope being twice that of the capacitance values). FIG. 19F is a table showing a summary of the roughness factor that was normalized based on the Cu foam.

FIG. 20 is a graph showing products of EOD reaction on CuAg_{glv}/Cu electrode at different potentials for half-hour electrolysis.

FIGS. 21A-B show results of a control experiment of electrolysis of furfuryl alcohol on CuAg_{glv}/Cu electrode. FIG. 21A shows LSV and FIG. 21B shows CA curves on CuAg_{glv}/Cu electrode.

FIGS. 22A-D show EOD reaction on Cu₂O NPs/Cu electrode. FIGS. 22A-22B show SEM images. FIG. 22C shows LSV (2^{nd} cycle) on Cu₂O NPs/Cu and CuAg_{glv}/Cu in 1 M KOH with 200 mM furfural. The current density is normalized on roughness factor (RF). FIG. 22D is a table showing a summary of the results for half-hour electrolysis of furfural on Cu₂O NPs/Cu.

FIGS. 23A-C show characterizations and reaction activities on CuAg_{glv}/Cu that were prepared from various precursor concentrations. FIG. 23A shows XRD pattern. FIG. 23B shows H₂ production rate for half-hour electrolysis. FIG. 23C shows SEM images.

FIG. 24 is a graph showing XRD patterns of CuAg_{glv}/Cu before and after electrolysis at 0.2 V_{RHE}.

FIGS. 25A-B show SEM of OD-Cu before (FIG. 25A) and after (FIG. 25B) electrolysis at 0.2 V_{RHE}.

FIGS. 26A-C show top-down SEM-EDS analysis of CuAg_{glv}/Cu before (FIG. 26A) and after (FIG. 26B, 0.5 h and FIG. 26C, 3.5 h) electrolysis at 0.2 V_{RHE}.

FIGS. 27A-F show XPS analysis of CuAg_{glv}/Cu at different reaction durations, including as-synthesized (FIG. 27A and FIG. 27D), after half-hour electrolysis (FIG. 27B and FIG. 27E), and after 3.5-hour electrolysis (FIG. 27C and FIG. 27F). The shoulder peak appeared at ˜944 eV, suggesting the characteristic “shake up” satellite structure, which is typical for the Cu²⁺ state.

FIG. 28 is a graph showing XPS analysis of CuAg_{glv}/Cu at different reaction durations.

FIG. 29 is a graph showing Pourbiax diagram of Cu (left panel) and Ag (right panel). These images are adapted from the literature (Hans et al., “Physicochemical Properties of Copper Important for its Antibacterial Activity and Development of a Unified Model,” Biointerphases 11(1):018902 (2016), which is hereby incorporated by reference in its entirety).

FIGS. 30A-D show roughness factor of CuAg_{glv}/Cu (FIG. 30A) and OD-Cu (FIG. 30B) after electrolysis. FIG. 30C shows the double-layer capacitance calculated for CuAg_{glv}/Cu and OD-Cu after 3.5 hours and 2.5 hours electrolysis tests using non-Faradaic regions of FIGS. 30A-B (Note: current densities as a function of scanning rates with the corresponding slope being twice that of the capacitance values). FIG. 30D shows roughness factor of CuAg_{glv}/Cu and OD-Cu after electrolysis tests.

FIGS. 31A-F show characterization of CuAg_{dep}/Cu. FIGS. 31A-31C show top-down SEM images. FIG. 31D shows incorporated percentage of Ag probed by ICP-MS in the CuAg_{dep}/Cu electrodes prepared using various precursor [Ag+] at 2 A cm⁻². The total precursor (AgNO₃ and CuSO₄) concentration is kept at 50 mM. FIG. 31E shows cyclic voltammogram (CV) of CuAg_{glv}/Cu foam after 3.5 hours and 2.5 hours electrolysis tests. FIG. 31F shows the double-layer capacitance calculated for CuAg_{glv}/Cu foam after electrolysis tests.

FIGS. 32A-C show characterization of CuAg_{dep}/Cu. FIG. 32A shows XRD pattern and FIGS. 32B-32C show SEM-EDS images.

FIG. 33 shows images of cross-sectional SEM-EDS analysis of as-synthesized CuAg_{glv}/Cu.

FIG. 34 shows images of cross-sectional SEM-EDS analysis of CuAg_{glv}/Cu after 3.5 hour-electrolysis at 0.2 V_{RHE}.

FIG. 35 shows images of cross-sectional SEM-EDS analysis of as-synthesized CuAg_{dep}/Cu.

FIG. 36 shows top-down SEM images of CuAg_{dep}/Cu after 3.5-hour electrolysis at 0.2 V_{RHE}.

FIGS. 37A-D show kinetic isotopic effect (KIE) and Tafel analysis for EOD reaction on CuAg_{glv}/Cu. FIG. 37A shows reaction order fitting for Cannizzaro reaction (furfural-to-2-FA). FIG. 37B shows dependence of partial current density of H₂ on base concentration. FIG. 37C shows produced product for half-hour electrolysis at 0.4 V_{RHE}. FIG. 37D shows Tafel slope of the partial current density of H₂. The data for Tafel analysis was obtained from the LSV curve with a potential range from −0.95 V to −0.84 V_{Ag/AgCl} (0.07 to 0.26 V_{RHE}). In this range, because the ˜100% FE toward H₂, the current density of H₂ is equal to its partial current density.

FIGS. 38A-C show extending EOD reactions to various feedstocks with or without α-H. FIG. 38A shows LSV (2^{nd} cycle) in 1 M KOH with 200 mM of various aldehydes. FIG. 38B shows current density-time profiles and FIG. 38C shows faradaic efficiency (left y-axis) and passed charge (right y-axis) of H₂ at 0.4 V_{RHE} for half-hour electrolysis. The dropped current density is attributed to the consumption of furfural.

FIGS. 39A-B show current density-time profiles in the MEA-based flow cell. The half-hour electrolysis was performed at different cell voltages with 40 ml (FIG. 39A) and 250 ml (FIG. 39B) electrolyte. The anolyte and catholyte were prepared in 1 M KOH solution with and without 250 mM furfural, respectively. The gradually dropped current density is attributed to the consumption of reactant. In particular, at 0.6 V with 40 ml electrolyte, a suddenly decreased current density was observed at around 15 min. When the current density decreased during the consumption of furfural in the 40 ml electrolyte, the voltage drops that attributed to the cathodic HER and solution and membrane resistances were lower, then the anodic partial potentials were higher than the oxidation of Cu to Cu(I), which is unreactive to catalyze EOD reaction. In contrast, when the solution volume was largely elevated to 250 ml, the current density at both 0.4 and 0.6 V_{RHE} became relatively stable during half-hour electrolysis.

FIGS. 40A-D show SEM (FIG. 40A-40C) and XRD patterns (FIG. 40D) on Ni₂P catalyst. XRD pattern can be indexed to the characteristic diffraction peaks of Ni (PDF #04-0850), Ni₂P (PDF #03-0953), and Ni(OH)₂ (PDF #38-0715).

FIG. 41 is a graph showing HER on Ni₂P and Pt/C in a one-compartment cell with a three-electrode configuration. The geometric area of electrode is 1 cm², and the electrolyte is 1 M KOH.

FIG. 42 is a graph showing bipolar H₂ production in the MEA-based flow cell (40 ml electrolyte) with CuAg_{glv}/Cu anode and Ni₂P cathode for half-hour electrolysis. The anolyte and catholyte were prepared in 1 M KOH solution with and without 250 mM furfural, respectively.

FIGS. 43A-B show ECH of furfural on Ni₂P and Pt/C in H-type cell. FIG. 43A shows linear sweep voltammograms. FIG. 43B shows Faradaic efficiency for half-hour electrolysis in 1 M KOH with 250 mM furfural.

FIG. 44 is a graph showing PEIS of the MEA-based flow cell with dialysis membrane. The membrane was treated by storing in 1 M KOH solution with different durations.

FIGS. 45A-D show results of crossover studies on dialysis membrane and AEM. Time-dependent 2-FA (FIGS. 45A-45B) or furfuryl alcohol (FIGS. 45C-45D) concentration in the catholyte that was separated by a cellulose-based dialysis membrane or AEM. The catholyte was 1 M KOH, and anolyte was 1 M KOH with 250 mM 2-FA (FIGS. 45A-45B) or furfuryl alcohol (FIGS. 45C-45D). All crossover experiments were performed in a similar MEA-based flow cell set-up with the Pt/C cathode and CuAg_{glv}/Cu anode under OCV. The permeability was determined by the equation as follow:

$${P}_{s} = \frac{{V}_{C}}{{c}_{A} A} \frac{d {c}_{C}}{dt} = \frac{{D}_{s}}{L}$$

The maximum permeability was obtained from the linear part of the diffusion graph for 2-FA for the dialysis membrane and AEM to be P_{2-FA, max}=5.56×10⁻⁶ cm s⁻¹ and P_{2-FA, max}=2.80×10⁻⁵ cm s⁻¹, respectively. Their diffusion coefficients are D_{s,2-FA}=3.89×10⁻⁸ cm² s⁻¹ and D_{s,2-FA}=1.96×10⁻⁷ cm² s⁻¹. Similarly, these values for furfuryl alcohol are: P_{2-FA, max}=8.74×10⁻⁶ cm s⁻¹ and P_{2-FA, max}=1.05×10⁻⁵ cm s⁻¹. Dₛ, alcohol=6.12×10⁻⁸ cm² s⁻¹ and Dₛ, alcohol=7.33×10⁻⁹ cm² s⁻¹.

FIG. 46 is a schematic illustration of one embodiment of a system for bipolar H₂ production to minimize Cannizzaro reaction.

FIG. 47 is a graph showing results of stability testing in the MEA-based system with dialysis membrane at the cell voltage of 0.4 V. A current drop was observed as a result of furfural consumption from EOD reaction and the competitive Cannizzaro reaction. After refreshing the electrolyte (250 mM furfural in 1 M KOH, 250 ml) each hour, the original performance is almost restored.

FIGS. 48A-H show synthesis and characterization of Cu-based bimetallic catalysts. FIG. 48A is a schematic illustration of synthesis of Cu-M bimetals by a galvanic replacement method. FIG. 48B is an SEM image of Cu foam. FIG. 48C shows XRD patterns, FIG. 48D shows auger Cu LM spectrum, and FIG. 48E shows an SEM image of as-synthesized CuPt/Cu. FIGS. 48F-48G show HR-STEM images of Cu₂O and Pt regions. The inset image is the FFT pattern. HR-STEM images showed the lattice spacing of Cu₂O and Pt, which agreed with the calculated lattice spacing from FFT. FIG. 48H shows HAADF-STEMEDS elemental mapping, which shows Pt (red color) distributed on Cu substrate (green color).

FIGS. 49A-F show EOD performance on Cu-based bimetallic catalysts in the H-type cell. FIG. 49A shows linear sweep voltammetry (2^{nd} cycle) on Cu-based electrodes, including Cu foam and CuM/Cu (M=Ag, Au, Pt, Pd), with or without 200 mM furfural in 1.0 M KOH electrolyte. FIG. 49B shows online GC to detect H₂ from EOD under different experimental conditions. The retention time of H₂ was at around 3 min. FIGS. 49C-49F show Faradaic efficiency and passed charge for half-hour electrolysis on different electrodes: CuAg/Cu, CuAu/Cu, CuPt/Cu, and CuPd/Cu. The electrolyte was 200 mM furfural in 1.0 M KOH.

FIG. 50 is a graph showing comparison of the roughness-factor (RF)-normalized partial current density of H₂ and partial current density of H₂ among different Cu-based bimetallic catalysts.

FIGS. 51A-D show bipolar H₂ production in the MEA-based flow cells. FIG. 51A is a schematic illustration and FIG. 51B is a photograph of one embodiment of the reactor setup. FIG. 51C shows a linear sweep voltammograms of bipolar H₂ production with Pt/C cathode and Cu-based bimetallic anodes. FIG. 51D shows partial current density of anodic H₂ and its faradaic efficiency at the cell voltage of 0.6 V. 250 mM furfural in 1.0 M KOH was the anolyte, and 1.0 M KOH was the catholyte. The electrolyte volume was 250 mL.

FIGS. 52A-E show SEM-EDS of CuPt/Cu catalysts. FIG. 52A shows an SEM image of CuPt/Cu electrode. FIG. 52B shows EDS of the entire region of FIG. 52A. FIGS. 52C-52E show the corresponding elemental mappings of Cu (FIG. 52C), O (FIG. 52D), and Pt (FIG. 52E).

FIGS. 53A-E shows SEM-EDS of CuAu/Cu catalysts. FIG. 53A shows an SEM image of CuAu/Cu electrode. FIG. 53B shows an EDS of the entire region of FIG. 53A. FIGS. 53C-53E show the corresponding elemental mappings of Cu (FIG. 53C), O (FIG. 53D), and Au (FIG. 53E).

FIGS. 54A-E show SEM-EDS of CuAg/Cu catalysts. FIG. 54A shows an SEM image of CuAg/Cu electrode. FIG. 54B shows EDS of the entire region of FIG. 54A. FIGS. 54C-54E show the corresponding elemental mappings of Cu (FIG. 54C), O (FIG. 54D), and Ag (FIG. 54E). This data is adopted from previous work (Liu et al., “Ultra-Low Voltage Bipolar Hydrogen Production from Biomass-Derived Aldehydes and Water in Membrane-Less Electrolyzers,” Energy Environ. Sci. 15:4175-4189 (2022), which is hereby incorporated by reference in its entirety).

FIGS. 55A-E show SEM-EDS of CuPd/Cu catalysts. FIG. 55A shows an SEM image of CuPd/Cu electrode. FIG. 55B shows EDS of the entire region of FIG. 55A. FIGS. 55C-55E show the corresponding elemental mappings of Cu (FIG. 55C), O (FIG. 55D), and Pd (FIG. 55E).

FIGS. 56A-I show characterization of CuPt/Cu catalysts. FIGS. 56A-56C show SEM images. FIG. 56D shows an XRD pattern. FIG. 56E shows XPS Cu 2p_{3/2} and FIG. 56F shows auger Cu LM spectra. FIGS. 56G-56H show cyclic voltammograms (CV, 2^{nd} cycle) on Cu foam and CuPt/Cu. FIG. 56I shows double-layer capacitance (C_{dl}), which was calculated on Cu-based electrodes at non-Faradaic regions (−0.80 V_{RHE}). The roughness factor of CuPt/Cu is 4.9, based on the slope normalization to Cu foam in FIG. 56I.

FIGS. 57A-I show characterization of CuAg/Cu catalysts. FIGS. 57A-57C show SEM images. FIG. 57D shows an XRD pattern. FIG. 57E shows XPS Cu 2p_{3/2}, FIG. 57F shows auger Cu LM, and FIG. 57G shows Ag 2p spectra. FIGS. 57H-57I show cyclic voltammograms (CV, 2^{nd} cycle) on Cu foam and CuPt/Cu. FIG. 57I shows double-layer capacitance (C_{dl}), which was calculated on Cu-based electrodes at non-Faradaic regions (−0.80 V_{RHE}). The roughness factor of CuAg/Cu is 5.8, based on the slope normalization to Cu foam in FIG. 57I.

FIGS. 58A-I show characterization of CuAu/Cu catalysts. FIGS. 58A-58C show SEM images. FIG. 58D shows XRD pattern. FIG. 58E shows XPS Cu 2p_{3/2}, FIG. 58F shows auger Cu LM, and FIG. 58G shows Au 4f spectra. FIGS. 58H-58I show cyclic voltammograms (CV, 2^{nd} cycle) on Cu foam and CuPt/Cu. FIG. 58I shows double-layer capacitance (C_{dl}), which was calculated on Cu-based electrodes at non-Faradaic regions (−0.80 V_{RHE}). The roughness factor of CuAu/Cu is 22.3, based on the slope normalization to Cu foam in FIG. 58I.

FIGS. 59A-I show characterization of CuPd/Cu catalysts. FIGS. 59A-59C show SEM images. FIG. 59D shows XRD pattern. FIG. 59E shows XPS Cu 2p_{3/2}, FIG. 59F shows auger Cu LM, and FIG. 59G shows Ag 2p spectra. FIGS. 59H-59I show cyclic voltammograms (CV, 2^{nd} cycle) on Cu foam and CuPt/Cu. FIG. 59I shows double-layer capacitance (C_{dl}), which was calculated on Cu-based electrodes at non-Faradaic regions (−0.80 V_{RHE}). The roughness factor of CuPd/Cu is 13.1, based on the slope normalization to Cu foam in FIG. 59I.

FIG. 60 shows a schematic illustration of a hydrogen spillover pathway on CuPd/Cu and CuPt/Cu electrodes. Similar hydrogen spillover mechanisms were reported in other electrochemical reactions by using bimetallic catalysts, such as hydrogen evolution reaction (Fu et al., “Hydrogen Spillover-bridged Volmer/Tafel Processes Enabling Ampere-level Current Density Alkaline Hydrogen Evolution Reaction under Low Overpotential,” J. Am. Chem. Soc. 144(13):6028-6039 (2022), which is hereby incorporated by reference in its entirety).

FIGS. 61A-B show HOR on different catalysts. FIG. 61A shows HOR on commercial nanoparticles: Pt/C, Pd/C, Ag/C, and Au/C. FIG. 61B shows HOR on CuPt/Cu and CuAg/Cu electrodes. HOR was conducted in 1.0 M KOH with H₂ purging (100 mL min-).

FIGS. 62A-M show characterization of Cu-based bimetals post-electrolysis. FIGS. 62A-62L) show cyclic voltammograms (CV, 2^{nd} cycle), double-layer capacitance (C_{dl}), and SEM images on CuM/Cu electrodes: CuPt/Cu (FIGS. 62A-62C), CuAg/Cu (FIGS. 62D-62F), CuAu/Cu (FIGS. 62G-62I), and CuPd/Cu (FIGS. 62J-62L). FIG. 62M is a table showing a summary of the roughness factors before and after electrolysis. The electrolysis was conducted at 0.2 V_{RHE} for half-hour.

FIG. 63 is a graph showing current density-time profiles of half-hour electrolysis on four kinds of bimetals.

FIGS. 64A-B show activation energy for EOD on CuPt/Cu at 0.1 V_{RHE}. FIG. 64A shows linear sweep voltammograms of CuPt/Cu in 1.0 M KOH with 200 mM furfural at different temperatures. The geometric area of CuPt/Cu was 1 cm². FIG. 64B shows an Arrhenius plot for EOD on CuPt/Cu at 0.1 V_{RHE}.

FIGS. 65A-H show durability tests in the MEA-based flow cell with four kinds of Cu-based bimetals as anode: CuAg/Cu (FIGS. 65A-65B); CuAu/Cu (FIGS. 65C-65D); CuPt/Cu (FIGS. 65E-65F); CuPd/Cu (FIGS. 65G-65H). The current density-time profiles, and the summary of current density and activity decrease in each 1-hour cycle are shown. The activity decrease percentage is calculated by the equation, as follows:

$$activity decrease percentage = \frac{{i}_{n}}{{i}_{n - 1}}$$

where iₙ and iₙ₋₁ are the current densities at the n and n−1 cycle of 1-hour electrolysis.

FIGS. 66A-F show physical characterization of CuPt/Cu electrode after long-term electrolysis. FIGS. 66A-66B show SEM images. FIGS. 66C-66D show cyclic voltammograms (CV, 2^{nd} cycle) and double-layer capacitance (C_{dl}) on CuPt/Cu electrode. FIGS. 66E-66F show XPS Cu 2p_{3/2} spectra (FIG. 66E) and Ols spectra (FIG. 66F) of CuPt/Cu electrode after long-term electrolysis of 5 cycles of 1-hour tests.

FIGS. 67A-F show physical characterization of CuPd/Cu electrode after long-term electrolysis. FIGS. 67A-67B show SEM images. FIGS. 67C-67D show cyclic voltammograms (CV, 2^{nd} cycle) and double-layer capacitance (C_{dl}) on CuPt/Cu electrode. FIGS. 67E-67F show XPS Cu 2p_{3/2} spectra (FIG. 67E) and Ols spectra (FIG. 67F) of CuPd/Cu electrode after long-term electrolysis of 5 cycles of 1-hour tests.

### DETAILED DESCRIPTION OF THE INVENTION

The present disclosure relates to systems and methods for low-voltage bipolar hydrogen production from aldehydes and water.

One aspect of the present disclosure relates to a system for generating hydrogen (H₂) from an aldehyde, where the system comprises an anode comprising a metal-based alloy catalyst, a cathode comprising Ni₂P or Pt/C, and a separator positioned between the anode and the cathode.

Another aspect of the present disclosure relates to a method of producing hydrogen (H₂). This method involves providing a system comprising an anode comprising a metal-based alloy catalyst; a cathode comprising Ni₂P or Pt/C; and a separator positioned between the anode and the cathode. An aldehyde is added to the system under conditions effective to produce hydrogen (H₂) from electrocatalytic oxidative dehydrogenation (EOD) of the aldehyde at the anode and water reduction at the cathode.

In some embodiments, the system is a membrane-electrode assembly (MEA)-based electrolysis system for bipolar H₂ production.

In some embodiments, the system of the present disclosure is a flow cell with a membrane-electrode-assembly (MEA) configuration. In some embodiments the MEA-based flow cell electrolyzer is a custom-designed flow cell with active surface area of 1 cm² (1×1 cm²) for anode and 6.25 cm² (2.5×2.5 cm²) for cathode. In some embodiments the active surface area of each of the anode and the cathode is 25 cm² (5×5 cm²). In some embodiments, the active surface area of each of the anode and the cathode is about 1 cm², 2 cm², 3, cm², 4 cm², 5 cm², 6 cm², 7 cm², 8 cm², 9 cm², 10 cm², 11 cm², 12 cm², 13 cm², 14 cm², 15 cm², 16 cm², 17 cm², 18 cm², 19 cm², 20 cm², 21 cm², 22 cm², 23 cm², 24 cm², 25 cm², or higher, or any size or range between 1 cm² and 25 cm². In some embodiments, the active surface area of the anode is about 0.5 cm², about 1 cm², about 1.5 cm², about 2 cm², or more, or any size or range between 0.5 cm² and 2 cm². In some embodiments, the active surface area of the cathode is about 6.25 cm² to about 25 cm², about 9 cm² to about 25 cm², about 12.25 cm² to about 25 cm², about 16 cm² to about 25 cm², or about 20.25 cm² to about 25 cm², or any size or range between 6 cm² to 25 cm². In some embodiments, the active surface area of each of the anode and cathode is square in shape, but the active surface area of each of the anode and cathode can have any shape or dimension. In some embodiments, the size of the active surface area of the anode and the cathode is the same. In some embodiments, the size of the active surface area of the anode and the cathode is different from each other. For example, the active surface area of the anode may be smaller in size than the active surface area of the cathode.

In some embodiments, the separator positioned between the anode and cathode is a dialysis membrane or size-exclusion membrane. A dialysis membrane is a semipermeable film containing pores of various sizes. Molecules larger than the pores cannot pass through the membrane, while molecules which are smaller than the pores can pass through the membrane freely. A dialysis membrane is characterized by its molecular-weight cut-off (MWCO), which is determined by the membrane's pore size-range. In some embodiments, the separator is a dialysis membrane comprising a pore size of between about 50 nm to 1 μm, or between about 75 nm to 1 μm, or between about 100 nm to 1 μm, or between about 150 nm to 1 μm, or between about 200 nm to 1 μm, or between about 500 nm to 1 μm.

In some embodiments, the separator is a cellulose-based dialysis membrane with a molecular-weight cut-off (MWCO), the lowest retained molar mass, in the range of 0.1-0.5 kD. It is noted that MWCO is not an accurately defined value, and the diffusion of molecules near the MWCO remains slow, which is suitable for, e.g., furfural (molar mass: 96 g mol⁻¹).

In some embodiments, the separator is not an anion exchange membrane. An anion exchange membrane is a semipermeable membrane generally made from ionomers and designed to conduct anions while being impermeable to gases such as oxygen or hydrogen. Anion exchange membranes are used in electrolytic cells and fuel cells to separate reactants present around the two electrodes while transporting the anions essential for the cell operation. In some embodiments, the system of the present disclosure operates without an anion exchange membrane, and instead uses a much less expensive separator or dialysis membrane.

In some embodiments, the separator comprises an alkaline tolerable material. By alkaline tolerable material it is meant that the material forming the separator maintains or largely maintains its structure in the presence of an alkaline environment, even at elevated temperatures.

In some embodiments, KOH (e.g., 1 M KOH) may be employed as the supporting electrolyte that enables free transport of K⁺ and OH⁻ across the separator, while retaining the aldehyde crossover from anolyte to catholyte.

The resistance of a dialysis membrane may be strongly influenced by a pretreatment process. Thus, in some embodiments, the separator or dialysis membrane undergoes a pretreatment process. Such pretreatment process may involve, among other things, being stored in an electrolyte solution (e.g., 1 M KOH) for time (e.g., 1 h) to increase its conductivity. Such a pretreatment may be carried out to facilitate saturation of ions in pores of the separator or membrane so as to increase its conductivity.

In some embodiments, the anode comprises Copper (Cu). In some embodiments, the anode comprises Silver (Ag). In some embodiments, the anode comprises an alloy of any two or more metals selected from the group consisting of Platinum (Pt), Palladium (Pd), Gold (Au), Copper (Cu), and Silver (Ag).

In some embodiments, the anode comprises a metal foam structure, such as copper (Cu) foam, silver (Ag) foam, or CuAg foam. In some embodiments, the catalyst comprises CuAg/Cu foam. In some embodiments, the catalyst comprises CuPt/Cu foam.

In some embodiments, a galvanic replacement method is used to prepare CuM (M=Pt, Pd, Au, and Ag) bimetallic catalysts to improve EOD. The redox potential difference between Cu/Cu²⁺ and a noble metal M/M^{y+} can incorporate noble metal on Cu surface resulting in a great increase in the surface roughness and enlarging its surface area. In some embodiments, the roughness factor ranges from about 4 to about 25. In some embodiments the roughness factor ranges from about 4 to about 10, from about 4 to about 15, from about 4 to about 20, from about 6 to about 10, from about 6 to about 15, from about 6 to about 20, from about 6 to about 25, from about 8 to about 10, from about 8 to about 15, from about 8 to about 20, from about 8 to about 25, from about 10 to about 15, from about 10 to about 20, from about 10 to about 25, from about 12 to about 15, from about 12 to about 20, from about 12 to about 25, from about 14 to about 15, from about 14 to about 20, from about 14 to about 25, from about 16 to about 20, from about 16 to about 25, from about 18 to about 20, from about 18 to about 25, from about 20 to about 25, or from about 22 to about 25.

In some embodiments, the cathode comprises Ni₂P or Pt/C. The preparation of Ni—P electrodes is described in the literature, and will be familiar to persons of ordinary skill in the art. Modifications to such electrodes may be made to be suitable in the systems and methods of the present disclosure.

In some embodiments, the cathode comprises other materials, such as other types of non-precious metal catalysts for alkaline hydrogen evolution reaction, including Mo-based, Co-based carbide, phosphide, sulfide catalysts, including Mo₂C, MoP, CoP, Co₂S, etc. See Mahmood et al., “Electrocatalysts for Hydrogen Evolution in Alkaline Electrolytes: Mechanisms, Challenges, and Prospective Solutions,” Adv. Sci. 5:1700464 (2018), which is hereby incorporated by reference in its entirety.

In some embodiments, the electrodes (anode and/or cathode) may be formed of a microporous layer configured to increase reactant diffusion effects. The microporous layer may include conductive powders with a particular particle diameter, for example a carbon powder, carbon black, acetylene black, activated carbon, a carbon fiber, fullerene, carbon nanotube, carbon nano wire, a carbon nano-horn, carbon nano ring, or a combination thereof. When used, the microporous layer may be formed by coating a composition including a conductive powder, a binder resin, and a solvent on the electrode substrate. The binder resin may include, for example and without limitation, polytetrafluoroethylene, polyvinylidenefluoride, polyhexafluoropropylene, polyperfluoroalkylvinylether, polyperfluorosulfonylfluoride, alkoxyvinyl ether, polyvinylalcohol, celluloseacetate, a copolymer thereof, or the like. The solvent may include alcohols such as ethanol, isopropyl alcohol, n-propylalcohol, and butanol, water, dimethyl acetamide, dimethylsulfoxide, N-methylpyrrolidone, tetrahydrofuran, or the like. The coating method may include, but is not limited to, screen printing, spray coating, doctor blade methods, gravure coating, dip coating, silk screening, painting, direct writing (e.g., as an ink) and so on, depending on the viscosity of the composition. In some embodiments, a microporous layer is a benefit for mass transport, which may be important for high-current-density electrolysis operation.

Anodes and cathodes of the present disclosure may be comprised of a single layer or more than one layer. In some embodiments the anode and cathode each comprises a single layer. In some embodiments, the anode and cathode each comprises two or more layers. The anode and the cathode may be formed of the same or a different number of layers than each other.

In some embodiments, the method of the present disclosure is carried out under conditions of an overall electrolytic cell voltage of about 0.5 V at 100 m A/cm², or 0.4 V at 100 m A/cm², or 0.3 V at 100 m A/cm², or 0.6 V at 100 m A/cm², or 0.7 V at 100 m A/cm², or 0.8 V at 100 m A/cm², or less than 0.5 V at 100 m A/cm², or less than 0.4 V at 100 m A/cm², or less than 0.6 V at 100 m A/cm², or less than 0.7 V at 100 m A/cm².

In some embodiments, the method of the present disclosure enables bipolar H₂ production that demonstrates a partial current density of about 200 mA cm⁻² to about 500 mA cm⁻² at a cell voltage of about 0.2 V to about 0.6 V. In some embodiments, the partial current density is about 200 mA cm⁻² to about 250 mA cm⁻² at a cell voltage of about 0.2 V to about 0.6 V, about 200 mA cm⁻² to about 300 mA cm⁻² at a cell voltage of about 0.2 V to about 0.6 V, about 200 mA cm⁻² to about 350 mA cm⁻² at a cell voltage of about 0.2 V to about 0.6 V, about 200 mA cm⁻² to about 400 mA cm⁻² at a cell voltage of about 0.2 V to about 0.6 V, or about 200 mA cm⁻² to about 450 mA cm⁻² at a cell voltage of about 0.2 V to about 0.6 V.

In some embodiments, the aldehyde used in the methods and systems of the present disclosure is selected from the group consisting of furfural, 5-hydroxymethylfurfural (HMF), formaldehyde, and acetaldehyde. Other aldehydes are also suitable for use in the methods and systems of the present disclosure including, without limitation, benzaldehyde and glucose (C₅H₁₁O₅CHO).

The above disclosure is general. A more specific description is provided below in the following examples. The examples are described solely for the purpose of illustration and are not intended to limit the scope of the present application. Changes in the form and substitution of equivalents are contemplated as circumstances suggest or render expedient. Although specific terms have been employed herein, such terms are intended in a descriptive sense and not for the purposes of limitation.

### EXAMPLES

### Example 1—Ultra Low-Voltage Bipolar Hydrogen Production from Furfural and Water in Membrane-Less Electrolyzers

Experimental Section

1. Chemicals and Materials

Potassium hydroxide (85%), 5-(hydroxymethyl)furfural (HMF, 99%), furfural (99%), furfural alcohol (FA, 98%), 2-furoic acid (98%), acetaldehyde (≥99.5%), formaldehyde solution (ACS reagent, 37 wt. % in H₂O), urea (98%), NaH₂PO₂·H₂O (99%), ammonium fluoride (99.99%), nickel nitrate hexahydrate (97%), and copper nanoparticles (25 nm) were purchased from Sigma-Aldrich. Acetonitrile (CH₃CN, HPLC grade), platinum foil (0.025 mm thick, 99.9%), nickel foil (0.1 mm thick, 99.5%), palladium foil (0.025 mm thick, 99.9%), gold foil (0.05 mm thick, 99.95%) were purchased from Fisher Scientific. Silver foil (0.5 mm thick, 99.9985%) was purchased from Alfa Aesar. Nickle foam (1.6 mm thick, purity >99.99%, porosity ≥95%) was purchased from MTI corporation. Copper foam (130 ppi, 1 mm thick) was purchased from Taobao. Cu₂O nanoparticles (18 nm, 99.86%) was purchased from US-Nano. Ag₂O nanoparticles (99+%) CuO nanoparticles (97%) were purchased from Acros Organics. Plain carbon cloth was purchased from the Fuel Cell Store. 40 wt. % Pt on Vulcan XC-72 (Pt/C), IrO₂ powder, and RuO₂ powder were purchased from Premetek. A201 anion exchange membrane was purchased from Tokuyama Corp. 1 cm² and 25 cm² water electrolyzer hardware were purchased from Shanghai Keqi Tech. and Dioxide Materials, respectively. Silicon gasket ( 1/16 inch thick) was purchased from McMaster-Carr. H₂ calibration gases (10 ppm, 100 ppm, 1,000 ppm, 5,000 ppm, 10,000 ppm, balance helium) were purchased from Cal Gas Direct. Deionized (DI) water (18.2 MΩ cm, Barnstead™ E-Pure™) was used for all experiments in this work. All electrochemical tests were performed by a Biologic SP-300 potentiostat with a ±2 A/±30 V booster.

2. Electrode Preparation

The copper foam was first sonicated in 2 M HCl solution for 5 min to remove the surface oxide, followed by rinsing and sonicating in DI-water. The cleaned Cu foam was then sonicated (operating frequency 35 kHz, RF-power 90 W) in the solution of AgNO₃ (50 mM) at room temperature for 30 s in order to etch and partially oxidize the Cu surface, and to galvanic exchange Ag with Cu in order to form the as-synthesized CuAg_{glv}/Cu electrode. Finally, an oxide-derived CuAg_{glv}/Cu was obtained from in-situ electroreduction at the potential of −0.1 V_{RHE} for 3 min.

CuAg electrodes from electrodeposition (CuAg_{dep}/Cu) were prepared based on a previous work (Turner et al., “Renewable Hydrogen Production,” Int. J. Energy Res., 32(5):379-407 (2008), which is hereby incorporated by reference in its entirety). The pre-cleaned Cu foam with 1 cm² geometric area was immersed in a 1.5 M H₂SO₄ aqueous solution containing metal-salt precursors (CuSO₄ and AgNO₃). The total precursor concentration is 50 mM, containing X % AgNO₃ and (100-X) % CuSO₄. The electrodeposition was conducted using a three-electrode setup with an Ag/AgCl (KCl sat.) reference electrode and Pt foil counter electrode. The electrodeposition was performed at 2 A cm⁻² for 1 min. Then, the electrode was instantly rinsed with DI-water to avoid galvanic replacement and dried under air.

Oxide-derived Cu (OD-Cu) was synthesized from the electrooxidation, thermal treatment (Navarro et al., “Hydrogen Production Reactions from Carbon Feedstocks: Fossil Fuels and Biomass,” Chem. Rev. 107(10):3952-3991 (2007), which is hereby incorporated by reference in its entirety), followed by a similar in-situ electroreduction as CuAg_{glv}/Cu electrode. Specifically, the pre-cleaned Cu foams were first immersed in a one-compartment three-electrode cell with 3 M NaOH electrolyte as both the cathode and anode. Then, a constant current of 10 mA was applied to oxidize the surface of Cu foam to Cu(OH)₂ for 5 min, followed by cleaning in DI-water and drying in the oven. The dried Cu(OH)₂ was then placed into a ceramic boat and transferred to the tube furnace for heat treatment at 550° C. for 2 h at a ramping rate of 3° C. min⁻¹ under Ar atmosphere. Finally, OD-Cu was obtained from in-situ electroreduction at the potential of −0.1 V_{RHE} for 3 min.

Ni₂P electrode was prepared from a modified method in the literature (Huber et al., “Raney Ni—Sn Catalyst for H₂ Production from Biomass-derived Hydrocarbons,” Science 300(5628):2075-2077 (2003), which is hereby incorporated by reference in its entirety). Ni foam was first cleaned by 6 M HCl and DI-water for 15 min under sonication. Then, a 40 ml solution with 4 mmol NH₄F, 10 mmol urea, and 4 mmol Ni(NO₃)₂·6H₂O was prepared and transferred to a 50 mL Teflon-lined stainless steel autoclave. The hydrothermal growth of the hydroxides on Ni foam was performed at 120° C. for 6 h with a heating rate of 3° C. min⁻¹, followed by sonication in DI-water and drying in the oven at 80° C. Then, the as-synthesized hydroxides and 1.6 g of NaH₂PO₂·H₂O powder were placed at two separate positions in a ceramic boat and transferred to a tube furnace. The NaH₂PO₂·H₂O powder was placed at upstream of the Argon flow. After flushing by Ar for 30 min, the temperature was elevated to 300° C. at a ramping rate of 3° C. min⁻¹ and held at 300° C. for 2 hours under a static Ar atmosphere.

Cu nanoparticles (NPs)/Cu (1 mg_{catalyst} cm⁻²) and Cu₂O NPs/Cu (3 mg_{catalyst} cm⁻²) were prepared by a typical spray-coating method on Cu foam substrate. Pt/C, IrO₂, and RuO₂ (0.5 mg_{catalyst} cm⁻²) were spray-coated on HNO₃-treated carbon cloth substrates. The treatment of carbon cloth was conducted in 67-70 wt. % HNO₃ at 110° C. for 1 h 45 min to improve its hydrophilicity. The catalyst ink was prepared by dispersing nanoparticles in a mixture of DI water and 2-propanol (10 mg_{Ag} mL⁻¹) with added ionomer by ultrasonication. The mass ratio of nanoparticles and ionomer was 4:1. The ink was then airbrushed onto the substrate to the final loadings.

3. CuOₓ Reduction by Aldehydes in the Batch Reactor

Autocatalytic CuOₓ reduction by aldehyde with H₂ production was carried out at room temperature in a gastight reactor for half hour. Specifically, 50 mg of Cu-based nano-powders was suspended in 15 mL of the solution with 200 mM furfural in 1 M KOH, and magnetically stirred at 350 r.p.m. The solution was sparged with Ar during the test to carry the produced H₂ to the online GC for its quantification.

4. Electrochemical Measurements in the H-Type Cell

To perform EOD reaction in an H-type cell, a three-electrode configuration was set up with Ag/AgCl as the reference electrode and Pt foil as the counter electrode. The resistance between the working and reference electrodes was determined by potentiostatic electrochemical impedance spectroscopy (PEIS), and 90% IR-compensation was applied for all electrochemical measurements. The geometric area of the working electrode was 1 cm². Anode and cathode compartments were separated by a Nafion membrane (K⁺ transport). The electrolyte was prepared in 1 M KOH solution, and 15 ml of electrolyte was used in each compartment. It is noted that the prepared furfural-containing electrolyte was conducted electrolysis instantly, in order to avoid its degradation to humins and minimize the side Cannizzaro reaction in the alkaline medium.

Linear sweep voltammetry (LSV) and chronoamperometry (CA) tests were conducted under a constant Ar flow through the catholyte for deaeration and online analysis of evolved H₂ by gas chromatography (GC). LSV was carried out without magnetic stirring at 10 mV s⁻¹. During CA tests, the catholyte and anolyte were stirred by PTFE-coated magnetic bars (20×6 mm, Chemglass Life Sciences) at 350 r.p.m. Potentials versus RHE relative to those versus Ag/AgCl was calculated by:

E_{RHE}=E_{Ag/AgCl}+0.197 V+0.059 V×pH.

5. Electrochemical Measurements in the MEA-Based Flow Electrolyzer

The flow electrolyzer contains two stainless steel flow-field plates with serpentine channels (1 cm² active surface area), PTFE and silicone gaskets, and the MEA, which contains two electrodes and a membrane, and was formed after assembling the cell hardware. The catholyte and anolyte were circulated by a peristaltic pump (Masterflex® L/S®) at 10 ml min-. The applied potential or current was controlled by a Biologic SP-300 potentiostat/galvanostat. The membrane used to separate catholyte and anolyte was anion exchange membrane (A201) or dialysis membrane (Biotech CE Dialysis Trial Kit, MWCO of 0.1-0.5 kD, and thickness of 70 μm; Repligen Inc.).

6. Membrane Characterization

6.1 Permeability

The permeability (Ps) of 2-FA and furfuryl alcohol was determined using the same MEA-based flow cell set-up with a dialysis membrane or AEM to separate the anode and cathode. Anolyte and catholyte were circuited by 1 M KOH solution with or without 250 mM 2-FA or furfuryl alcohol. The 2-FA or furfuryl alcohol concentration in the catholyte was then determined at various time intervals. Subsequently, the permeability of certain chemicals was calculated based on their concentration changes over time using the equation as follows:

$${P}_{s} = \frac{{V}_{C}}{{c}_{A} A} \frac{d {c}_{C}}{dt} = \frac{{D}_{s}}{L}$$

where V_{C} is the volume of the catholyte, L is the membrane thickness, A is the membrane area, t is time, Dₛ is their diffusion coefficient, and c_{A} and c_{C} are the concentration of alcohol or acid in anolyte and catholyte, respectively.

6.2 Calculation of Conductivity and Potential Drops Across the Membrane

Since the dialysis membrane is a porous separator without any ion-selective preference across the membrane, sample molecules larger than the pores are retained on the sample-side of the membrane, while small ions would freely pass through the membrane. KOH in the electrolyte was dissociated into K⁺ and OH⁻ with equal charge; therefore, the conductance is given by the sum of their conductance as follows:

$$Λ = {λ}_{i} = {λ}_{+} + {λ}_{-} = \frac{κ}{{z}_{+} {v}_{+} c} = \frac{κ}{{c}_{equiv}}$$

where λᵢ is the equivalent ionic conductance, with the unit of S cm² equiv⁻¹. K is the conductivity with the unit of S m⁻¹. The equivalent conductance for K⁺ and OH⁻ is 73.52 and 197.6 S cm² equiv⁻¹, respectively (Ashby et al., “Concerning the Formation of Hydrogen in Nuclear Waste. Quantitative Generation of Hydrogen via a Cannizzaro Intermediate,” J. Am. Chem. Soc. 115(3):1171-1173 (1993), which is hereby incorporated by reference in its entirety).

$$Λ = {λ}_{+} = {λ}_{+} + {λ}_{-} = 73.52 + 197.6 = \frac{κ}{{c}_{equiv}}$$

The concentration of 1 M is equal to 1/1000 equiv cm⁻³. Then, substituting into the above equation gives κ=247 mS cm⁻¹ for dialysis membrane. The potential drop (Δϕ) across the membrane is calculated as follows:

$$Δ ϕ = \frac{i L}{κ}$$

where i is the current density (unit: A m⁻²) and L is the thickness of the membrane (unit: m). Therefore, for the dialysis membrane with a thickness of 70 μm and at 300 mA cm⁻², the calculated Δϕ is 8.5×10⁻³ mV.

In comparison, based on the literature (Kapoor et al., “Kinetics of Hydrogen Formation from Formaldehyde in Basic Aqueous Solutions,” J Phys. Chem. 99(18):6857-6863 (1995), which is hereby incorporated by reference in its entirety), the κ value for AME (A201 membrane) is 15-20 mS cm⁻¹. With its thickness of 28 μm and at 300 mA cm⁻², the calculated Δϕ is 5.6×10⁻²−4.2χ 10⁻² mV.

6.3 Water Uptake

The quantification of water uptake for membranes was modified from the literature (Zhang et al., “Additive-Free, Robust H₂ Production from H₂O and DMF by Dehydrogenation Catalyzed by Cu/Cu2O Formed In Situ,” Angew. Chem. Int. Ed. 56(28):8245-8249 (2017), which is hereby incorporated by reference in its entirety). The AEM or dialysis membrane was first stored in 1 M KCl for 24 hours at room temperature. Then, the cleaned membrane was transferred to DI water for additional 24-hour storage at room temperature. Finally, the membrane was soaked in 1 M KOH for 1 hour. After gently removing the surface water by paper tissues, the mass of each hydrated membrane (mₕ, g) was immediately measured by an analytical balance. For another 24-hour drying in the atmosphere, the mass of each dried membrane (m_{d}, g) was tested. The water uptake value can be calculated from the equation as follow:

$$W U ( \% ) = \frac{{m}_{h} - {m}_{d}}{{m}_{d}} \times 100 \%$$

7. Product Analysis

The electrolyte was analyzed by High-Performance Liquid Chromatography (HPLC, Agilent Technologies, 1260 Infinity II LC System) equipped with a variable wavelength detector (Agilent 1260 Infinity Variable Wavelength Detector VL). The column (Bio-Rad Aminex HPX-87H) for analyzing anodic species (including furfural and 2-FA) was operated at 50° C. with a mobile phase of 0.01 M H₂SO₄ at 0.5 ml min⁻¹, and the wavelength of 260 nm was applied. For the quantification of furfuryl alcohol that produced from Cannizzaro reaction, a C18 HPLC column (Gemini® 3 μm, 110 Å, 100×3 mm) was used at 45° C. with a binary gradient pumping method to drive mobile phase containing water and CH₃CN at 0.4 ml min⁻¹ with the wavelength of 225 nm. The CH₃CN fraction was increased from an initial volumetric ratio of 15% to 60% during 5-15 min, and then was decreased to 15% from 17-24 min.

H₂ was quantified by on-line GC (SRI Instrument 8610C MG #3) equipped with HaySep D and MolSieve 5 Å columns and a thermal conductivity detector. The calibration curve was established by analyzing the stanFiguredard calibration gases with different concentrations (10-10,000 ppm).

The GC program was started 2 min after the electrolysis was initiated, and a 4.5-min programmed cycle (including a 4-min running period and a 0.5-min cooling period) was repeated throughout the measurement.

The rate of H₂ generation (r, mol s⁻¹) for each cycle was calculated by the following equation:

r=c×10⁻⁶×[P\dot{v}×10⁻⁶/(RT)]

Where c is the H₂ concentration (ppm); \dot{V} is the volumetric flow rate of the inlet gas (12.5 ml min⁻¹); p is the ambient pressure (p=1.013×10⁵ Pa); R is the gas constant (R=8.314 J mol⁻¹ K⁻¹); Tis the room temperature (293.15 K). The total amount of H₂ (mol) was calculated by integrating the plot of H₂ production rate (mol s⁻¹) vs. reaction time (s) with polynomial curve fitting.

The Faradaic efficiency (FEᵢ) and partial current density of H₂ (j_{H2}) can be calculated by equations as follows:

$$F {E}_{i} = \frac{{n}_{i} {z}_{i} F}{Q} \times 100 \%$$

$${j}_{{H}_{2}} = \frac{Q}{t} \times F E$$

Where n₀ is initial moles of reactant; n is the moles of reactant after electrolysis; nᵢ is the moles of product i; zᵢ is the number of electrons transferred for one product molecule; F is the Faraday constant (96,485 C mol⁻¹); Q is the total charge passed through the electrolytic cell; t is the electrolysis time (s). In particular, the produced 2-FA from the EOD pathway is calculated by subtracting 2-FA that was generated from the Carnizarro pathway (by quantifying furfuryl alcohol) from the total detected 2-FA.

The identification of geminal diols from aldehydes in alkaline media was obtained from ¹H NMR spectroscopy via a Bruker 600 MHz NMR spectrometer (AVIII-600). The samples were prepared by mixing 100 mM furfural-containing electrolyte in various KOH concentrations with D₂O in a volume ratio of 9:1. NMR analysis was conducted using a WATERGATE method for background water peak suppression. The ratio of diols was directly quantified by comparing the H peak in the aldehyde group with other H peaks in the furan rings, and with the H peaks in standard furfural samples without base.

8. Materials Characterization

8.1 Physical Characterization

To physical characterization of materials, X-ray diffraction (XRD) crystallography was carried out on a Siemens D500 X-ray diffractometer with a Cu Kα source (λ=1.5418 Å) at a tube voltage of 45 kV and a tube current of 30 Ma. The scan was performed at a rate of 100 min⁻¹ and a step size of 0.01°. X-ray photoelectron spectroscopy (XPS) was carried out on a Kratos Amicus/ESCA 3400 X-ray photoelectron spectrometer with Mg Kα X-ray (1,253.7 eV). All spectra were calibrated with the C is peak at 284.8 eV. Scanning Electron Microscopy-Energy Dispersive X-ray Spectroscopy (SEM-EDS) was performed on a field-emission scanning electron microscope (FEI Quanta-250) equipped with a light-element X-ray detector and an Oxford Aztec energy-dispersive X-ray analysis system. Inductively coupled plasma-optical emission spectroscopy (ICP-OES) was performed on a PerkinElmer® Optima™ 8000 ICP-OES instrument. Inductively coupled plasma mass spectrometry (ICP-MS) was performed from an Agilent 7700X instrument. Transmission electron microscopy (TEM) samples were prepared by scratching the CuAg/Cu foam surface. The scratched material was dispersed in ethanol and ultrasonicated for 5 min, followed by a drop-casting method. Aberration corrected scanning transmission electron microscopy (STEM) images and energy-dispersive X-ray spectroscopy (EDS) mappings were taken from a Titan Themis 300 probe corrected TEM with a Super-X EDS detector.

8.2 Determination of the Roughness Factor

Surface roughness factors for the electrodes relative to copper foam were determined by measuring double-layer capacitances (C_{dl}). Cyclic voltammetry (CV) was performed in a one-compartment electrochemical cell with 1 M KOH solution in a three-electrode configuration without stirring. The potential range for CV was conducted in the potential regions where no faradaic processes occurred, and the geometric current density difference (Δj) was plotted against different scan rates of CV (20 to 200 mv s⁻¹).

9. Nernstian Equilibrium Shift

Nernst equation can be expressed as follow:

$$E = E ° + \frac{R T}{n F} ln \frac{{a}_{o x}}{{a}_{r e d}}$$

where E⁰ is the standard potential for the full cell at 25° C., E is the actual full cell potential, R is the ideal gas constant, T is the temperature, n is the number of transferred electrons, F is the Faraday constant, aₒₓ is the activity of the oxidized species, and a_{red} is the activity of the reduced species.

To prepare the CuAg_{glv}/Cu from galvanic replacement method, the following reaction occurs:

Cu+2Ag⁺→Cu²⁺+2Ag

When the concentration of the precursor Ag⁺ varied from 1 mM to 200 mM, the Nernstian shift of the equilibrium potential equals:

$$Δ E = \frac{0.059}{2} [ log ( 0. {2}^{2} ) - log ( 0.00 {1}^{2} ) = 0.14 V$$

Thus, varying the concentration of Ag⁻ provided a tunable driving force to etch the Cu surface and create different relative abundance of Cu₂O and surface morphologies.

Results and Discussion

1. Screening Transition-Metal Catalysts for EOD Reaction

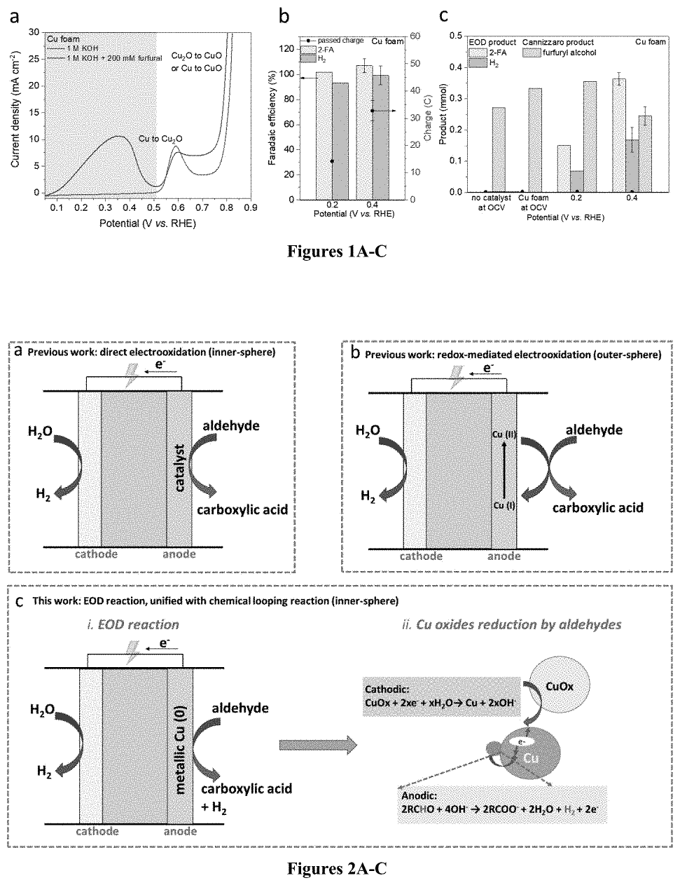

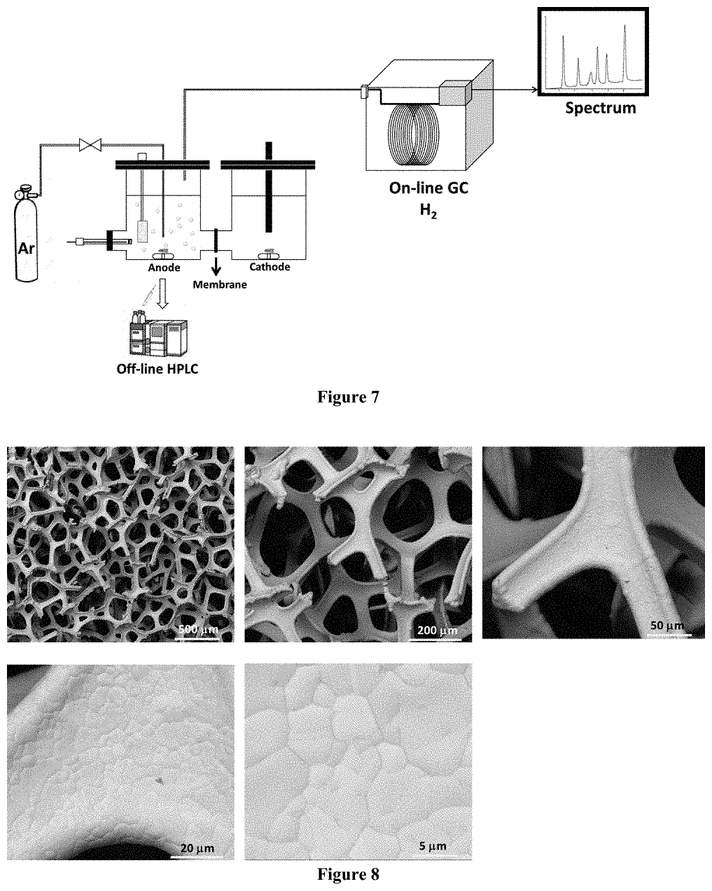

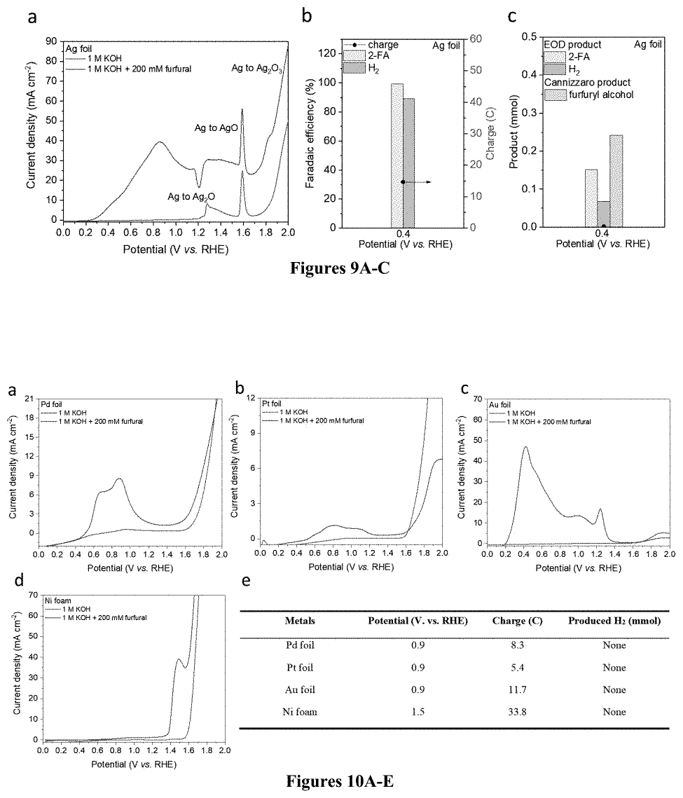

EOD reaction was first studied in a typical H-type reactor with various commercially available metallic foams (FIG. 8) or foils as catalysts (FIG. 7). Linear sweep voltammetry (LSV) was first conducted with and without furfural in 1 M KOH. As shown in FIG. 1A, LSV curves on Cu foam with 200 mM furfural showed an apparent current density in the potential range of 0.1-0.5 V_{RHE}, corresponding to the EOD reaction. Half-hour chronoamperometry (CA, FIG. 1B) tests at 0.2 and 0.4 V_{RHE} (V_{RHE}: potential versus RHE, hereinafter) showed that the production rate ratio of 2-FA to H₂ is close to 2:1, and their FE is both ˜100%, in line with the stoichiometry of EOD equation (RXN 1). A more favorable EOD reaction occurs at relatively more positive potentials before the onset of Cu oxidation, suggesting metallic Cu is the active phase. A similar EOD reaction was observed on the Ag foil with an onset potential of ˜0.3 V_{RHE} (FIGS. 9A-C), positively shifting ˜200 mV compared to the Cu foam. Interestingly, the occurrence of EOD reaction was not observed on other transition metals (Pd, Pt, Au, and Ni, FIGS. 10A-E), because no apparent current density was observed in the relatively low anodic potential regions, and no H₂ was detected by our online-gas chromatography (GC). These results suggested Cu and Ag are unique metal catalysts for EOD reaction.

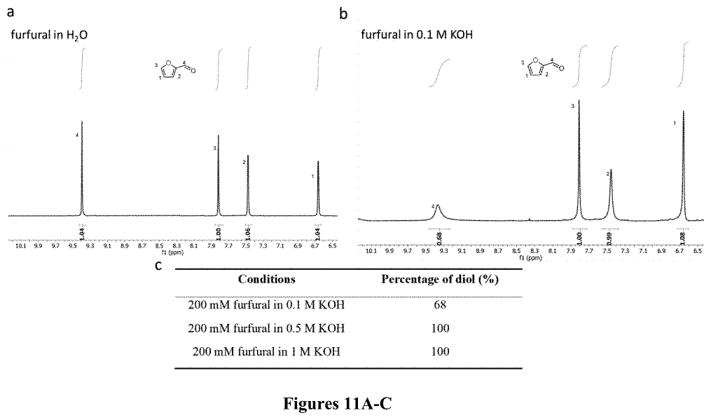

Furfuryl alcohol was also detected in the electrolyte, suggesting its generation from the competing non-Faradaic Cannizzaro pathway. It should be noted that the reported FE and production rate of 2-FA from the EOD pathway has subtracted 2-FA co-produced from Cannizzaro reaction (quantified from the furfuryl alcohol) throughout our work. FIG. 1C showed that Cannizzaro reaction is the only reaction that occurs under open circuit voltage (OCV) without catalysts. Interestingly, the presence of catalysts (i.e., Cu foam at OCV) promoted this non-Faradaic reaction. The use of Ag foil, and Cu and Ag nanoparticles under OCV also confirmed the elevated Cannizzaro reaction rate (FIG. 7). Interestingly, when the applied potential increased from 0.2 to 0.4 V_{RHE} (FIG. 1C), EOD pathway became more favorable suppressing Cannizzaro reaction, this suggested these two reactions might share a common intermediate. NMR was then used to estimate the equilibrium ratio of aldehyde to geminal diols. FIGS. 11A-C show that 68% of furfural existed as its diol form in the 0.1 M KOH solution, and this value approached ˜100% when the base concentration increased to ≥0.5 M. Thus, the diol species, produced from a chemical (or solution-mediated) step by OH⁻ attacking, is the common intermediate involved in both EOD and Cannizzaro reactions. EOD reaction could involve the adsorption of this diol species on the electrode surface followed by the C—H bond cleavage to produce H₂. Table 1 shows Cannizzaro reactions on Cu and Ag nanoparticles and Ag foil. With existence of Cu and Ag, and large surface area, Cannizzaro reactions can be enhanced.

TABLE 1
Cannizzaro reactions on different nanoparticles.^{a}

| | Cannizzaro reaction |
|---|---|
| Conditions | produced 2-FA (mmol) |
| No catalysts | 0.27 |
| Ag foil (1 cm²) | 0.30 |
| 50 mg Cu NPs | 0.72 |
| 50 mg Ag NPs | 0.67 |

^{a}Cannizzaro reactions were conducted at the batch reactor stirred at 350 r.p.m for half hour.

2. Unifying EOD Reaction with the Chemical Looping Reaction Through MPT

It was found that an autocatalytic chemical reaction on metal oxides occurred with a similar half-reaction (as EOD) can generate equivalent H₂ and carboxylic acid. This autocatalytic reaction was performed in a batch reactor with 1 M KOH+200 mM furfural, 50 mg Cu₂O or CuO nanoparticles (NPs) under Ar atmosphere (FIGS. 12A-B). Interestingly, H₂ detected by online GC shows a volcano-type production rate, suggesting copper oxides was consumed during H₂ evolution process. No H₂ was detected in the control experiments with Cu NPs while H₂ detected only when the Cu NPs was intentionally oxidized. XRD confirmed this oxidized Cu was reduced back to its metallic state after the reaction (FIG. 12C), indicating Cu oxides were indeed consumed during H₂ evolution. In addition, the ratio of production rate of 2-FA and H₂ on all oxidized Cu is close to 2:1, consistent with the stoichiometry of EOD reaction. Furthermore, when fully deuterated (D₂O with 1 M NaOD) solution was used, differential electrochemical mass spectroscopy (DEMS) shows only m/z signal of 2, confirming both H atoms in H₂ are from the aldehyde group (FIG. 12D), which is in line with the EOD reaction.

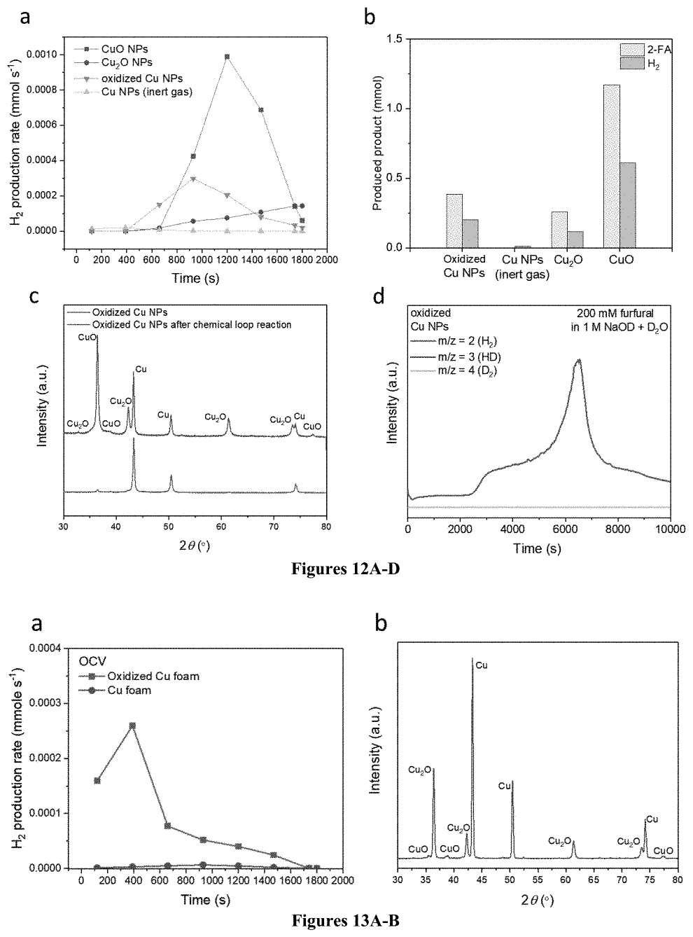

When an oxidized Cu foam was immersed in the electrolyte at OCV state (no anodic potential applied), H₂ spontaneously evolved. The H₂ production rate increased then decreased with progressing time (FIG. 13A). The XRD patterns of the oxidized Cu foam is shown in FIG. 13B.

The autocatalytic H₂ evolution reaction can be linked to the electrocatalytic EOD reaction through the mixed potential theory (MPT) (Bard and Faulkner, “Fundamentals and Applications,” Electrochemical Methods 2(482):580-632 (2001); Ryu et al., “Thermochemical Aerobic Oxidation Catalysis in Water Can Be Analysed as Two Coupled Electrochemical Half-reactions,” Nat. Catal. 4(9):742-752 (2021), which are hereby incorporated by reference in their entirety). From the electrochemical perspective, the complete thermocatalysis cycle (FIG. 2C) resembles a short-circuit fuel cell: the continuous reduction of Cu oxides to Cu particles serves as the cathodic half-reaction; meanwhile, the reduced Cu particles functioned as both the catalysts for aldehyde oxidation along with H₂ evolution (anodic half-reaction), and the conductive substrate for electrons to flow at an equal rate but opposite flux direction. When CuOₓ is contacted with aldehyde, a “mixed potential” between CuOₓ reduction to metallic Cu and aldehyde oxidization to acid along with H₂ evolution occurred on the Cu “electrode”. The effective overall reaction is enabled by the highly conductive properties of these NPs and the electron transfer between the NPs and the adsorbed aldehydes, which drove the overall process to occur and kept a neutral net current on particles. This spontaneously occurred two half reactions in a “short-circuit cell” can be divided into two half electrochemical reactions, while the anodic half-reaction is same as the EOD reaction with the same distribution of products. Both reactions are catalyzed by the metallic Cu and governed by the same thermodynamic formula of μ̅ⱼ=μⱼ+zⱼFϕ (Peng et al., “An Electrified Insight Into the Thermocatalysis in Water,” Joule 5(11):2768-2771 (2021); Adams et al., “Unifying Concepts in Electro- and Thermocatalysis toward Hydrogen Peroxide Production,” J. Am. Chem. Soc. 143(21):7940-7957 (2021), which are hereby incorporated by reference in their entirety).

Both chemical looping reaction and the electrochemical EOD reaction are based on the favorable thermodynamics (Example 2). However, more benefits can be obtained from decoupling reactions in the electrolytic cell. 1) The chemical state of Cu can be well regulated at its Cu(0) state for continuous H₂ generation in an appropriate anodic potential window of an electrolytic cell. 2) Fermi electrons are drawn away from the metals via an external circuit to the cathode, electrochemically driving certain usable reduction reactions to constitute the full cell. For example, EOD-HER combined electrolytic cell for bipolar H₂ production. More interesting, EOD can be coupled with oxygen reduction reaction (ORR) in a Galvanic cell for co-generation of H₂ and electricity (Wang et al., “Transforming Electrocatalytic Biomass Upgrading and Hydrogen Production From Electricity Input to Electricity Output,” Angew. Chem. Int. Ed. 61(12):e202115636 (2021), which is hereby incorporated by reference in its entirety). All of these cathodic half-reactions serve as electron scavengers (e.g., Cu oxides reduction, HER, ORR) that provide an incipient electrochemical driving force for substrate oxidation and maintain redox neutrality of the net reaction (detailed summaries and comparisons are shown in Table 2). It should be noted that the metallic Cu(0) state is the catalytic active phase for C—H bond cleavage to evolve H₂ for both catalytic and electrocatalytic reactions. This is fundamentally different from previous works on electro-oxidation of aldehyde toward acid without H₂ production on high oxidation states of Cu (FIG. 2A) (Nam et al., “Copper-based Catalytic Anodes to Produce 2, 5-furandicarboxylic Acid, a Biomass-derived Alternative to Terephthalic Acid,” Acs Catal. 8(2):1197-1206 (2018); Chen et al., “Cu—Ni Bimetallic Hydroxide Catalyst for Efficient Electrochemical Conversion of 5-Hydroxymethylfurfural to 2, 5-Furandicarboxylic Acid,” ChemElectroChem 6(23):5797-5801 (2019), which are hereby incorporated by reference in their entirety) or through Cu(I)/Cu(II) redox cycling (FIG. 2B) (Zhang et al., “Coupling Glucose-Assisted Cu (I)/Cu (II) Redox with Electrochemical Hydrogen Production,” Adv. Mater. 2104791 (2021); Zhou et al., “Room-temperature Chemical Looping Hydrogen Production Mediated by Electrochemically Induced Heterogeneous Cu (I)/Cu (II) Redox,” Chem. Catal. 1(7):1493-1504 (2021), which are hereby incorporated by reference in their entirety). Specifically, EOD and Cu/CuOₓ chemical looping reactions reported herein show H₂ generation property (FIG. 2C), as compared to the previously reported Cu(I)/Cu(II) redox-mediated reaction without H₂ evolving (FIG. 2B), mainly because the in-situ produced Cu(I) is not active but Cu (0) is active for C—H dissociation, consistent with our experimental and DFT results.

TABLE 2
Summary of different cathodic half-reactions as electron-scavengers.

| Reaction | Types | Cathode | | Anode | | Overall |
|---|---|---|---|---|---|---|
| CuOₓ | galvanic | CuOₓ + | outer-sphere | 2RCHO + | inner- | CuOₓ + 2RCHO + |
| reduction | cell | 2xe⁻ + | (catalyst | 4OH⁻ → | sphere | 2(2 − x)OH⁻ + |
| | | xH₂O→ Cu + | independent) | 2RCOO⁻ + | (catalyst | 2(x − 1)e⁻→ |
| | | 2xOH⁻ | | 2H₂O + | dependent) | Cu + 2RCOO⁻ + |
| | | | | H₂ + 2e⁻ | | (2 − x)H₂O + H₂ |
| EOD-HER | electrolytic | 2H₂O + 2e⁻ | inner-sphere | | | 2RCHO + 2OH⁻ → |
| | cell | → 2OH⁻ + H₂ | (catalyst | | | 2RCOO⁻ + 2H₂ |
| | | | dependent) | | | |
| EOD-ORR | galvanic | O₂ + 2H₂O + | inner-sphere | | | 2RCHO + O₂ → |
| | cell | 4e⁻ → 4OH⁻ | (catalyst | | | 2RCOO⁻ + H₂ |
| | | | dependent) | | | |

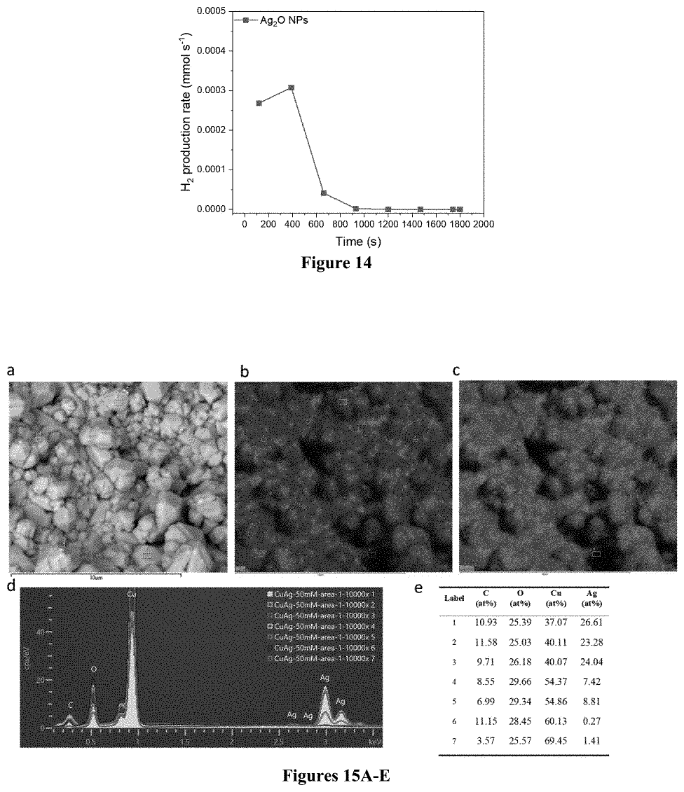

The MPT can also guide one to predict the occurrence of EOD reaction on other metals. As the EOD reaction has been observed on Ag foil (FIGS. 9A-C), it was further found that the occurrence of Ag₂O reduction in aldehyde solutions showing similar H₂ evolution property (FIG. 14). In comparison, the thermodynamic of Pd(II) or Pt (II) reduction by aldehydes along with H₂ evolution is more favorable, however, previous experiments showed these noble metal salts were indeed reduced to their metallic states but without H₂ evolution (e.g., 2R—CHO+Pt(II)→R—COO⁻+Pt+2H₂O) (Zhang et al., “Effect of Synthetic Reducing Agents on Morphology and ORR Activity of Carbon-supported Nano-Pd—Co Alloy Electrocatalysts,” Electrochim. Acta 52(28):7964-7971 (2007), which is hereby incorporated by reference in its entirety). Linked by MPT, this result agreed with the experimental obtained no EOD reaction occurring on Pd and Pt foils (FIGS. 10A-E). This is explained by the DFT work: much higher overpotentials are required to oxidize aldehyde to acid on Pt due to the strong bonding of CO, leading to H generation rather than H₂. Overall, the electrochemical EOD reaction and chemical looping reaction have been unified through the MPT, indicating the surface intermediates involved in electrochemical processes may also be accessible via thermochemical reactions. This finding will help predict and rational design novel electrocatalysts and electrocatalytic processes.

3. Demonstrating an Active and Stable CuAg Catalyst for EOD Reaction

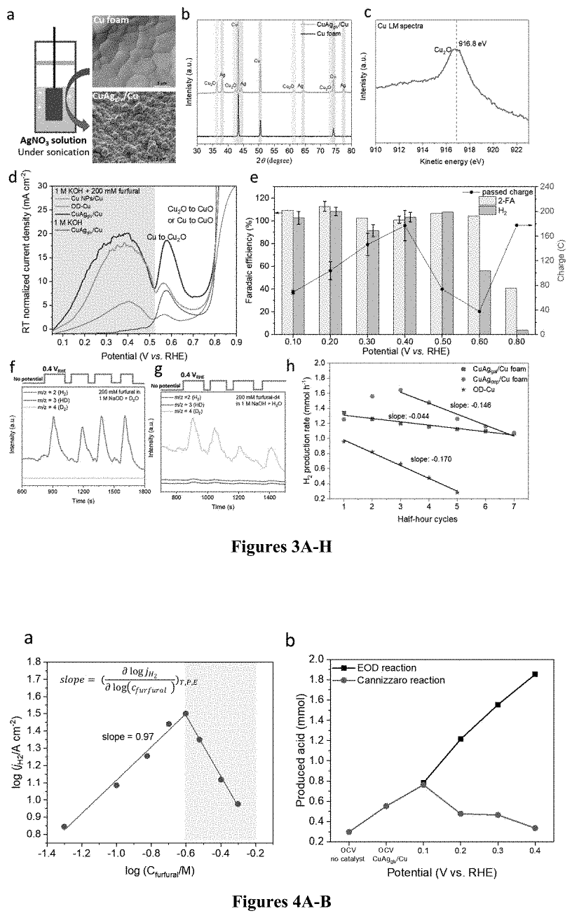

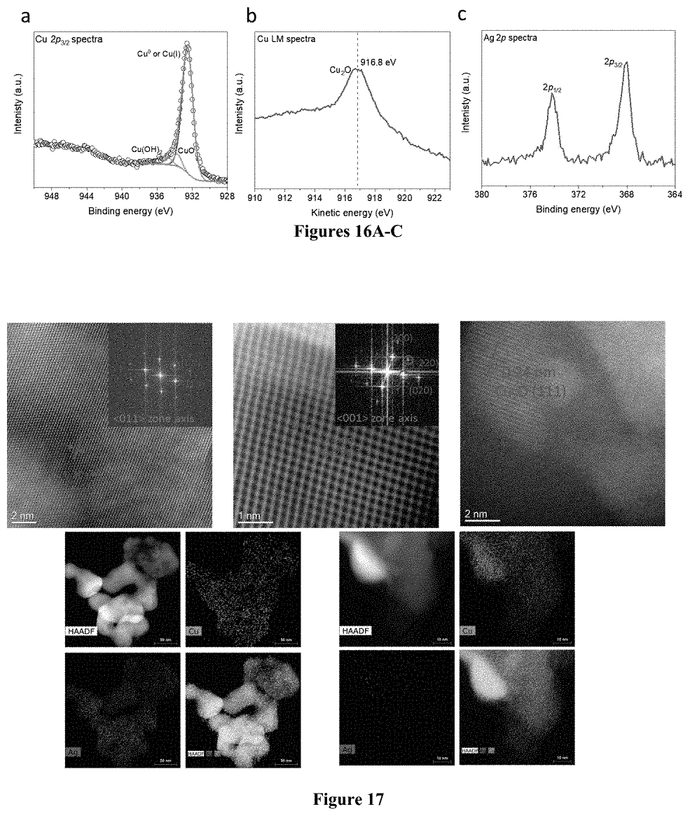

A series of Cu-based catalysts (i.e., oxide-derived Cu (OD-Cu), commercial Cu NPs coated on Cu foam (Cu NPs/Cu), electrodeposited CuAg on Cu foam (CuAg_{dep}/Cu)) were evaluated, and it was found that a Cu-rich, nano-sized, bimetallic CuAg catalyst prepared from a galvanic replacement method (denoted as CuAg_{glv}/Cu) can better facilitate EOD reaction with higher intrinsic activity or stability. The as-synthesized CuAg_{glv}/Cu catalyst was prepared by immersing pre-cleaned Cu foam in AgNO₃ solution under sonication, to create an oxidized nanoporous Cu surface with large area (FIG. 3A) and broadly distributed Ag on and underneath the Cu-rich surface (as shown in EDS, FIGS. 15A-E). It was proposed that the surface roughening is a result of rapid Cu crystal deformation that started from the grain boundaries and defects (Wang et al., “Bimetallic Effects on Zn—Cu Electrocatalysts Enhance Activity and Selectivity for the Conversion of CO2 to CO,” Chem. Catal. 1(3):663-680 (2021), which is hereby incorporated by reference in its entirety). XRD analysis indicated that both metals are polycrystalline with Cu₂O, Cu, and Ag phases (FIG. 3B). XPS Cu LM spectra (FIG. 3C) with a kinetic energy peak at ˜916.8 eV suggested the surface is dominated by Cu₂O species, while Ag 2p spectra showed its metallic state (FIGS. 16A-C). HRTEM and EDS mapping also suggested the uniformly distributed Ag on Cu and a clear phase separation between Ag and Cu₂O (FIG. 17).

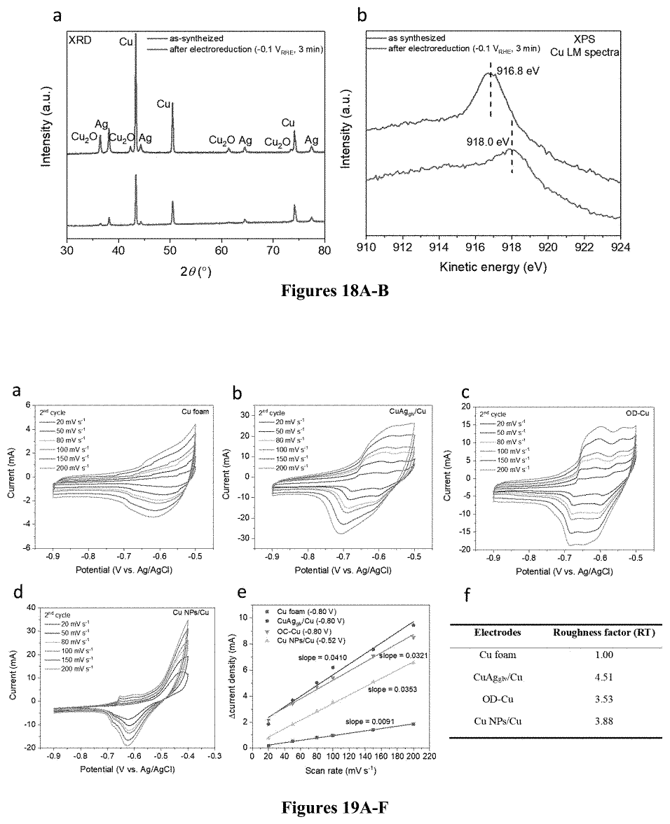

Extensive measurements were conducted on CuAg_{glv}/Cu anode in the three-electrode H-type cell to test its performance for EOD reaction. The as-synthesized CuAg_{glv}/Cu foam was first held at −0.1 V_{RHE} for 3 min to in-situ reduce surface Cu₂O back to metallic Cu in the furfural-containing electrolyte for its transformation to oxide-derived Cu. XRD and Auger Cu LM spectra showed the largely decreased Cu₂O intensity after this treatment (FIGS. 18A-B). Their intrinsic activity was further compared by quantitatively analyzing their surface areas. Double-layer capacitance was tested to assess the roughness of each material and then normalized to plain Cu foam (FIGS. 19A-F). LSV curves with roughness factor (RF)-normalized current density showed a similar trend among various Cu-based catalysts (FIG. 3D). Typically, CuAg_{glv}/Cu exhibited four times higher intrinsic activity (in the RF-normalized current density) than a commercial Cu NPs/Cu at 0.4 V_{RHE}. It was further found that a comparable RF-normalized current densities (20.2 vs. 17.7 mA cm⁻² at 0.4 V_{RHE}) between the oxide-derived CuAg_{glc}/Cu and oxide-derived Cu (i.e., OD-Cu), which was prepared via a typical electrooxidation-thermal treatment method. It is well known that oxide-derived catalysts are highly active because of their unique features such as low coordinated sites, grain boundaries, subsurface oxygen, etc. (Dattila et al., “Active and Selective Ensembles in Oxide-derived Copper Catalysts for CO2 Reduction,” ACS Energy Lett. 5(10):3176-3184 (2020); Cheng et al., “The Nature of Active Sites for Carbon Dioxide Electroreduction Over Oxide-derived Copper Catalysts,” Nat. Commun. 12(1):1-8 (2021); Liu et al., “Electrocatalytic Nitrate Reduction on Oxide-derived Silver with Tunable Selectivity to Nitrite and Ammonia,” ACS Catal. 11(14):8431-8442 (2021); which are hereby incorporated by reference in their entirety). Therefore, the results suggested the galvanic replacement method in the present work prepared an active oxide-derived Cu-rich surface, which can effectively improve EOD reaction performance, comparable to state-of-art OD-Cu electrodes.

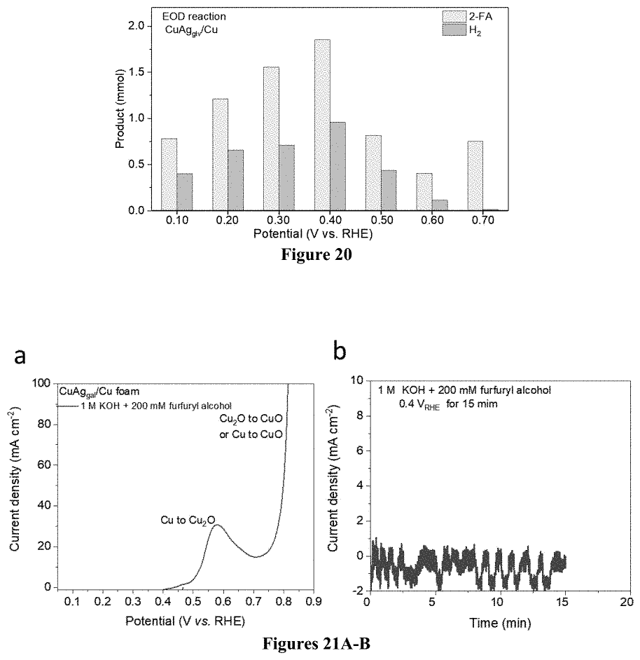

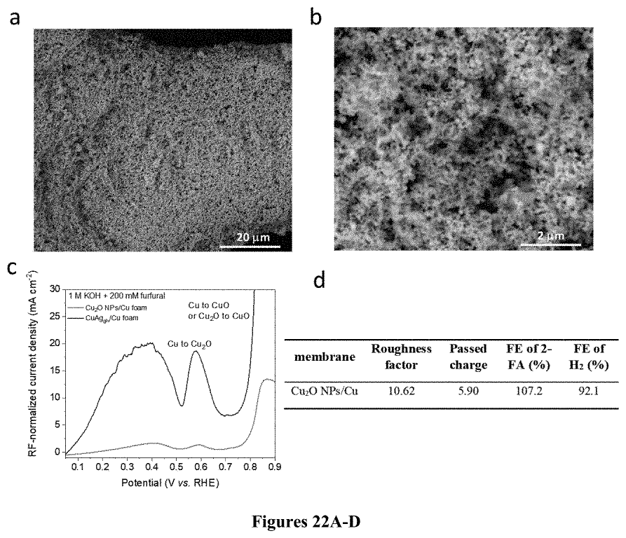

EOD reaction activity on CuAg_{glv}/Cu was further tested at static electrolysis conditions with different potentials. A typically pulsed potential connected with online DEMS confirmed the proton source for H₂ in the EOD reaction is indeed from the aldehyde group rather than H₂O (FIG. 3F-G). With the constant electrolysis duration (half-hour), FIG. 3E shows ˜100% FE to both 2-FA and H₂ (production rate ratio of ˜2:1, FIG. 20) was achieved in the potential range of 0.1-0.5 V_{RHE}. The passed charge (FIG. 3E, right y-axis) increased from 0.1 to 0.4 V_{RHE} followed by a decrease starting from 0.5 V_{RHE} and minimized at 0.6 V_{RHE}. The decreased reaction activity is due to the gradually oxidation of Cu to Cu(I) that is unreactive in catalyzing EOD reaction. The decreased FE ratio between H₂ and 2-FA from ˜1 to 0.5 at 0.6 V_{RHE} suggests concurrently occurring EOD (RXN 1, supra) and ECO (RXN 2, supra) reactions. Control experiment of electrolysis with furfuryl alcohol on CuAgglv/Cu electrode is shown in FIGS. 21A-B. Minimal current density and undetectable H₂ indicate that the unique EOD reaction only occurred on the aldehyde group. The current density at 0.4 V_{RHE} is due to the background double layer charging-discharging (FIG. 21B). Additional support for Cu(I) is not reactive was obtained from the relatively low EOD activity on a drop-coated Cu₂O/Cu catalyst (FIGS. 22A-D). Further increasing the anodic potential to 0.8 V_{RHE} largely increased the passing charge to a relatively high value (178C) but with greatly suppressed H₂ formation (FE: ˜4%), this could be due to the further oxidation of Cu and Cu(I) to Cu(II) that switched the dominant pathway from EOD to ECO reaction (Nam et al., “Copper-based Catalytic Anodes to Produce 2, 5-furandicarboxylic Acid, a Biomass-derived Alternative to Terephthalic Acid,” Acs Catal. 8(2):1197-1206 (2018); Zhang et al., “Coupling Glucose-Assisted Cu (I)/Cu (II) Redox with Electrochemical Hydrogen Production,” Adv. Mater. 2104791 (2021); Zhou et al., “Room-temperature Chemical Looping Hydrogen Production Mediated by Electrochemically Induced Heterogeneous Cu (I)/Cu (II) Redox,” Chem. Catal. 1(7):1493-1504 (2021); Bender et al., “Unraveling Two Pathways for Electrochemical Alcohol and Aldehyde Oxidation on NiOOH,” J. Am. Chem. Soc. 142(51):21538-21547 (2020); which are hereby incorporated by reference in their entirety). The DFT suggested a potential-dependent switching from the Tafel step of coupling of adsorbed H to the reverse-Volmer step of H⁺ production. The favorable ECO reaction on copper oxides could be due to their weak binding of surface H, suggesting the dominant pathway between EOD and ECO reactions can be well-regulated by anodic potentials and/or chemical states of Cu.

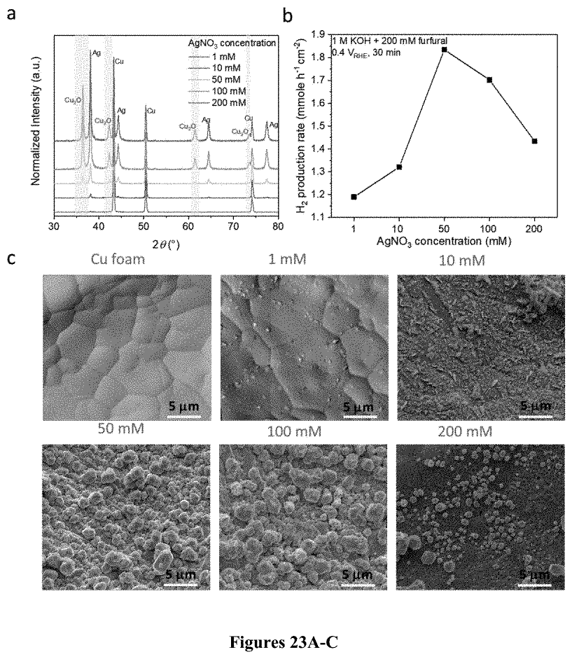

It was also found that the catalyst synthesis conditions of sonication and precursor concentrations are important to obtain the fully etched and oxidized Cu surface, strongly affecting the EOD activity. The concentration of AgNO₃ offers a tunable driving force to manage the surface roughness and relative abundance of Cu₂O in the as-synthesized CuAg_{glv}/Cu (FIGS. 23A-C). Changing its concentration from 1 to 200 mM is equivalent to a ˜0.14 V Nernstian shift of the redox potential. It was observed that higher concentration of AgNO₃ is needed to form a Cu₂O-dominated pre-catalyst; however, the large driving force has excessively dissolved Cu surface with a decrease of surface roughness (FIGS. 23A-C), leading to a dropped EOD activity.

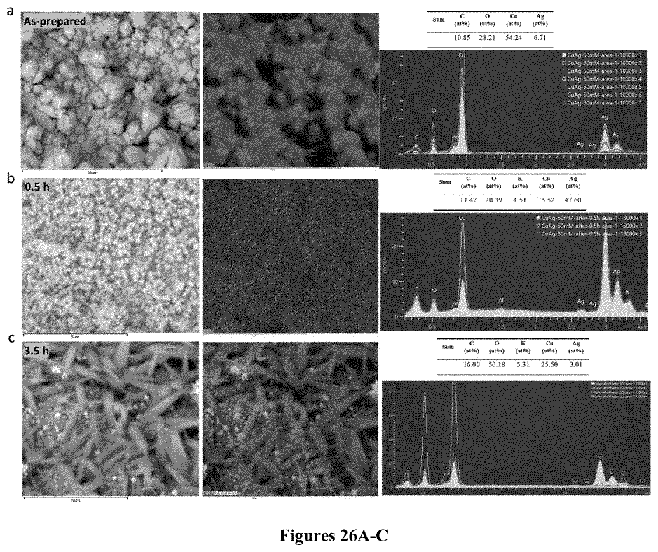

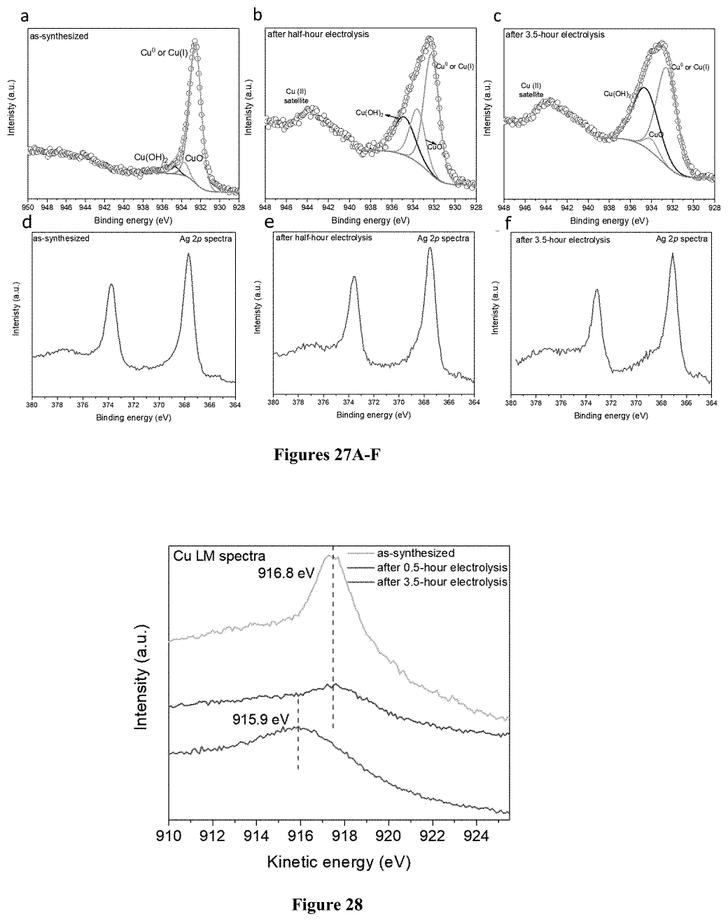

To determine dynamic changes of catalysts during EOD reaction, representative samples were characterized after different durations of electrolysis. Although OD-Cu showed similar RF-normalized reaction activity as oxide-derived CuAg_{glv}/Cu (FIG. 3A), they exhibited notably different surface morphological evolution during electrolysis at 0.2 V_{RHE} (FIG. 3H). A fast decay was observed on OD-Cu for five continuous half-hour electrolysis, resulting in a 71% drop of H₂ production rate, along with a loss of its nano-sized morphology and RF (from 3.5 to 1.1, FIGS. 25A-B). In contrast, CuAg_{glv}/Cu showed only slightly decreased activity (21%) and RF (4.5 vs. 3.9, FIGS. 30A-D) after successive 7 cycles. Top-down SEM-EDS, XRD, and XPS analysis (FIGS. 26A-C, FIGS. 27A-G, FIG. 28) showed dynamic morphology changes along with surface reconstructions during potentiostatic tests, with an overall decrease trend in the Cu-to-Ag ratio followed by its increase to the original values. These surface reconstructions were not owing to the detachment of Cu or Ag from the electrode surface to the electrolyte (as confirmed by ICP with Ag atomic percentage maintained at ˜13%, Table 3). The mobility of Ag and Cu is significant even at room temperature, and the applied anodic bias during EOD reaction is sufficient to drive drastic changes in their morphology (Antczak and Ehrlich, Surface Diffusion: Metals, Metal Atoms, and Clusters. Cambridge University Press (2010); Morales-Guio et al., “Improved CO₂ Reduction Activity Towards C₂₊ Alcohols on a Tandem Gold on Copper Electrocatalyst,” Nat. Catal. 1(10):764-771 (2018); which are hereby incorporated by reference in their entirety). As such, the different surface reconstruction modes resulted in the different activity trend between OD-Cu and CuAg_{glv}/Cu. Homogenous redispersion of Ag on the Cu surface or interdiffusion of the metal atoms occurs during EOD reaction, maintaining the high surface roughness and contributing to robust durability.

TABLE 3
ICP results of CuAg_{glv}/Cu pre- and post-reaction.

| | Percentage | Dissolved Cu | Dissolved Ag |
|---|---|---|---|
| | of Ag | in electrolyte | in electrolyte |
| | (%) | (ppm) | (ppm) |
| As synthesized | 12.5 | N/A* | N/A* |
| After 3.5-hour | 11.8 | 1.78 | 0.57 |
| EOD reaction | | | |

*below ICP detection limit.

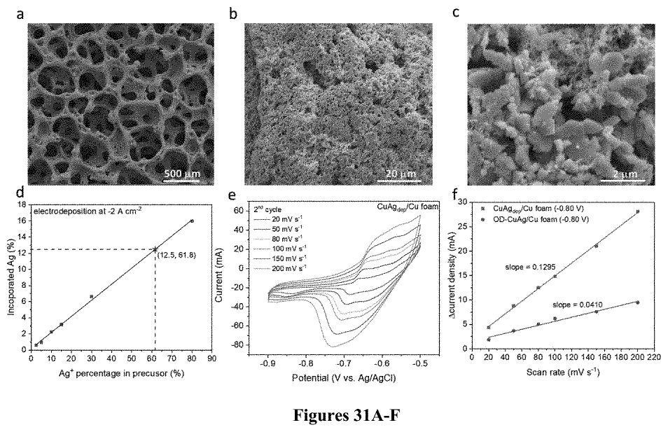

CuAg_{glv}/Cu prepared from the spontaneous deposition (i.e., galvanic replacement) was further compared with a CuAg catalyst obtained from the co-electrodeposition (i.e., CuAg_{dep}/Cu) with mesoporous architectures that were created by escaped H₂ bubbles from the concurrently occurred HER at strong acid conditions (1.5 M H₂SO₄) (Lamaison et al., “High-current-density CO2-to-CO Electroreduction on Ag-alloyed Zn Dendrites at Elevated Pressure,” Joule 4(2):395-406 (2020), which is hereby incorporated by reference in its entirety). The use of sufficiently large cathodic current density (2 A cm⁻²) greatly minimized the spontaneous galvanic replacement, and the diffusion of metal ions dominantly governed their deposition to the electrode. Ag loading was controlled at 12.5 atm % for CuAg_{dep}/Cu as that of CuAg_{glv}/Cu by the linear plot between the atomic percentage of incorporated Ag in the electrode (as determined by ICP) and the molar percentage of precursor Ag⁺ in the deposition solution (FIGS. 31A-F).

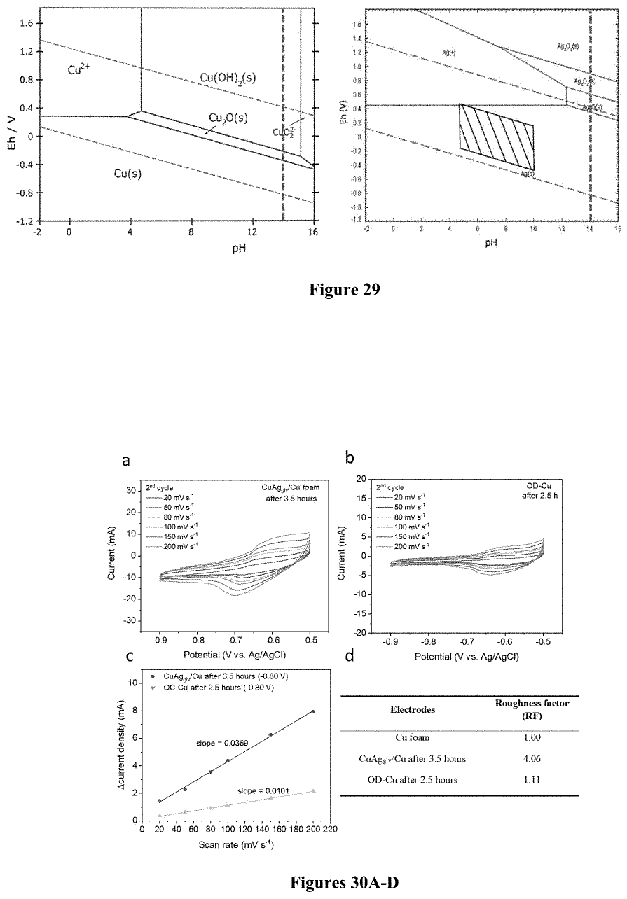

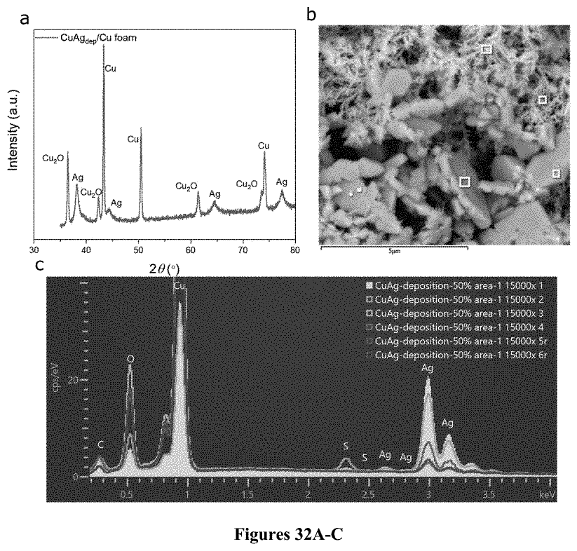

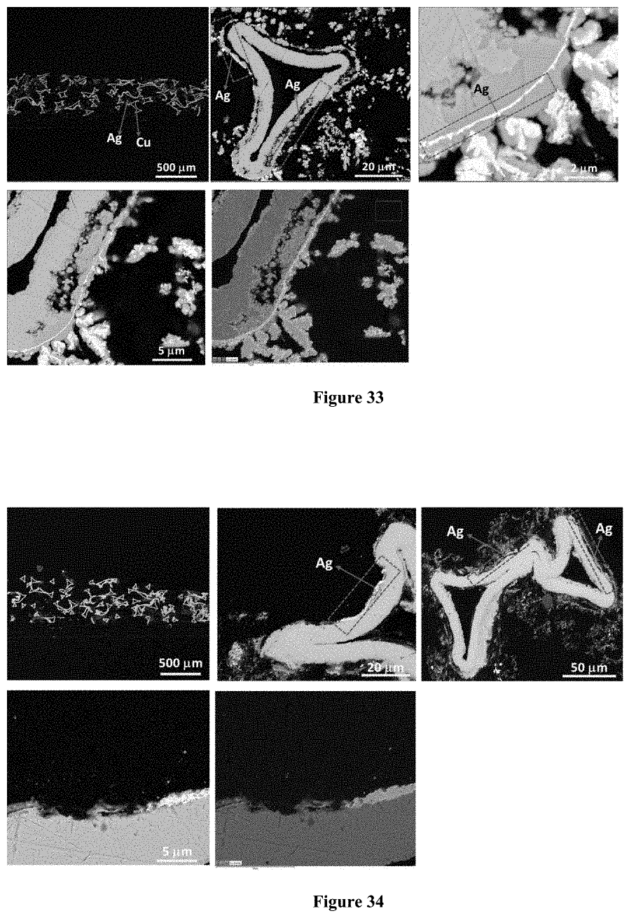

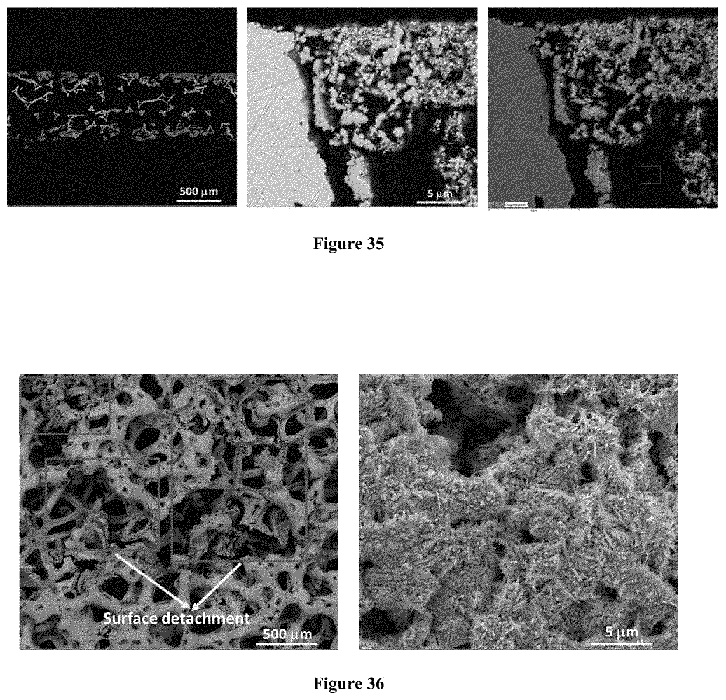

The influences of Ag incorporation and distribution in the catalyst durability was revealed by comparing the EOD performance of CuAg_{dep}/Cu and CuAg_{glv}/Cu with same Ag loading. SEM showed the dendritic Ag and hexagonal Cu structures on the CuAg_{dep}/Cu surface with microporous high-surface-area (FIGS. 31A-F, FIGS. 32A-C), exhibiting a higher RF than CuAg_{glv}/Cu (14.2 vs. 4.5). However, the durability for EOD reaction showed a different trend between these two catalysts (FIG. 3H). At 0.2 V_{RHE}, CuAg_{dep}/Cu showed an increased H₂ production rate in the first three half-hour cycles and outperformed CuAg_{glv}/Cu electrode, mainly benefiting from the higher surface area of CuAg_{dep}/Cu. However, CuAg_{dep}/Cu activity degraded faster than CuAg_{glv}/Cu as shown by different slopes for degradation rate: −0.146 vs. −0.044. Cross-sectional SEM and EDS images (FIGS. 33-35) pre- and post-electrolysis exhibited different Ag distributions between the two catalysts. It was found that the galvanic deposited Ag layer covered the outer shell of the Cu boundary. Resulting from more stable of Ag than Cu (as shown in Pourbaix diagrams in FIG. 29), the Ag layers in the cross-section partially protected Cu and avoided its quick deactivation under harsh electrolytic conditions. This unique structure could keep a rough and active surface to maintain stabilities throughout electrolysis. In contrast, cross-sectional SEM-EDS of CuAg_{dep}/Cu showed the randomly distributed Ag that loosely covered the Cu substrate (FIG. 35), without forming an intact Ag layer at the outer shell of Cu surface. Further, the porous structure of CuAg_{dep}/Cu were very fluffy and fragile, leading to physical detachment of Cu and Ag and loss of partial Cu foam substrate (FIG. 36). This distinct distribution of Ag and different dynamic surface reconstructions resulted in more durable CuAg_{glv}/Cu than CuAg_{dep}/Cu. More detailed characterizations and comparisons of the dynamic changes of catalysts are shown in Example 2.

The Ag-decorated Cu electrode showed nearly the same LSV and CA behaviors as the Cu foam substrate and other Cu-based monometallic electrodes, indicating the incorporated Ag did not directly participate in the EOD reaction to alter product selectivity, but acted as a powerful promoter to improve intrinsic EOD activity and mitigate Cu degradation. The assessment clearly demonstrated that the herein described CuAg bimetallic catalysts have a faster EOD rate than pure Cu and Ag, indicating that incorporating Ag into Cu engenders a synergistic effect that improves the activity and durability beyond either of its component metals. Similar approaches of using a relative noble metal (e.g., Pd, Rh) to induce surface reconstruction and stabilize Cu substrates, with similar dynamic surface composition changes, were reported in electroreduction of CO₂ (Lamaison et al., “High-current-density CO2-to-CO Electroreduction on Ag-alloyed Zn Dendrites at Elevated Pressure,” Joule 4(2):395-406 (2020); Weng et al., “Self-cleaning Catalyst Electrodes for Stabilized CO2 Reduction to Hydrocarbons,” Angew. Chem. 129(42):13315-13319 (2017); Herzog et al., “Operando Investigation of Ag-Decorated Cu₂O Nanocube Catalysts With Enhanced CO₂ Electroreduction Toward Liquid Products,” Angew. Chem. Int. Ed 60(13):7426-7435 (2021); which are hereby incorporated by reference in their entirety).

With the presence of highly concentrated OH⁻ ions in the electrolyte, and more severely, under anodic biasing, the transformation of surface Cu species towards Cu(OH)₂ and CuO cannot be fully avoided (Liu et al., “Investigation and Mitigation of Degradation Mechanisms in Cu₂O Photoelectrodes for CO₂ Reduction to Ethylene,” Nat. Energy 6(12):1124-1132 (2021), which is hereby incorporated by reference in its entirety). Ex-situ SEM-EDS and XPS confirmed the detached Ag layer and increased surface oxygen, which could rationalize the experimentally observed 21% drop of the reaction activity after 7 cycles of electrolysis on CuAg_{glv}/Cu. Designing Cu electrocatalysts with much longer-term catalytic durability, especially under harsh electrolytic conditions, remains a challenge that needs future studies to address.

4. Electrokinetics of EOD Reaction on CuAg_{glv}/Cu Electrode

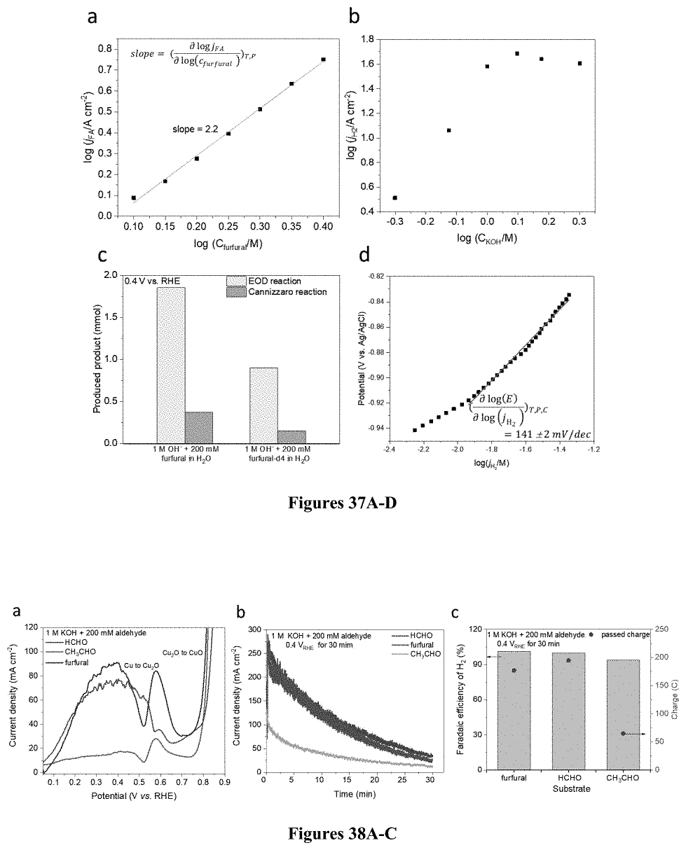

To obtain deep mechanistic insights into the electro-kinetics, the furfural concentration was varied and the j_{A-H2} was plotted against its concentration in a log-log scale. The electrolysis was conducted at 0.4 V_{RHE} with supplying the same amount of charge (i.e., 30 C). Interestingly, a first-order dependence (slope of 0.96) of the furfural-to-H₂ reaction was observed in furfural concentration ranging from 50 to 250 mM, followed by a negative reaction order in its concentration >250 mM (FIG. 4A). This negative order can be attributed to the non-Faradaic Cannizzaro reaction largely outperformed EOD reaction, because of its doubled reaction order (i.e., 2.2, FIG. 37A). This indicated that, as the aldehyde concentration increased, the kinetics for the Cannizzaro pathway increased faster than the EOD route. However, it was found that the Cannizzaro reaction can be largely minimized by positively shifting the potential from 0.2 to 0.4 V_{RHE}, in line with experimentally and computationally observed common diol intermediate and the potential-dependent pathway-switching behavior. Overall, the side Cannizzaro reaction was largely suppressed as compared to EOD reaction, e.g., 0.34 vs. 1.85 mmol of 2-FA for half-hour electrolysis at 0.4 V_{RHE}.

EOD reaction was also highly dependent on the OH⁻ concentration (FIG. 37B): j_{A-H2} was linearly increased in its range of 0.1-1 M and reached a plateau at >1.0 M, in line with the NMR results in the formation of geminal diols (FIGS. 11A-C). This highly OH⁻ concentration-dependent agreed with our DFT calculation of the more favorable diol route than the direct carbonyl route for EOD reaction. In addition, half-hour electrolysis of D-labeled furfural (furfural-d4) showed a kinetic isotopic effect (KIE) of 2.06 (calculated from the partial current density ratio of 2-FA, j_{H}/j_{D}, FIG. 37C). This large primary KIE suggested C—H/D bond cleavage is involved in the rate-determining step (RDS) (Lin et al., “Quantitative Isotope Measurements in Heterogeneous Photocatalysis and Electrocatalysis,” Energy & Environmental Science 13(9):2602-2617 (2020), which is hereby incorporated by reference in its entirety), and supported by our DFT calculation. Further, the Tafel slope (FIG. 37D) of 141 mV dec⁻¹ (equal to the transfer coefficient of α=0.42) suggested the single electron transfer participated in the RDS.

The versatility of EOD reaction was also demonstrated by extending the substrate to acetaldehyde (CH₃CHO) and formaldehyde (HCHO), two representative aldehydes with and without α-H, respectively. It is known that the Cannizzaro reaction occurs only on the compounds without any α-H, because the formation of critical diol intermediate cannot occur with α-H existed (Birdja and Koper, “The Importance of Cannizzaro-type Reactions During Electrocatalytic Reduction of Carbon Dioxide,” J. Am. Chem. Soc. 139(5):2030-2034 (2017), which is hereby incorporated by reference in its entirety). However, the occurrence of EOD reaction is not strongly relied on the type of aldehyde (FIGS. 38A-C), largely suggesting a direct carbonyl route existed for EOD reaction, in line with the DFT calculation. The decreased current density for CH₃CHO (with α-H) than the reactants without α-H suggested the diol route is more favorable than the direct carbonyl route, also consistent well with DFT results. This versatility can benefit future H₂ production from EOD of aldehyde feedstocks acquired from different resources.

5. Development of Innovative Flow Cells for Bipolar H₂ Production

5.1 H₂ Production from EOD Reaction with Enhanced Mass Transport

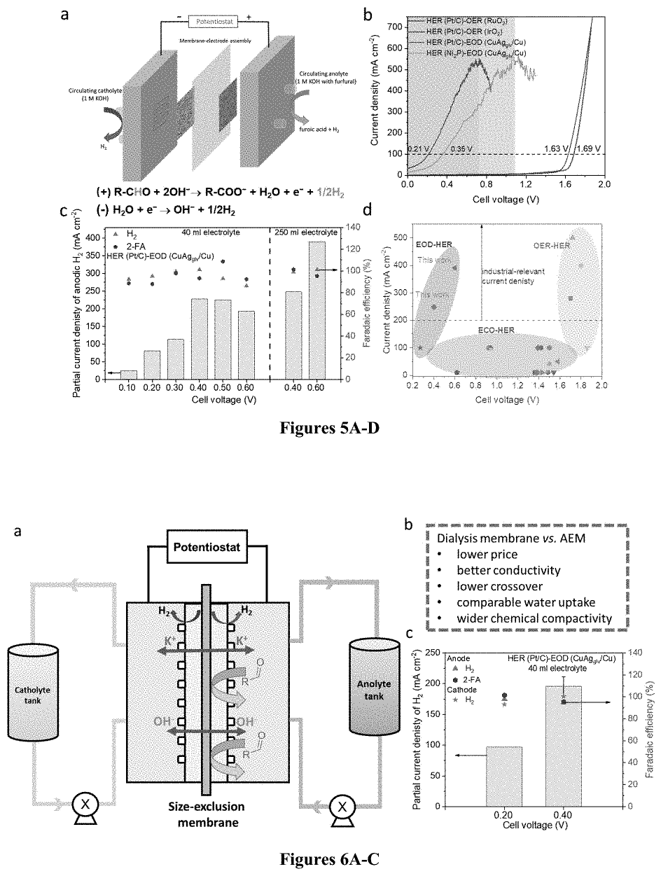

The acquired relationship between the catalyst morphology, the electrolysis conditions, and the facile EOD kinetics has enabled the design of an MEA-based flow cell to demonstrate bipolar H₂ production (FIG. 5A). The MEA is composed of an AEM, a Pt/C cathode and a CuAg_{glv}/Cu anode in a zero-gap configuration. 1 M KOH with and without 250 mM furfural were used as the anolyte and catholyte, respectively.

LSV measurements (FIG. 5B) showed that the cell voltage for HER-EOD reaction (0.21 V) was greatly lower than that of HER-OER reaction (1.63 V with RuO₂ anode and 1.69 V with IrO₂ anode) at 100 mA cm⁻². The maximum current density is ˜500 mA cm⁻² for HER-EOD reaction. The current density was dropped by further increasing the cell voltage to >0.7 V, which can be attributed to Cu oxidation that switched reaction pathway toward ECO reaction, in line with H-cell results.

Steady-state, half-hour electrolysis was conducted at various cell voltages (FIG. 5C). The obtained j_{A-H2} was increased from 0.1 to 0.5 V, and then decreased from >0.6 V. Current density-time profiles (FIG. 39A) showed a gradually decreased net current density, which is mainly attributed to the consumption of furfural, because the electrokinetic studies have confirmed the 1^{st} order dependence of its concentration. To avoid the insufficient of reactant for half-hour electrolysis, the analyte volume was increased from 40 to 250 ml, leading to j_{A-H2} stabilized to 248 and 390 mA cm⁻² at 0.4 and 0.6 V, respectively (FIG. 5c and FIG. 39B). The obtained cell voltages in the HER-EOD system have outperformed most previously reported, conventional electrolyzers for H₂ production, including HER-OER based water electrolyzer and HER-ECO based organic systems (FIG. 5D). The bipolar H₂ production system has doubled H₂ production rate as compared to the conventional processes with solely cathodic H₂ evolution.

Limited by the mass transport, most previously reported current density for organic electrolysis (e.g., furfural, glycerol) is low (i.e., <100 mA cm⁻²) in order to maximize the FE to target products (Liu et al., “Paired Electrolysis of 5-(hydroxymethyl) Furfural in Flow Cells With a High-performance Oxide-derived Silver Cathode,” Green Chem. 23:5056-5063 (2021); Liu and Li, “Recent Advances in Paired Electrolysis of Biomass-derived Compounds Toward Cogeneration of Calue-added Chemicals and Fuels,” Curr. Opin. Electrochem. 30:100795 (2021); Liu et al., “Paired and Tandem Electrochemical Conversion of 5-(Hydroxymethyl) Furfural Using Membrane-Electrode Assembly-Based Electrolytic Systems,” ChemElectroChem 8(15):2817-2824 (2021); which are hereby incorporated by reference in their entirety). To satisfy industrial requirements, the high surface area of electrodes or large reactors are needed, leading to higher capital costs. This work has achieved a record-high, industrial relevant current density of ˜400 mA cm⁻² at 0.6 V, which has outperformed most previously reported results (FIG. 5D and Table 4).

TABLE 4
Comparison of the various types of paired systems.

| | | | | | j (mA | Cell | |
|---|---|---|---|---|---|---|---|
| Paired types | Anodic substrate | Anode | Anode product | Cathode (for HER) | cm⁻2)^{b} | voltage | Ref. |
| | | Co—P/CF | | Co—P/CF | 20 | 1.39 | 1 |
| | HMF | Ni₂P NPA/NF | 2,5-furandicarboxyic acid | Ni₂P NPA/NF | 10 | 1.44 | 2 |
| | | Ni₃S₂/NF | | Ni₃S₂/NF | 10 | 1.46 | 3 |
| | | MoO₂—FeP@C | | MoO₂—FeP@C | 10 | 1.49 | 4 |
| | | Ni₂Fe(CN)₆ | | RuO₂ | 100 | 1.35 | 5 |
| | urea | Ni—WOx | N₂ and CO₂ | Ni—WOx | 100 | 1.42 | 6 |
| | | NiSe₂—NiO | | NiSe₂—NiO | 41 | 1.5 | 7 |
| | | NF/NiMoO | | NF/NiMoO | 10 | 1.38 | 8 |
| HER-ECO | ethanol | F-modified FeOOH | acetic acid | Pt/C | 10 | 1.43 | 9 |
| | | SA In—Pt NWs/C | | SA In—Pt NWs/C | 10 | 0.62 | 10 |
| | glycerol | NC/Ni—Mo—N/NF | formate | NC/Ni—Mo—N/NF | 10 | 1.38 | 11 |
| | | Ni—Mo—N/CFC | formate | Ni—Mo—N/CFC | 10 | 1.36 | 12 |
| | glucose | NiFeOx—NF | glucaric acid | NiFeOx—NF | 100 | 1.39 | 13 |
| | | Cu(I)/Cu(II) Redox | | Pt/C | 100 | 0.92 | 14 |
| | raw biomass (chitin) | hp-Ni | acetic acid | hp-Ni | 100 | 1.83 | 15 |
| | NO | carbon cloth | NO₃⁻ | N/A | 10 | 1.39 | 16 |
| | ascorbic acid | Cu(I)/Cu(II) Redox | dehydroascorbic acid | CoP | 100 | 0.94 | 17 |
| | | Co-NC-T/CF | | CoO—NC—T/CF | 100 | 1.86 | 18 |
| HER-OER | H₂O | NiFe-LDH | O₂ | Pt/C | 280 | 1.7 | 19 |
| | | IrO₂ | | Pt black | 399 | 1.8 | 20 |
| | | FeP/Ni2P | | FeP/Ni₂P | 500 | 1.72 | 21 |
| | | Cu foam | | Pt/C | 100 | 0.31 | 22 |
| HER-EOD | furfural | | Furoic acid and H₂ | | 248 | 0.4 | This |
| | | | | | | | work |
| | | OD-CuAg/Cu foam | | Pt/C | 390 | 0.6 | This |
| | | | | | | | work |

The references identified in Table 4 are as follows: 1. Jiang et al., “Integrating Electrocatalytic 5-hydroxymethylfurfural Oxidation and Hydrogen Production Via Co—P-derived Electrocatalysts,” ACS Energy Lett. 1(2):386-390 (2016); 2. You et al., “Simultaneous H2 Generation and Biomass Upgrading in Water by an Efficient Noble-Metal-Free Bifunctional Electrocatalyst,” Angew. Chem. Int. Ed. 55(34):9913-9917 (2016); 3. You et al., “A General Strategy for Decoupled Hydrogen Production from Water Splitting by Integrating Oxidative Biomass Valorization,” J Am. Chem. Soc. 138(41):13639-13646 (2016); 4. Yang et al., “Interfacial Engineering of MoO2-FeP Heterojunction for Highly Efficient Hydrogen Evolution Coupled with Biomass Electrooxidation,” Adv. Mater. 32(17):2000455 (2020); 5. Geng et al., “Nickel Ferrocyanide as a High-performance Urea Oxidation Electrocatalyst,” Nat. Energy 6(9):904-912 (2021); 6. Wang et al., “Regulating the Local Charge Distribution of Ni Active Sites for the Urea Oxidation Reaction,” Angew. Chem. 133(19):10671-10676 (2021); 7. Liu et al., “Efficient Synergism of NiSe2 Nanoparticle/NiO Nanosheet for Energy-relevant Water and Urea Electrocatalysis,” Appl. Catal. B: Environ. 276:119165 (2020); 8. Yu et al., “Ni—Mo—O Nanorod-derived Composite Catalysts for Efficient Alkaline Water-to-hydrogen Conversion Via Urea Electrolysis,” Energy Environ. Sci. 11(7):1890-1897 (2018); 9. Chen et al., “Low-voltage Electrolytic Hydrogen Production Derived from Efficient Water and Ethanol Oxidation on Fluorine-modified FeOOH Anode,” ACS Catal. 8(1):526-530 (2018); 10. Zhu et al., “Single-Atom In-Doped Subnanometer Pt Nanowires for Simultaneous Hydrogen Generation and Biomass Upgrading,” Adv. Funct. Mater. 30(49):2004310 (2020); 11. Xu et al., “Integrating Electrocatalytic Hydrogen Generation with Selective Oxidation of Glycerol to Formate Over Bifunctional Nitrogen-doped Carbon Coated Nickel-molybdenum-nitrogen Nanowire Arrays,” Appl. Catal. B: Environ. 298:120493 (2021); 12. Li et al., “Nickel-molybdenum Nitride Nanoplate Electrocatalysts for Concurrent Electrolytic Hydrogen and Formate Productions,” Nat. Commun. 10(1):1-12 (2019); 13. Liu et al., “Efficient Electrochemical Production of Glucaric Acid and H 2 Via Glucose Electrolysis,” Nat. Commun. 11(1):1-11 (2020); 14. Zhang et al., “Coupling Glucose-Assisted Cu (I)/Cu (II) Redox with Electrochemical Hydrogen Production,” Adv. Mat. 33(48):2104791 (2021); 15. Zhao et al., “Raw Biomass Electroreforming Coupled to Green Hydrogen Generation,” Nat. Commun. 12(1):1-10 (2021); 16. Wang et al., “Coupling Electrocatalytic Nitric Oxide Oxidation over Carbon Cloth with Hydrogen Evolution Reaction for Nitrate Synthesis,” Angew. Chem. 133(46):24810-24816 (2021); 17. Zhou et al., “Room-temperature Chemical Looping Hydrogen Production Mediated by Electrochemically Induced Heterogeneous Cu (I)/Cu (II) Redox,” Chem. Catal. 1(7):1493-1504 (2021); 18. Huang et al., “Rapid and Energy-efficient Microwave Pyrolysis for High-yield Production of Highly-active Bifunctional Electrocatalysts for Water Splitting,” Energy Environ. Sci. 13(2):545-553 (2020); 19. Dresp et al., “Efficient Direct Seawater Electrolysers Using Selective Alkaline NiFe-LDH as OER Catalyst in Asymmetric Electrolyte Feeds,” Energy Environ. Sci. 13(6):1725-1729 (2020); 20. Leng et al., “Solid-state Water Electrolysis with an Alkaline Membrane,” J. Am. Chem. Soc. 134(22):9054-9057 (2012); 21. Yu et al., “High-performance Bifunctional Porous Non-Noble Metal Phosphide Catalyst for Overall Water Splitting,” Nat. Commun. 9(1):1-9 (2018); 22. Wang et al., “Combined Anodic and Cathodic Hydrogen Production from Aldehyde Oxidation and Hydrogen Evolution Reaction,” Nat. Catal. 1-8 (2021); which are hereby incorporated by reference in their entirety.

For conventional ECO reactions, it generally needs surface reaction of adsorbed reactive oxygen or hydroxyl intermediates and organic-derived intermediates on two adjacent sites via Langmuir-Hinshelwood mechanism. These induced more severe internal mass-transport issues and limited the delivered partial current density to desired products. In addition, most ECO reactions (e.g., ECO of furfural or 5-(hydroxymethyl)furfural) are particularly favorable on OER electrocatalysts (e.g., Ni- or Co-based catalysts), and thus, it is challenging to completely suppress OER, especially at high current densities (Liu and Li, “Recent Advances in Paired Electrolysis of Biomass-derived Compounds Toward Cogeneration of Calue-added Chemicals and Fuels,” Curr. Opin. Electrochem. 30:100795 (2021); Liu et al., “Paired and Tandem Electrochemical Conversion of 5-(Hydroxymethyl) Furfural Using Membrane-Electrode Assembly-Based Electrolytic Systems,” ChemElectroChem 8(15):2817-2824 (2021); which are hereby incorporated by reference in their entirety). Thanks to the much favorable thermodynamics (Table 5), EOD reaction of high current densities occurs at a low potential range of 0.1-0.5 V_{RHE}, much lower than the thermodynamic potential of 1.23 V_{RHE} for OER, explicitly excluding Langmuir-Hinshelwood mechanistic sequences that involves adsorbed oxygen species formed at higher potential. In addition, EOD reaction occurs through sequentially chemical-electrochemical steps, the organic species itself is the reactant whose oxidation kinetics is facilitated by single-electron transfer at electrode-electrolyte interface, without involving other complicated adsorbates. Besides, the free-standing porous Cu foam is hydrophilic, thus can retain larger volume of the electrolyte to facilitate efficient transport of liquid-phase species through the electrode (Liu et al., “Paired Electrolysis of 5-(hydroxymethyl) Furfural in Flow Cells with a High-performance Oxide-derived Silver Cathode,” Green Chem. 23:5056-5063 (2021); Zhang et al., “Porous Metal Electrodes Enable Efficient Electrolysis of Carbon Capture Solutions,” Energy Environ. Sci. 15(2):705-713 (2022); which are hereby incorporated by reference in their entirety). Furthermore, the porous substrate with increased porosity and surface roughness promoted H₂ bubble releasing from the surface efficiently, so that they do not block the surface for subsequent adsorption of reactants. Overall, benefiting from the favorable thermodynamics, facile kinetics, and largely increased external and internal mass transport, we have significantly increased the partial current density of EOD reaction toward H₂ production.

TABLE 5
Thermodynamic data of different reactions.

| | | ΔG | E⁰ |
|---|---|---|---|
| Reaction | Reaction question | (298.15 k, 1 bar) | (vs. NHE) |
| Cathode | CuO + 2e⁻ + H₂O → Cu + 2OH⁻ | 52.40 | −0.27 |
| | Cu₂O + 2e⁻ + H₂O→2Cu + 2OH⁻ | 69.47 | −0.36 |
| | Ag₂O + 2e⁻ + H₂O → 2Ag + 2OH⁻ | −66.00 | 0.34 |
| | Pd²⁺ + 2e⁻ → Pd | −183.32 | 0.95 |
| | Pt²⁺ + 2e⁻ → Pt | −227.70 | 1.18 |
| | 2H₂O + 2e⁻ → H₂ + 2OH⁻ | 159.68 | −0.83 |
| Anode | 2HCHO + 4OH⁻ → 2HCOO⁻ + 2H₂O + H₂ + 2e⁻ | −272.42 | 1.41 |
| | HCHO + 3OH⁻ → HCOO⁻ + 2H₂O + 2e⁻ | −216.05 | 1.12 |
| Combined | CuO + 2HCHO + 2OH⁻ → Cu + H₂O + H₂ + 2HCOO⁻ | −359.44 | 1.86 |
| | Cu₂O + 2HCHO + 2OH⁻ → 2Cu + H₂O + H₂ + 2HCOO⁻ | −290.89 | 1.51 |
| | Ag₂O + 2HCHO + 2OH⁻ → 2Ag + H₂O + H₂ + 2HCOO⁻ | −503.30 | 2.61 |
| | Pd²⁺ + 2HCHO + 4OH⁻ → 2HCOO⁻ + Pd + 2H₂O + H₂ | −595.16 | 3.08 |
| | Pt²⁺ + 2HCHO + 4OH⁻ → 2HCOO⁻ + Pt + 2H₂O + H₂ | −639.54 | 3.31 |
| | HCHO + OH⁻→ HCOO⁻ + H₂ | −126.02 | 0.65 |

5.2. Non-Noble Metal for HER with Reduced Catalyst Cost

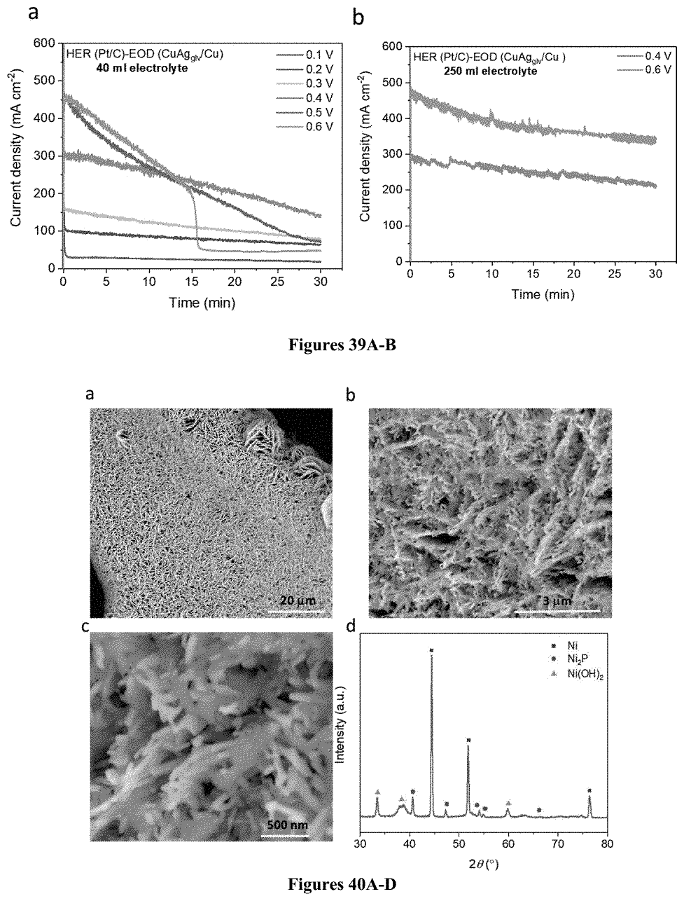

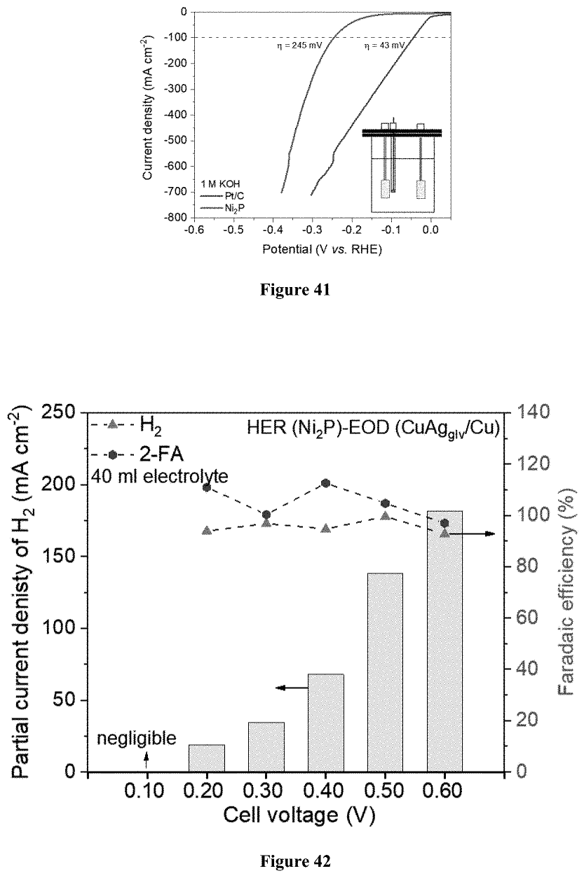

Selecting a cathode material with lower costs than platinum-group metals is important for reaching an efficient and cost-effective process. To this end, a non-precious 00106 catalyst with a highly roughened surface was prepared (FIGS. 40A-D). LSV curves in a one-compartment, three-electrode cell showed ˜200 mV higher overpotential of Ni₂P than Pt/C at 100 mA cm⁻², −0.245 V vs. −0.043 V_{RHE}, approaching the state-of-art Ni-based catalysts that prepared from various methods (Yu et al., “Clean and Affordable Hydrogen Fuel from Alkaline Water Splitting: Past, Recent Progress, and Future Prospects,” Adv. Mater. 33(31):2007100 (2021), which is hereby incorporated by reference in its entirety). Ni₂P was then employed in the HER-EOD coupled flow system. LSV and CA measurements showed a slightly higher cell voltage (˜200 mV shift) than the system with Pt/C cathode (FIGS. 41-42). In addition to its low price, one of the other advantages of using Ni₂P is its suppressed electrocatalytic hydrogenation reaction (ECH, FIGS. 43A-B). ECH of furfural at −0.15 V_{RHE} was tested for half-hours, resulting in a much lower FE toward furfuryl alcohol on Ni₂P than on Pt/C: 7% vs. 83%. Consequently, if aldehyde crossover occurs during long-time electrolysis in real applications, the unfavorable ECH on Ni₂P would not apparently influence the H₂ evolution from cathode.

5.3 Dialysis Membrane as a Separator with Reduced Membrane Cost

The great advantage of bipolar H₂ production (same H₂ produced from both anode and cathode) in the electrolytic cell could enable using a cheap, commercially available filter membrane, namely dialysis membrane (Janoschka et al., “An Aqueous, Polymer-based Redox-flow Battery Using Non-corrosive, Safe, and Low-cost Materials,” Nature 527(7576):78-81 (2015), which is hereby incorporated by reference in its entirety), because no O₂ is produced at the anode, eliminating the H₂/O₂ mixing issue. A cellulose-based dialysis membrane with the smallest commercially available pore size (i.e., molecular-weight cut-off (MWCO), the lowest retained molar mass) of 0.1-0.5 kD was selected. MWCO is not a sharply defined value, and the diffusion of molecules near the MWCO is still slow, which is appropriate for furfural (0.096 kg mol⁻¹≈0.1 kD) in the system described herein. This cellulose-based separator is able to tolerate acid, base, and organic solutions, and low or high temperatures (Janoschka et al., “An Aqueous, Polymer-based Redox-flow Battery Using Non-corrosive, Safe, and Low-cost Materials,” Nature 527(7576):78-81 (2015), which is hereby incorporated by reference in its entirety).

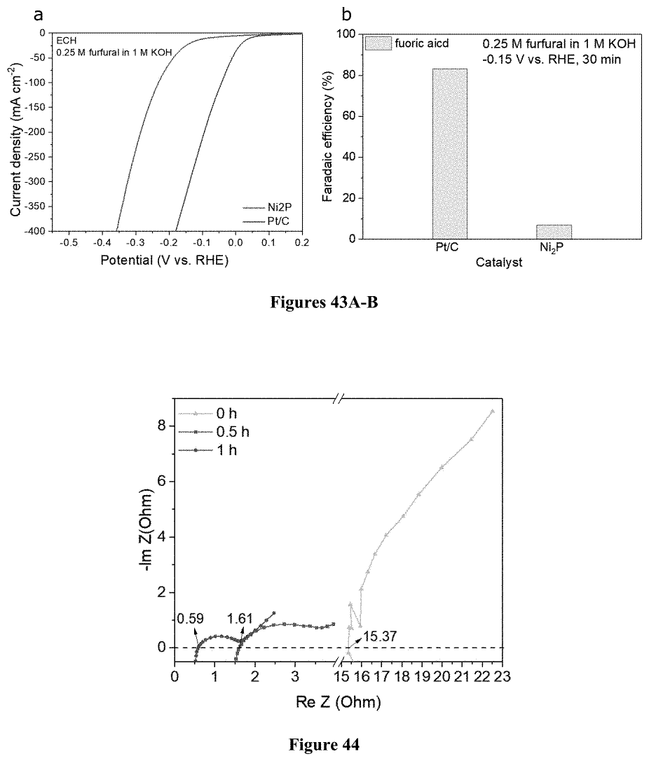

A similar MEA-based flow cell with Pt/C cathode and CuAg_{glv}/Cu anode was constructed with a piece of dialysis membrane (FIG. 6A). Supporting electrolyte of KOH enabled the free transport of K⁺ and OH⁻ across the membrane, while furfural crossover from anolyte to catholyte was retained. It was found that a pretreatment process strongly influenced the resistance of the cellulose membrane because of its non-conductive property. After 1-hour treatment by storing the membrane in 1 M KOH and implemented to flow cell, the solution resistance across the membrane has largely decreased from 15.37Ω to only 0.59Ω (FIG. 44), resulting from the saturation and transport of ions (K⁺ and OH⁻) in the pores of the membrane with its conductivity increased. Based on the high mobility of K⁺ and OH⁻ without any perm-selectivity, it was calculated that theoretical ionic conductivity for dialysis membrane (κ=247 mS cm⁻¹) is higher than AEM (κ=15-20 mS cm⁻¹) that was experimentally tested from a previous work (Duan et al., “Water Uptake, Ionic Conductivity and Swelling Properties of Anion-exchange Membrane,” J Power Sources 243:773-778 (2013), which is hereby incorporated by reference in its entirety). A slightly higher resistance of the system with dialysis membrane (0.59Ω) than AEM (0.3-0.4Ω) could be due to their different thickness: 70 vs. 28 μm. Finally, through operating this dialysis membrane in flow cells, the j_{A-H2} of 97 and 216 mA cm⁻² at 0.2 and 0.4 V (FIG. 6C), respectively, was obtained, approaching the values in the AEM-based system under the same reaction conditions with 250 ml electrolyte.

Crossover of gas and liquid products/reactants is analyzed and compared between the systems with AEM and dialysis membrane. Benefiting from the similar H₂ pressures on both anode and cathode with their concurrent generation, the gas crossover has been largely suppressed, resulting in ˜95% FE of H₂ from both electrodes. For half-hour electrolysis at 0.4 V, the amount of liquid products crossover the dialysis membrane was quantified from the catholyte (Table 6), showing 0.34, 2.02, and 4.19 mM of furfural, 2-FA, and furfuryl alcohol, respectively. In comparison, these values for crossing AEM are 0, 7.15, and 3.67 mM. The total crossed liquid reactants and products are <11 mM, corresponding to <4.5% of the initial furfural concentration of 250 mM. The very small amount of furfural crossover the dialysis membrane benefits from its size-exclusive property that retains relatively large molecular weight of organic compounds. The crossover of alcohol (produced from Cannizzaro reaction) and acid (generated from EOD reaction) are non-negligible and higher than furfural. Negatively charged acidic product (i.e., C₅H₃O₃⁻ from EOD reaction) is readily transported across the positively charged AEM, while highly soluble neutral products (i.e., alcohol) are also able to crossover through sorption into and subsequent diffusion through the membrane based on the concentration gradient. A comparable permeability of furfuryl alcohol for dialysis membrane and AEM (FIGS. 45A-D) was then measured: 8.74×10⁻⁶ cm² s⁻¹ vs. 1.05×10⁻⁵ cm² s⁻¹. This uncharged soluble liquid product follows the same transport mechanisms as water and its permeability is dependent on the water uptake property (Salvatore et al., “Designing Anion Exchange Membranes for CO 2 Electrolysers,” Nat. Energy 6(4):339-348 (2021), which is hereby incorporated by reference in its entirety). Water uptake for dialysis membrane (38%) is higher than that for AEM (26%) and would expected to have a higher alcohol crossover for dialysis membrane. The experimental obtained similar furfuryl alcohol crossover between these two membranes could be resulted from the thicker of dialysis membrane. In contrast, owing to the size-exclusive, non-selective characteristics of dialysis membrane, the permeability of 2-FA (i.e., 5.56×10⁻⁶ cm² s⁻¹, FIGS. 45A-D) is one-order-of-magnitude lower than that of anion selective-AEM ((i.e., 2.80×10⁻⁵ cm² s⁻¹), echoing the observed lower crossover rate of 2-FA in the system with dialysis membrane for half-hour electrolysis. Nevertheless, several properties can be further tuned to reduce voltage losses of dialysis membrane, such as thickness, pore size distribution.

TABLE 6
Crossover of product after half-hour electrolysis at 0.4
V_{RHE} in the flow cells with AEM or dialysis membrane.^{a}

| | furfuryl alcohol | 2-FA | furfural |
|---|---|---|---|
| membrane | (mM) | (mM) | (mM) |
| AEM | 3.67 | 7.15 | N/A |
| Dialysis | 4.19 | 2.02 | 0.34 |

^{a}The anolyte and catholyte were prepared in 1M KOH with and without 250 mM furfural, respectively. The crossover was detected by quantification of the products in the catholyte after half-hour electrolysis.

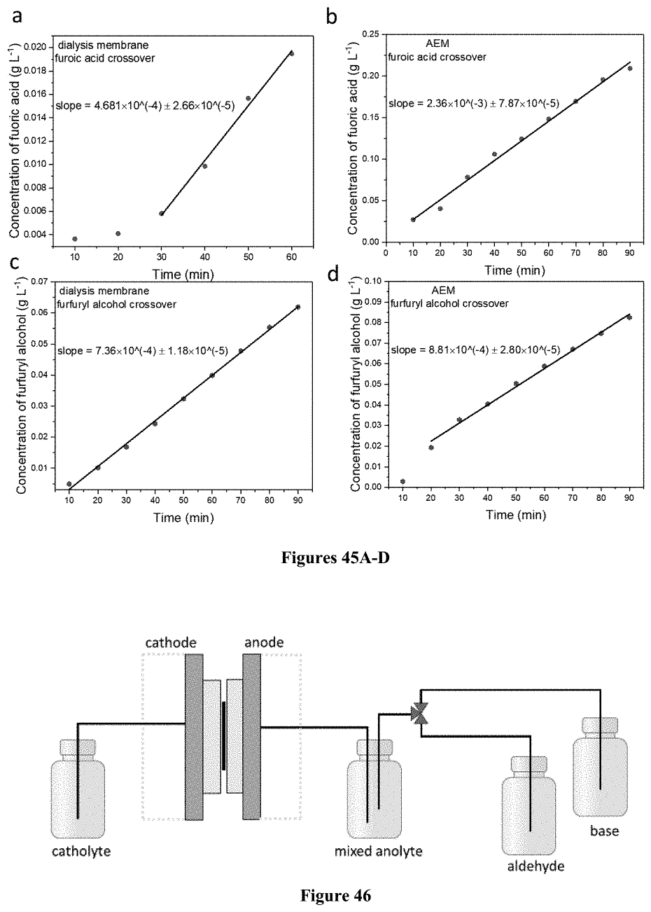

We proposed a system for bipolar H₂ production to minimize Cannizzaro reaction as shown in FIG. 46. The base solution (e.g., 2.0M KOH) and aldehyde solution (e.g., 0.5M furfural solution) are stored in separate containers, mixed in an extra container and then quickly fed to the anodic chamber for EOD reaction under anodic potential (FIG. 46). The ratio of aldehyde/base can be adjusted by the flow rates of base and aldehyde solutions.

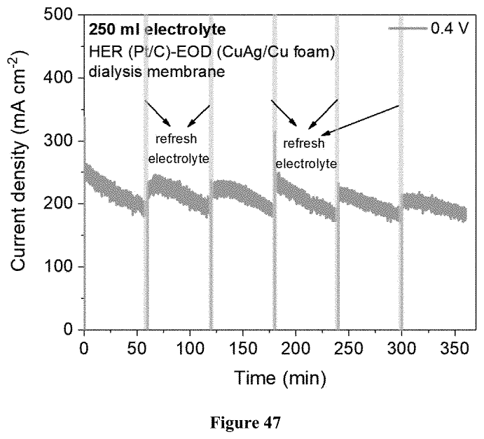

Finally, the long-term stability test in the system with dialysis membrane was investigated by conducting successive 7 cycles of 1-hour electrolysis at the cell voltage of 0.4 V (FIG. 47). Negligible changes in the current density were observed during the first 1-4 hours followed by a slow drop of performance, showing the excellent stability of both CuAg_{glv}/Cu anode and dialysis membrane.

Conclusion

In summary, enabled by the favorable thermodynamics and facile kinetics of EOD reaction, bipolar H₂ production in the flow cells was achieved with FE of ˜200% and current density of 248 and 390 mA cm⁻² at ultra-low cell voltages of 0.4 V and 0.6 V, respectively. These values are higher than most previously reported H₂ production rates in the HER-ECO paired systems. Experimental investigations have shown the reaction kinetics of EOD reaction on Cu electrodes, and suggested its linkage to the Cannizzaro side reaction. A more efficient CuAg bimetal catalyst synthesized on free-standing porous Cu foam electrode was explored, which demonstrated much more enhanced kinetics, mass transport, and durability. When the flow electrolyzer was engineered with a cheaper dialysis membrane as a separator, the excellent cell performance and stability maintained. Moreover, using MPT can link the EOD reaction with chemical looping of H₂ evolution reaction, and highlights its possibility to help rationally design and predict novel electrocatalysts and processes. In addition, this work provides a new avenue toward hydrogen and carboxylic acid co-production from flow cells operated at low voltages. It could facilitate to develop a simple, cheap electrochemical process for bipolar H₂ production with high efficiency, robustness, safety and scale-up potential.

### Example 2—Supporting Information for Example 1 Thermodynamic Analysis

The calculation of the equilibrium potentials for different reactions mentioned was shown by the equation as follows:

ΔG=−nFE°

where ΔG is the Gibbs free energy of reaction at 298 K and 1 bar, F is Faraday's constant, and n is the number of electrons passed during the reaction. All thermodynamic data is from NIST webbook or the electrochemical textbook (Fuller and Harb, Electrochemical Engineering, John Wiley & Sons (2018), which is hereby incorporated by reference in its entirety). It should be noted that because of the lack of thermodynamic data of furfural, HCHO was used for the thermodynamic analysis. This reactant also showed the EOD activity with similar performance as furfural from the experimental data. Thermodynamic data of different substances is shown in Table 7.

TABLE 7
Thermodynamic data of different substances.

| | ΔH_{f}° | S°, 1 bar | ΔG |
|---|---|---|---|
| Substance | (kJ mol⁻¹) | (J mol⁻¹ k⁻¹) | (298.15 k, 1 bar) |
| Cu | | | 0 |
| CuO | | | −129.70 |
| OH⁻ | −229.99 | −10.54 | −226.85 |
| H₂O | −285.83 | 69.95 | −306.69 |
| Ag | | | 0 |
| HCHO | −115.9 | 218.95 | −181.18 |
| HCOOH | −425.09 | 131.84 | −464.40 |

XRD and XPS Analysis on CuAg_{glv}/Cu

The XRD patterns (FIGS. 18A-B) of as-synthesized CuAg_{glv}/Cu anode can be indexed to the characteristic diffraction peaks of Cu (PDF #00-004-0836), Cu₂O (PDF #00-005-0667), and Ag (PDF #00-004-0783). Three phases on the as-synthesized CuAg/Cu foam were observed from XRD: copper, cuprite (Cu₂O), and silver. Both metals are polycrystalline, and no evidence of Cu—Ag intermetallic was observed.

To further investigate the composition of Cu and Ag on the surface, XPS was analyzed. The strong peak of Cu 2p_{3/2} at ˜ 932.6 eV is corresponded to Cu(0) or Cu(I) state, which cannot be differentiated from the Cu 2p spectra. Then, according to Auger peak of Cu LM spectra at ˜916.8 eV, the surface is indeed dominated by Cu(I) oxide. The fitted Cu 2p_{3/2} peaks at ˜933.8 eV and 934.7 eV are assigned to Cu(II) oxide and Cu(II) hydroxide, respectively. Ag is also presented on the surface in its metallic state with a low atomic concentration (4.3 at %, Table 5). Because Cu₂O is obtained from XRD, EDS, and XPS, it indicated cuprite is existed on both the surface and bulk regions.

Interestingly, it was found that the tested Ag (200) lattice (0.24 nm) is larger than its theoretical value of 0.20 nm. This suggests that the Cu which segregates to the electrode surface is initially dissolved in the Ag phase. It has been revealed that Cu and Ag showed limited surface miscibility (Sprunger et al., “Growth of Ag on Cu (100) Studied by STM: From Surface Alloying to Ag Superstructures,” Phys. Rev. B 54(11):8163 (1996), which is hereby incorporated by reference in its entirety), because they are completely immiscible in their entire composition at room temperature (Subramanian and Perepezko, “The Ag—Cu (Silver-copper) System,” Journal of Phase Equilibria 14(1):62-75 (1993), which is hereby incorporated by reference in its entirety). In fact, the addition of Ag adatoms onto Cu was found to spontaneously result in the formation of a random substitutional surface alloy at room temperature with a maximum Ag content of ˜16 at. % in the top layer of atoms (Sprunger et al., “Growth of Ag on Cu (100) Studied by STM: From Surface Alloying to Ag Superstructures,” Phys. Rev. B 54(11):8163 (1996); Clark et al., “Electrochemical CO₂ Reduction Over Compressively Strained CuAg Surface Alloys With Enhanced Multi-carbon Oxygenate Selectivity,” J. Am. Chem. Soc. 139(44):15848-15857 (2017); which are hereby incorporated by reference in their entirety). Similar observation is also obtained from a previous work for ZnCu bimetals that were also prepared from the galvanic replacement method at room temperature (Wang et al., “Bimetallic Effects on Zn—Cu Electrocatalysts Enhance Activity and Selectivity for the Conversion of CO₂ to CO,” Chem. Catal. 1(3):663-680 (2021), which is hereby incorporated by reference in its entirety).

No diffraction peak of CuAg alloy was detected from XRD, which could be due to the highly rouged surface and metallic Cu-dominated substrate, which introduced significant amounts of bulk Cu signals that hided the small amounts of CuAg bimetallic signals (Clark et al., “Electrochemical CO₂ Reduction Over Compressively Strained CuAg Surface Alloys With Enhanced Multi-carbon Oxygenate Selectivity,” J Am. Chem. Soc. 139(44):15848-15857 (2017); Yin et al., “Selective Electro- or photo-reduction of Carbon Dioxide to Formic Acid Using a Cu—Zn Alloy Catalyst,” J. Mater. Chem. A 5(24):12113-12119 (2017); which are hereby incorporated by reference in their entirety).

Characterizations of CuAg_{glv}/Cu at Different Stages of Reactions

SEM and EDS analysis were measured at different reaction durations. Top-down SEM-EDS (FIGS. 26A-C) on as-synthesized CuAg_{glv}/Cu showed the broadly distributed Ag on Cu foam, and an average Cu/O at % ratio of 54:24, corresponding to Cu₂O. After half-hour EOD reaction at 0.2 V_{RHE}, small Ag clusters are dispersed on Cu surface with a significantly increased Ag ratio. Ag-rich areas showed particle sizes of ˜100 nm. From typical EDS mappings on Ag-rich regions, the green and light blue areas indicated thick Ag layers and Cu below the think Ag layers, respectively. After prolonged electrolysis for 3.5 hours, the surface was predominated by CuO and showed nanorods morphology, indicating a dynamic transformation of surface Cu(I) to Cu(II).

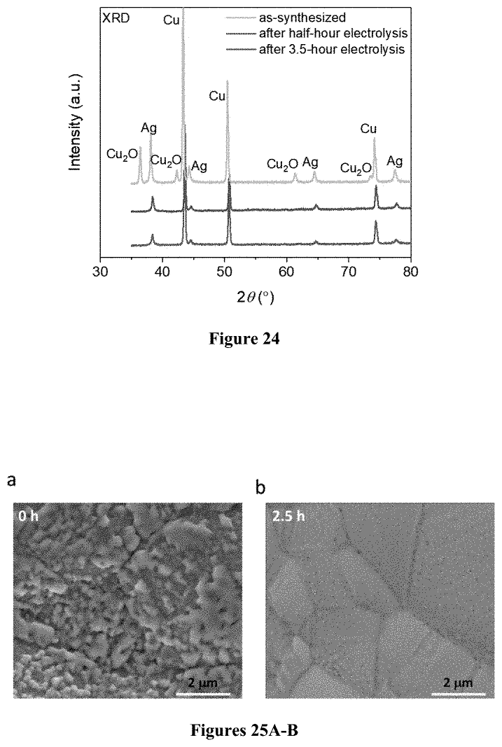

X-ray diffraction (XRD) was applied to examine the phase purity of the catalysts and to track the evolution of the crystal structure after EOD reaction. XRD patterns showed the as-synthesized CuAg_{glv}/Cu (FIGS. 18A-B) with the reflections assigned to Cu, Cu₂O, and Ag. After half- and 3.5-hour EOD reactions at 0.2 V_{RHE} (FIG. 24), Cu₂O was fully reduced to metallic Cu.

X-ray photoelectron spectroscopy (XPS) measurements were conducted to gain deeper insights into the surface composition and chemical state of the CuAg_{glv}/Cu before and after EOD reactions. The Ag₃a core-level regions of CuAg_{glv}/Cu revealed that Ag is in the metallic state before and after EOD reactions, consistent with the XRD results. In the deconvoluted Cu 2p_{3/2} spectra (FIGS. 27A-G), a main feature is observed at the binding energy of 932.6 eV together with two features at 933.6 eV and 934.8 eV, representing Cu(0) or Cu₂O, CuO, and Cu(OH)₂ signals, respectively (Biesinger, M. C., “Advanced Analysis of Copper X-ray Photoelectron Spectra,” Surf Interface Anal. 49(13):1325-1334 (2017), which is hereby incorporated by reference in its entirety). The metallic Cu and Cu₂O signal cannot be differentiated from Cu 2p spectra. The surface composition ratios of Cu(0 or I)/Cu (II) were determined by integrating the fitted peak areas between Cu (0 or I) and Cu (II) (CuO and Cu (OH)₂). Cu(II) percentage in the as-synthesized sample is minor (<15%), which has increased to ˜45% when the electrolysis duration is over 0.5 hours. The Cu(II) satellite peak at ˜944 eV also suggested transforming the chemical state to Cu(II) after EOD reactions. In particular, the surface Cu(OH)₂ species has increased from 23.6% in the 0.5-hour sample to 41.1% in the 3.5 hour-sample, which could be attributed to the decreased reactivity of the catalysts. It is worth noting that the surface Cu(OH)₂ is commonly observed on XPS, especially when the electrolysis of Cu is under aqueous solutions (Platzman et al., “Oxidation of Polycrystalline Copper Thin Films at Ambient Conditions,” J. Phys. Chem. C 112(4):1101-1108 (2008); Liu et al., “Investigation and Mitigation of Degradation Mechanisms in Cu₂O Photoelectrodes for CO₂ Reduction to Ethylene,” Nat. Energy, 6(12):1124-1132 (2021); which are hereby incorporated by reference in their entirety). Additionally, Auger Cu LM spectra (FIG. 28) were carried out to distinguish Cu(0), Cu(I), and Cu(II) species at near-surfaces. In the as-prepared sample, the peak maximum of kinetic energy at ˜916.8 eV suggested the domination of Cu₂O on its surface, agreed with the EDS and XRD results. After EOD reactions of 0.5 and 3.5 hours, the gradually broadened full width at half maximum (FWHM) and the shifted kinetic energy to lower values suggested the transformation of Cu₂O to Cu(OH)₂ (Biesinger, M. C., “Advanced Analysis of Copper X-ray Photoelectron Spectra,” Surf Interface Anal. 49(13):1325-1334 (2017); Frost et al., “X-ray Photoelectron Spectroscopy of Copper Compounds,” Mol. Phys. 24(4):861-877 (1972); which are hereby incorporated by reference in their entirety), consisted with Cu 2p spectra.

Unlike the XPS results, peaks for Cu(OH)₂ and CuO are not observed in XRD, which could be due to the amorphous nature of the phases and/or small domain sizes.

Surface Reconstruction and Protection Scenario Analysis

The trend of Cu:Ag value obtained from XPS is similar to those from EDS (Table 8). The as-prepared sample has a high Cu:Ag ratio, which decreased dramatically after half-hour electrolysis and increased back after 3.5-hour electrolysis. Interestingly, the percentage of Ag extracted from the surface-sensitive XPS analysis was generally higher than that from the EDS analysis, indicating some of the Ag beneath the surface Cu, because the “excitation depth” is much lower on XPS as compared to EDS: 5 nm vs. ˜1 μm.

TABLE 8
Summary of Cu and Ag compositions
at different reaction durations.

| | EDS | | XPS | |
|---|---|---|---|---|
| Time (h) | Cu (at %) | Ag (at %) | Cu (at %) | Ag (at %) |
| As synthesized | 88.99 | 11.01 | 95.69 | 4.31 |
| 0.5 | 24.59 | 75.41 | 66.12 | 33.88 |
| 3.5 | 89.44 | 10.56 | 92.58 | 7.42 |

The cross-section SEM images (FIG. 33-35) were preceded by embedding the samples using a vacuum impregnation device. Then, epoxy was introduced to infiltrate the samples effectively and gently for subsequent polishing through 0.25-μm diamond slurry. The images showed most of Ag is filled within the interspace of the Cu foam. In the as-synthesized sample, Ag is uniformly covered on the outer surface of the Cu boundary. From the Pourbaix diagrams (FIG. 29), Ag is more stable than Cu under our electrolysis condition of pH 14. Thus, the covered Ag layer can partly protect the Cu and avoid its corrosion in the strong alkaline and anodic electrolytic conditions. However, for very long-term electrolysis, the covered Ag layer would become loose and gradually detached from the Cu surface, which is attributed to the dropped performance (21% after 7 cycles electrolysis) in the main text.

### Example 3—Pt Dispersed Porous Cu for Electrocatalytic Oxidative Dehydrogenation of Aldehydes Toward Bipolar H₂ Production with Practical Rates

Experimental Section

1. Material Synthesis

The copper foam was first sonicated in 2 M HCl solution for 5 min to remove the surface oxide, followed by rinsing and sonicating in DI-water. The cleaned Cu foam was then sonicated (operating frequency 35 kHz, RF-power 90 W) in the precursor M solutions of 50 mM at room temperature for 30 s to etch and oxidize the Cu surface, and to galvanically exchange M with Cu in order to form the as-synthesized CuM/Cu electrode. The precursor solutions containing metal M include HPtCl₄, AuCl₃, Pd(NO₃)₂, and AgNO₃. Finally, the surface copper oxides in CuM/Cu electrodes were in-situ electroreduced at the potential of −0.1 V_{RHE} for 3 min.

Pt/C catalyst (0.5 mg_{Pt} cm^{-m}) was prepared by a spray-coating method on treated carbon cloth substrate. The treatment of carbon cloth was conducted in 67-70 wt. % HNO₃ at 110° C. for 1 h 45 min to improve its hydrophilicity. The catalyst ink was prepared by dispersing nanoparticles in a mixture of DI water and 2-propanol (10 mg_{Pt} mL^{-m}) with added ionomer (AS-4) by ultrasonication. The mass ratio of nanoparticles and ionomer was 4:1. The ink was then airbrushed onto the substrate to the final loadings.

2. Electrochemical Measurements in the H-Type Cell

To perform EOD reaction in an H-type cell, a three-electrode configuration was set up with Ag/AgCl as the reference electrode and Pt foil as the counter electrode. The resistance between the working and reference electrodes was determined by potentiostatic electrochemical impedance spectroscopy (PEIS), and 90% IR-compensation was applied for all electrochemical measurements. The geometric area of the working electrode was 1 cm². Anode and cathode compartments were separated by a Nafion membrane (K+ form). The electrolyte was prepared in 1.0 M KOH solution, and 15 ml of electrolyte was used in each compartment. It should be noted that the prepared furfural-containing electrolyte was conducted electrolysis instantly, in order to avoid its degradation to humins and minimize the side Cannizzaro reaction in the alkaline medium.

Linear sweep voltammetry (LSV) and chronoamperometry (CA) tests were conducted under a constant Ar flow through the catholyte for deaeration and online analysis of evolved H₂ by GC. LSV was carried out without magnetic stirring at 10 mV s-by GC. LSV was carried catholyte and anolyte were stirred by PTFE-coated magnetic bars (20×6 mm, Chemglass Life Sciences) at 350 r.p.m. Potentials versus RHE relative to those versus Ag/AgCl was calculated by:

E_{RHE}=E_{Ag/AgCl}+0.197 V+0.059 V×pH.

3. Electrochemical Measurements in the MEA-Based Flow Electrolyzer

The flow reactor set-up and conditions were adopted from previous work (Liu et al., “Ultra-Low Voltage Bipolar Hydrogen Production from Biomass-Derived Aldehydes and Water in Membrane-Less Electrolyzers,” Energy Environ. Sci. 15:4175-4189 (2022), which is hereby incorporated by reference in its entirety). Specifically, the flow electrolyzer contains two stainless steel flow-field plates with serpentine channels, PTFE and silicone gaskets, and the MEA, which contains two electrodes and a membrane, and was formed after assembling the cell hardware. The catholyte and anolyte were circulated by a peristaltic pump (Masterflex® L/S®) at 10 ml min-. To avoid current density exceeding the limit of potentiostat, custom-designed flow cell with active surface area of 1 cm² (1×1 cm²) for anode and 6.25 cm² (2.5×2.5 cm²) for cathode was applied. This cell configuration is based on the rate limiting step of the anodic EOD in the EOD-HER paired system, since HER is much favorable thermodynamically (E⁰=0 vs. SHE, at pH=0) and kinetically (on noble metal Pt/C catalysts). The applied potential or current was controlled by a Biologic SP-300 potentiostat/galvanostat with 70% IR-compensation. A piece of anion exchange membrane (Tokuyama A201, ˜29 m) was used to separate catholyte and anolyte. All experiments were performed at the room temperature.

4. Product Analysis

The electrolyte was analyzed by High-Performance Liquid Chromatography (HPLC, Agilent Technologies, 1260 Infinity II LC System) equipped with a variable wavelength detector (Agilent 1260 Infinity Variable Wavelength Detector VL). The column (Bio-Rad Aminex HPX-87H) for analyzing anodic species (including furfural and 2-FA) was operated at 50° C. with a mobile phase of 0.01 M H₂SO₄ at 0.5 ml min⁻¹, and the wavelength of 260 nm was applied. For the quantification of furfuryl alcohol that produced from Cannizzaro reaction, a C18 HPLC column (Gemini® 3 μm, 110 Å, 100×3 mm) was used at 45° C. with a binary gradient pumping method to drive mobile phase containing water and CH₃CN at 0.4 ml min⁻¹ with the wavelength of 225 nm. The CH₃CN fraction was increased from an initial volumetric ratio of 15% to 60% during 5-15 min, and then was decreased to 15% from 17-24 min.

H₂ was quantified by on-line GC (SRI Instrument 8610C MG #3) equipped with HaySep D and MolSieve 5 Å columns and a thermal conductivity detector. The calibration curve was established by analyzing the standard calibration gases with different concentrations (10-10,000 ppm).

The GC program was started 2 min after the electrolysis was initiated, and a 4.5-min programmed cycle (including a 4-min running period and a 0.5-min cooling period) was repeated throughout the measurement.

The rate of H₂ generation (r, mol s⁻¹) for each cycle was calculated by the following equation:

r=c×10⁻⁶×[P\dot{v}×10⁻⁶/(RT)]

where c is the H₂ concentration (ppm); \dot{v} is the volumetric flow rate of the inlet gas (12.5 ml min⁻¹); p is the ambient pressure (p=1.013×10⁵ Pa); R is the gas constant (R=8.314 J mol⁻¹ K⁻¹); T is the room temperature (293.15 K). The total amount of H₂ (mol) was calculated by integrating the plot of H₂ production rate (mol s⁻¹) vs. reaction time (s) with polynomial curve fitting.

The Faradaic efficiency (FEᵢ) and partial current density of H₂ (j_{H}_{₂}) can be calculated by equations as follows:

$$F {E}_{i} = \frac{{n}_{i} {z}_{i} F}{Q} \times 100 \%$$

$${j}_{{H}_{2}} = \frac{Q}{t} \times F E$$

where n₀ is initial moles of reactant; n is the moles of reactant after electrolysis; nᵢ is the moles of product i; zᵢ is the number of electrons transferred for one product molecule; F is the Faraday constant (96,485 C mol⁻¹); Q is the total charge passed through the electrolytic cell; t is the electrolysis time (s). In particular, the produced 2-FA from the EOD pathway is calculated by subtracting 2-FA that was generated from the Carnizarro pathway (by quantifying furfuryl alcohol) from the total detected 2-FA.

5. Materials Characterization

5.1 Physical Characterization

X-ray diffraction (XRD) crystallography was carried out on a Siemens D500 X-ray diffractometer with a Cu Kα source (λ=1.5432 Å) at a tube voltage of 45 kV and a tube current of 30 mA. The scan was performed at a rate of 100 min⁻¹ and a step size of 0.02°. X-ray photoelectron spectroscopy (XPS) was carried out on a Kratos Amicus/ESCA 3400 X-ray photoelectron spectrometer with Mg Kα X-ray (1,253.7 eV). All spectra were calibrated with the C is peak at 284.8 eV. Scanning Electron Microscopy-Energy Dispersive X-ray Spectroscopy (SEM-EDS) was performed on a field-emission scanning electron microscope (FEI Quanta-250) equipped with a light-element X-ray detector and an Oxford Aztec energy-dispersive X-ray analysis system. Transmission electron microscopy (TEM) samples were prepared by scratching the nanopowders from the CuPt/Cu surface. The scratched material was dispersed in ethanol and ultrasonicated for 5 min, followed by drop-casting on the grid. Aberration corrected scanning transmission electron microscopy (STEM) images and energy-dispersive X-ray spectroscopy (EDS) mappings were taken from a Titan Themis 300 probe corrected TEM with a Super-X EDS detector. All Cu-based samples were temporarily stored under inter gas before characterizations, in order to avoid their possible oxidation in air.

5.2 Determination of the Roughness Factor

Surface roughness factors for the electrodes relative to copper foam were determined by measuring double-layer capacitances (Cal). Cyclic voltammetry (CV) was performed in a one-compartment electrochemical cell with 1.0 M KOH solution in a three-electrode configuration without stirring. The potential range for CV was conducted in the potential regions where no faradaic processes occurred, and the geometric current density difference (Δj) was plotted against different scan rates of CV (20 to 200 mv s⁻¹).

Results and Discussion

1. Catalyst Synthesis and Morphology Characterizations

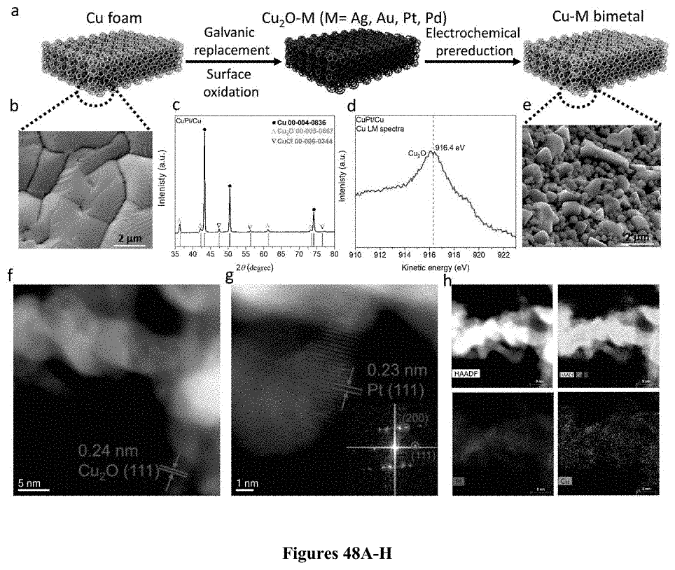

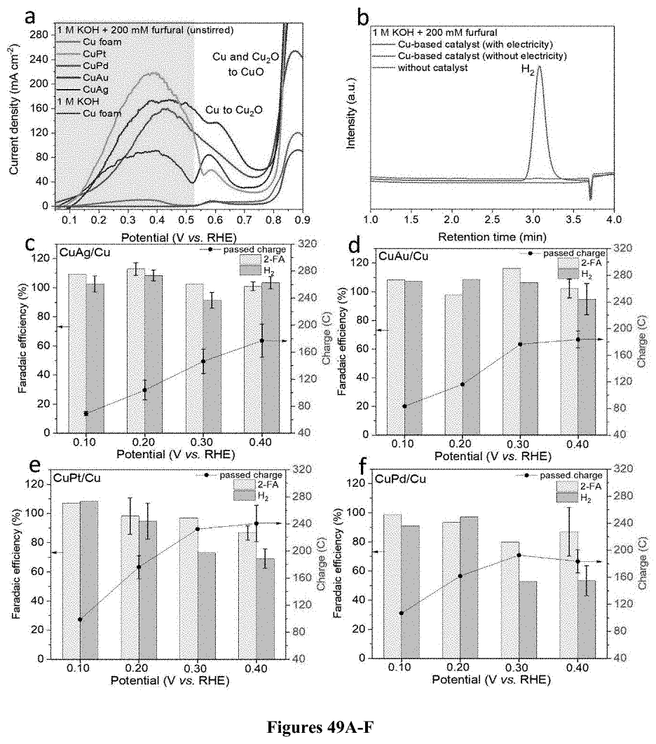

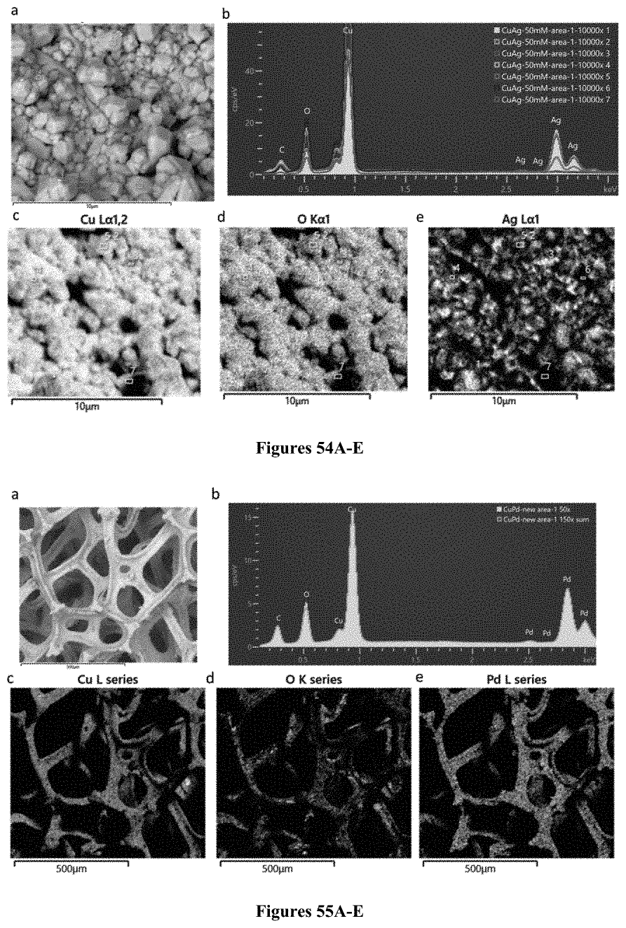

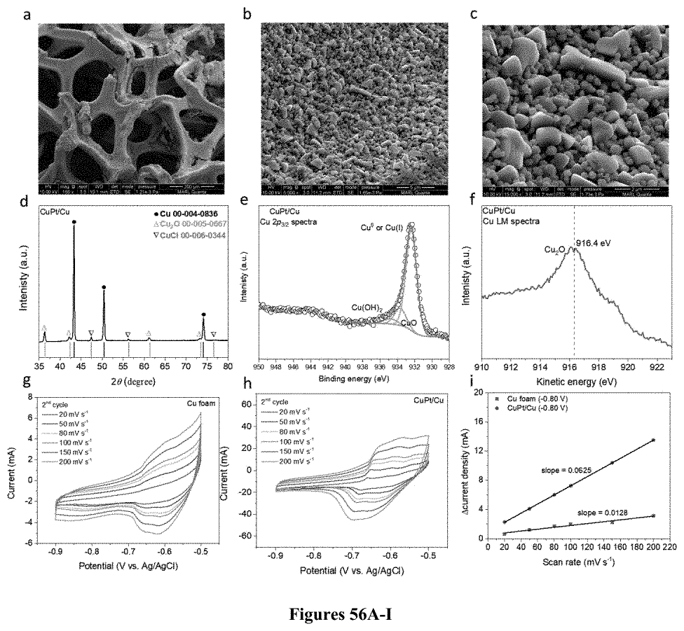

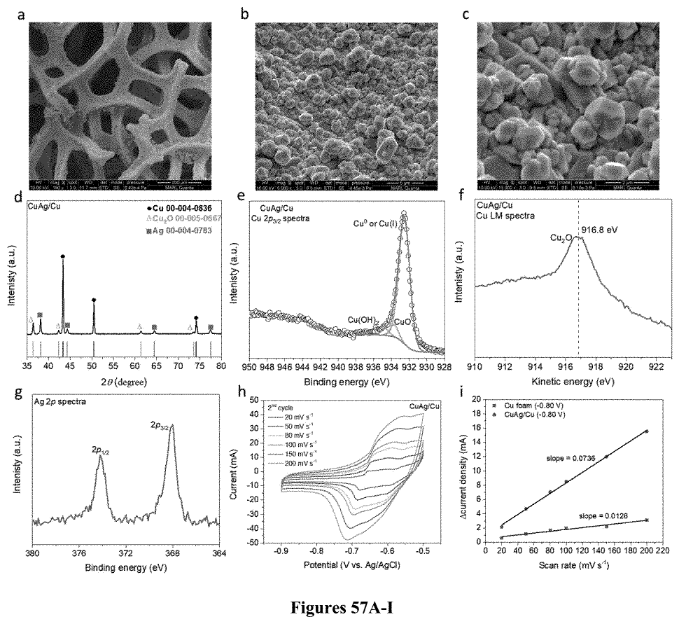

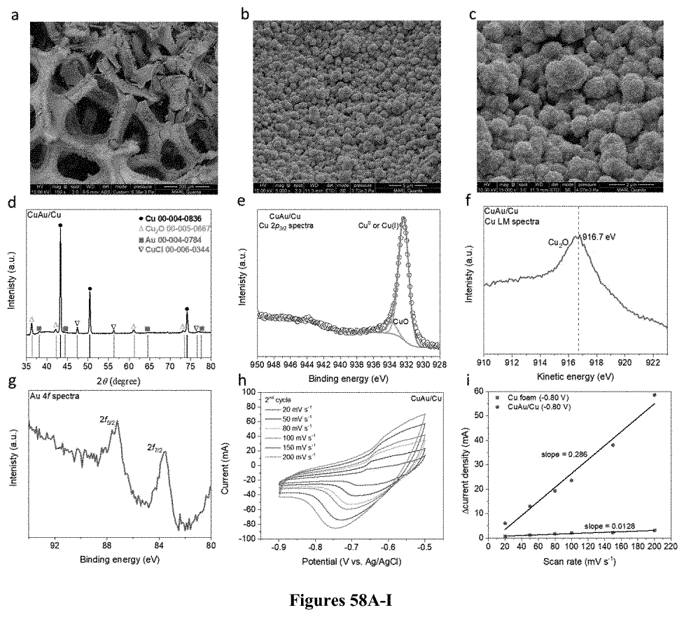

The bimetallic Cu-M catalysts (M=Ag, Au, Pd, and Pt) were prepared through a galvanic replacement method (FIG. 48A). Pre-cleaned Cu foam was immersed in the precursor solutions of metal M under sonication to form CuM/Cu bimetals. FIGS. 48A-H shows the synthesis and characterization results of the CuPt/Cu electrode. The control samples, including CuAg/Cu, CuAu/Cu, and CuPd/Cu, were also prepared, characterized, and evaluated, with details shown in FIGS. 52A-E, FIGS. 53A-E, FIGS. 54A-E, FIGS. 55A-E, FIGS. 56A-I, FIGS. 57A-I, FIGS. 58A-I, and FIGS. 59A-I.

Scanning electron microscope (SEM) images (FIG. 48B and FIG. 48E) showed the morphology transformation from a smooth Cu surface to a highly roughed, nano-sized surface after galvanic replacement under sonication. SEM-energy dispersive X-ray spectroscopy (EDS) analysis (FIGS. 52A-E, FIGS. 53A-E, FIGS. 54A-E, FIGS. 55A-E) showed the homogeneous distribution of M atoms on Cu foam, and a considerable amount of oxygen associated with Cu, indicating the formation of copper oxides on the surface. Double-layer capacitance (Cal) was further measured to assess the roughness of each Cu-M material and then normalized to the plain Cu foam. FIGS. 56A-I, FIGS. 57A-I, FIGS. 58A-I, and FIGS. 59A-I indeed suggested a significant increase in the roughness factor (RF) in four kinds of Cu-M bimetals: CuPt/Cu (4.75±0.18), CuAg/Cu (4.76±0.88), CuPd/Cu (13.1), and CuAu/Cu (22.3). These RF values can be applied to normalize the geometric current density and compare intrinsic activities among different bimetals (details shown infra).

X-ray Diffraction (XRD), X-ray photoelectron spectroscopy (XPS), and high-resolution transmission electron microscopy (HR-TEM) were further carried out to analyze the crystallographic structure and electronic properties of the bimetallic catalysts. XRD analysis on CuPt/Cu suggested the polycrystal Cu and Cu₂O (FIG. 48C). A minor intensity of the CuCl phase originates from incorporating chloride in the HPtCl₄ precursor into Cu. The slight peak shifts on Cu₂O to lower degrees indicated the formation of Cu—Pt alloys, and the disappearance of Pt peaks is probably because of its alloying with Cu (Zhang et al., “Platinum-copper Single Atom Alloy Catalysts with High Performance Towards Glycerol Hydrogenolysis,” Nat. Commun. 10(1):1-12 (2019); Clark et al., “Electrochemical CO2 Reduction Over Compressively Strained CuAg Surface Alloys with Enhanced Multi-carbon Oxygenate Selectivity,” J. Am. Chem. Soc. 139(44):15848-15857 (2017); which are hereby incorporated by reference in their entirety). Furthermore, in the deconvoluted Cu 2p_{3/2} spectra from XPS (FIG. 56E), a dominating peak was observed at the binding energy of 932.6 eV, representing the signals of Cu(0)/Cu₂O (Biesinger, M. C., “Advanced Analysis of Copper X-ray Photoelectron Spectra,” Surf Interface Anal. 49(13):1325-1334 (2017), which is hereby incorporated by reference in its entirety). Two minor peaks at 933.6 eV and 934.8 eV correspond to CuO and Cu(OH)₂, respectively (Biesinger, M. C., “Advanced Analysis of Copper X-ray Photoelectron Spectra,” Surf Interface Anal. 49(13):1325-1334 (2017), which is hereby incorporated by reference in its entirety). Auger electron spectra (AES) of Cu LM with a kinetic energy peak at 916.4 eV suggested the surface is dominated by Cu₂O species (FIG. 48D). Pt 4f spectra are undiscernible from XPS owing to their overlapping with the Cu 3p signal and the much stronger Cu 3p intensity than Pt 4f High-resolution scanning transmission electron microscopy (HR-STEM) images showed the lattice spacing of Cu₂O and Pt, in line with the calculated lattice spacing from the Fast Fourier Transform (FFT) (FIGS. 48F-G). High-angle annular dark-field STEM (HAADF-STEM X-ray energy dispersive spectroscopy (EDS) elemental mapping further suggests the uniform dispersion of Pt on the Cu substrate (FIG. 48H).

Similar characterizations were carried out in other bimetallic catalysts (FIGS. 57A-I, FIGS. 58A-I, and FIGS. 59A-I). XRD suggests the co-existence of Cu, M (i.e., Ag, Au, or Pd), and Cu₂O phases in all samples. The much broader M peaks than Cu indicate the M domains/crystallites are small. No evidence of alloy formation was observed in the CuAg/Cu sample because of nearly no shift in Cu diffraction peaks (FIG. 57D), which agreed well with previous observations (Liu et al., “Ultra-Low Voltage Bipolar Hydrogen Production from Biomass-Derived Aldehydes and Water in Membrane-Less Electrolyzers,” Energy Environ. Sci. 15:4175-4189 (2022), which is hereby incorporated by reference in its entirety). The appearance of peak shoulders or significant skews to the right in CuAu/Cu (FIG. 58D) and CuPd/Cu (FIG. 59D) indicated the incorporation of Au/Pd into Cu domains and the formation of alloys. The observation of alloys on CuPd, CuAu, and CuPt but not on CuAg is due to their more favorable mixability between two metal atoms, which is supported by the phase diagram of Cu-based alloys (Popov et al., “Experimental Redetermination of the Cu—Pd phase Diagram,” J. Alloys Compd. 777:204-212 (2019); Kawecki et al., “Fabrication, Properties and Microstructures of High Strength and High Conductivity Copper-silver Wires,” Arch. Metall. Mater. 57:1261-1270 (2012); Abe et al., “Thermodynamic Assessment of the Cu—Pt System,” J. Phase Equilibria Diffus. 27(1):5-13 (2006); Ravi and Paul, “Diffusion Mechanism in the Gold-copper System,” J. Mater. Sci. Mater. 23(12):2152-2156 (2012); which are hereby incorporated by reference in their entirety). In addition, similar to CuPt/Cu, XPS on all bimetals showed the Cu₂O-dominated surfaces, and M existed as its metallic chemical state.

The above characterization results suggested the galvanic replacement methods indeed etched and oxidized the Cu surface, resulting in a significant increase of surface area and a well-dispersion of small domains of metal M on the Cu₂O-rich surface. In addition to the thermodynamic driving force between Cu and M, the synthesis condition of sonication was also found to be important to increasing substrate surface areas. The synthesis of highly roughed bimetals reported herein has simplified the preparation procedures as compared to previous works (Chen et al., “Efficient Conversion of Low-concentration Nitrate Sources Into Ammonia on a Ru-dispersed Cu Nanowire Electrocatalyst,” Nat. Nanotechnol., 1-9 (2022); Wang et al., “Efficient Electrosynthesis of N-propanol From Carbon Monoxide Using a Ag—Ru—Cu Catalyst,” Nat. Energy 7(2):170-176 (2022); Lv et al., “Electron-deficient Cu Sites on Cu3Ag1 Catalyst Promoting CO₂ Electroreduction to Alcohols,” Adv. Energy Mater. 10(37):2001987 (2020); Gao et al., “Selective C—C Coupling in Carbon Dioxide Electroreduction Via Efficient Spillover of Intermediates as Supported by Operando Raman Spectroscopy,” J. Am. Chem. Soc. 141(47):18704-18714 (2019); Sanghez de Luna et al., “AgCu Bimetallic Electrocatalysts for the Reduction of Biomass-Derived Compounds,” ACS Appl. Mater. Interfaces 13(20):23675-23688 (2021); which are hereby incorporated by reference in their entirety): in those cases, a high-surface-area Cu substrate was firstly synthesized by various methods (e.g., electrodeposition, electro-anodizing, sputtering), followed by the galvanic replacement treatment in a precursor solution for placement in a certain time period without sonication.

2. Electrocatalytic EOD Performance

The EOD performance (RXN 1, supra) on CuM/Cu catalysts was investigated in a standard three-electrode H-type cell. The as-synthesized CuM/Cu was first held at −0.1 V_{RHE} for 3 min to reduce surface Cu₂O back to metallic Cu in the furfural-containing electrolyte. Linear sweep voltammetry (LSV) was performed with and without furfural in 1.0 M KOH. As shown in FIG. 49A, the EOD reaction with apparent current densities is mainly dominated in the potential range of 0.1-0.5 V_{RHE} on five Cu-based electrodes. The further positive shift of the anodic potentials would oxidize Cu to its oxides and trigger the electrocatalytic oxidation (ECO) of furfural without H₂ evolution (RXN 2, supra) (Liu et al., “Ultra-Low Voltage Bipolar Hydrogen Production from Biomass-Derived Aldehydes and Water in Membrane-Less Electrolyzers,” Energy Environ. Sci. 15:4175-4189 (2022), which is hereby incorporated by reference in its entirety). The current density profiles (without stirring of anolyte) show the EOD activity on different bimetallic electrodes, following the order of CuPt/Cu>CuAu/Cu>CuPd/Cu>CuAg/Cu, much higher than that of Cu foam (FIG. 49A).

EOD activity on CuM/Cu electrodes was further tested at static electrolysis conditions at different anodic potentials (FIGS. 49B-E). H₂ was quantified by online gas chromatography (GC, FIG. 49B), and 2-FA and furfural alcohol were quantified by offline high-performance liquid chromatography (HPLC). The FEs of 2-FA and H₂ are defined as the moles of 2-FA or 2 times of moles of H₂ produced divided by the total moles of electrons applied. It is noted that the reported FE of 2-FA from the EOD pathway is calculated after subtracting 2-FA co-produced from the non-faradaic Cannizzaro reaction (quantified from the amount of furfuryl alcohol produced, RXN 5 (supra)). With 30-min electrolysis at different potentials, ˜100% FEs of both 2-FA and H₂ was obtained on CuAg/Cu and CuAu/Cu electrodes in the potential range of 0.1-0.4 V_{RHE}. The passed charge (FIGS. 49C-D, right y-axis) increased from 0.1 to 0.4 V_{RHE}, consistent with the LSV trend. These results suggested that EOD is the dominant, sole faradaic reaction under this potential range.

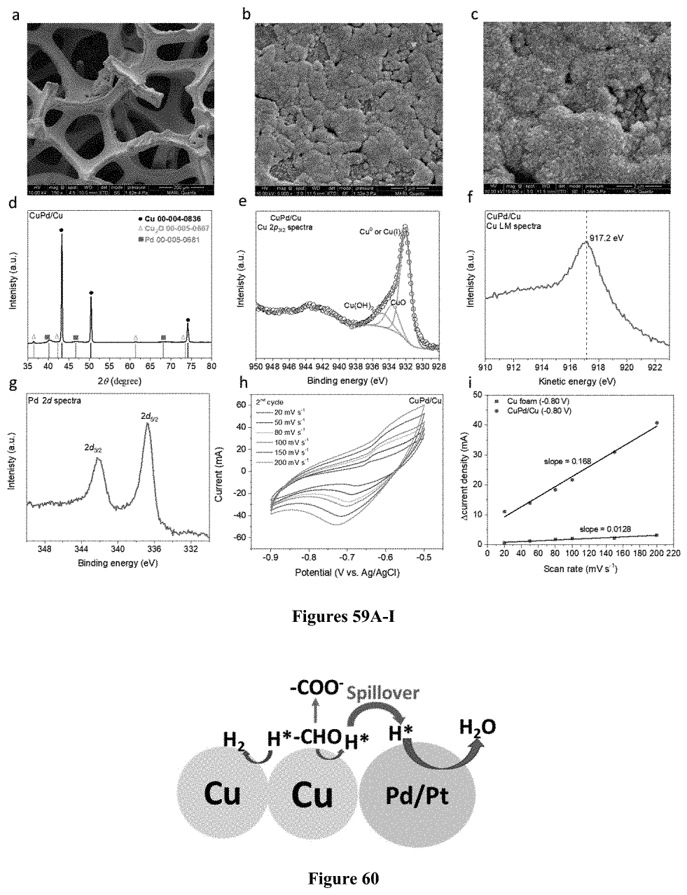

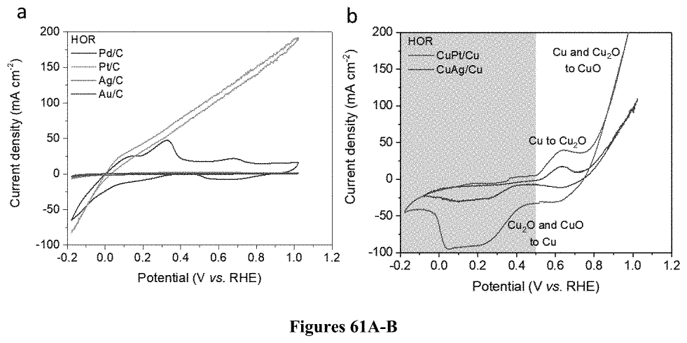

The EOD activity on CuPt/Cu and CuPd/Cu presented a different trend in terms of the FEs of product (FIGS. 49E-F). At 0.1-0.2 V_{RHE}, >95% FEs of 2-FA and H₂ was observed, approaching that on CuAg/Cu and CuAu/Cu electrodes. When the anodic potential ≥0.3 V_{RHE}, a decrease in the FEs of 2-FA and H₂ was observed. The H₂ FE was dropped to ˜70% and ˜50% for CuPt/Cu and CuPd/Cu catalysts, respectively, owing to a hydrogen spillover pathway (FIG. 60). That is, the C—H cleavage along with the aldehyde oxidation to acid occurred on Cu sites; instead of producing H₂ through a Tafel step for self-coupling of adsorbed H (H*) on Cu, certain H* would spill over to the adjacent noble metal sites for its conversion toward H⁺ through a reverse-Volmer step. Additional control experiments (FIG. 61A) on commercial nanoparticles (Pd/C, Pt/C, Au/C, and Ag/C) confirmed the favorable hydrogen oxidation reaction (HOR) toward H⁺ on noble metals (i.e., Pd/C and Pt/C) even under low anodic potentials (e.g., 0-0.4 V_{REH}), while HOR was suppressed on Ag/C and Au/C, in line with the FE trend of EOD on those four Cu-M bimetals and the proposed hydrogen spillover mechanism. The oxidation of H* to H⁺ can be minimized by negatively shifting the anodic potential, in accordance with our experimental observation of high H₂ FE (>95%) for EOD on CuPt/Cu and CuPd/Cu at 0.1 and 0.2 V_{RHE}. Besides, this H* oxidation to H⁺ on noble metal sites mainly occurred through the surface diffusion of H* at local regions, rather than the reabsorption of the EOD-produced H₂ for its further oxidation through HOR. This can be supported by the control experiment of the inactive nature of Cu-M catalysts (e.g., CuPt/Cu) for HOR, particularly in the potential range of 0-0.4 V_{REH} with excessive H₂ supply (100 mL min-s, FIG. 61B).

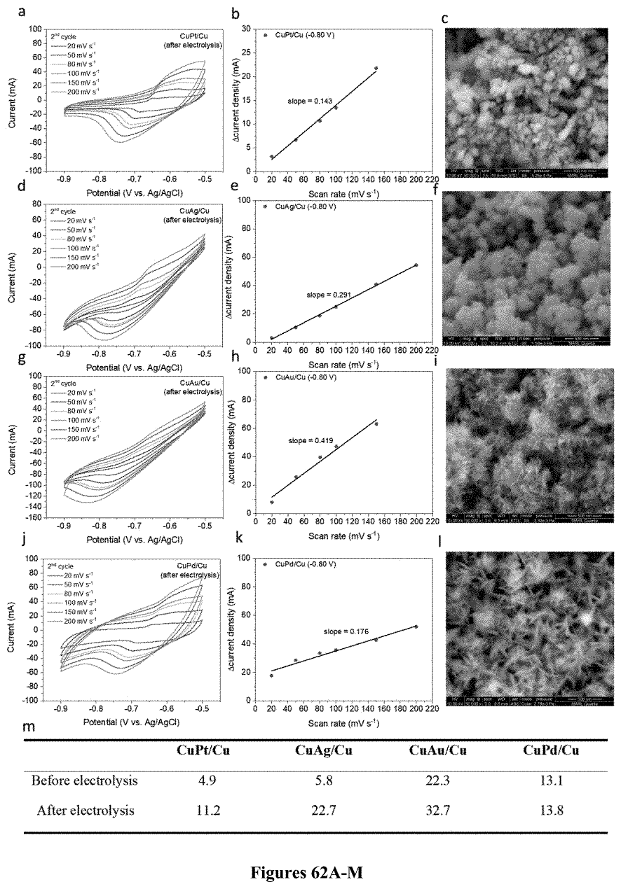

Additionally, during EOD, the dynamic surface reconstruction rearranged the lattice of the Cu-M catalysts and maintained the high-surface-area porous structure. SEM images (FIGS. 62A-M) show a significant morphology transformation after a half-hour EOD at 0.2 V_{RHE}. For instance, the surface morphology of the CuAu/Cu and CuPd/Cu catalysts was changed from spherical nanoparticles to nanosheets. Interestingly, post-electrolysis characterizations showed that those electrochemically induced surface reconstructions caused an increase in their surface roughness (FIGS. 62A-M), which could be beneficial for stabling the EOD performance. These dynamic surface morphology changes are driven by the significant mobility of Cu and M at room temperature and the anodic biasing during EOD. A similar observation of dynamic surface reconstruction of catalysts with an enhancement in electrocatalytic activity has been observed in recent works on different electrochemical reactions, such as NO₃⁻-to-NH₃ (Chen et al., “Efficient Conversion of Low-concentration Nitrate Sources into Ammonia on a Ru-dispersed Cu Nanowire Electrocatalyst,” Nat. Nanotechnol. 1-9 (2022); Li et al., “Reconstruction-induced NiCu-based Catalysts Towards Paired Electrochemical Refining,” Energy Environ. Sci. 15(7):3004-3014 (2022); which are hereby incorporated by reference in their entirety), OER (Zhao et al., “An Anionic Regulation Mechanism for Structural Reconstruction of Sulfide Electrocatalysts Under Oxygen Evolution Conditions,” Energy Environ. Sci. (2022), which is hereby incorporated by reference in its entirety).

3. Strong Synergistic Effects on CuPt/Cu Catalyst

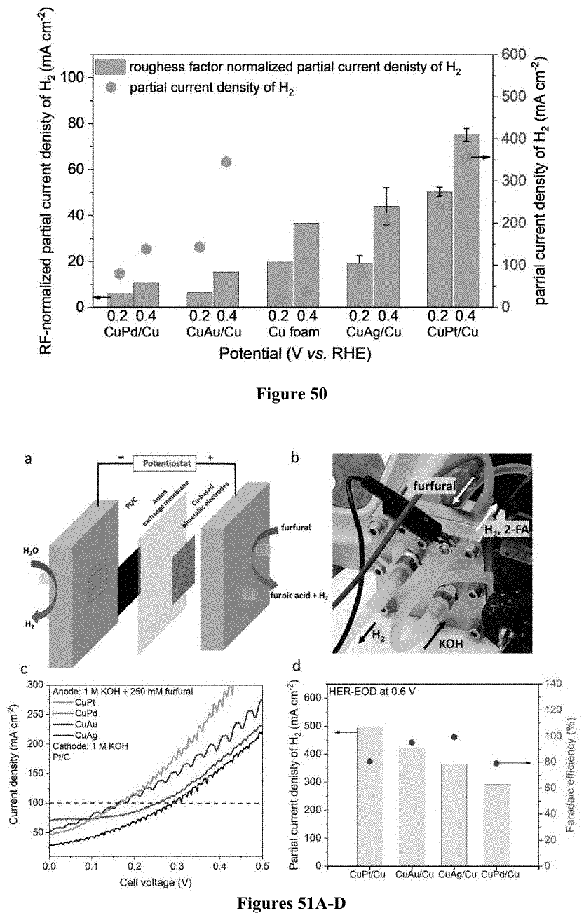

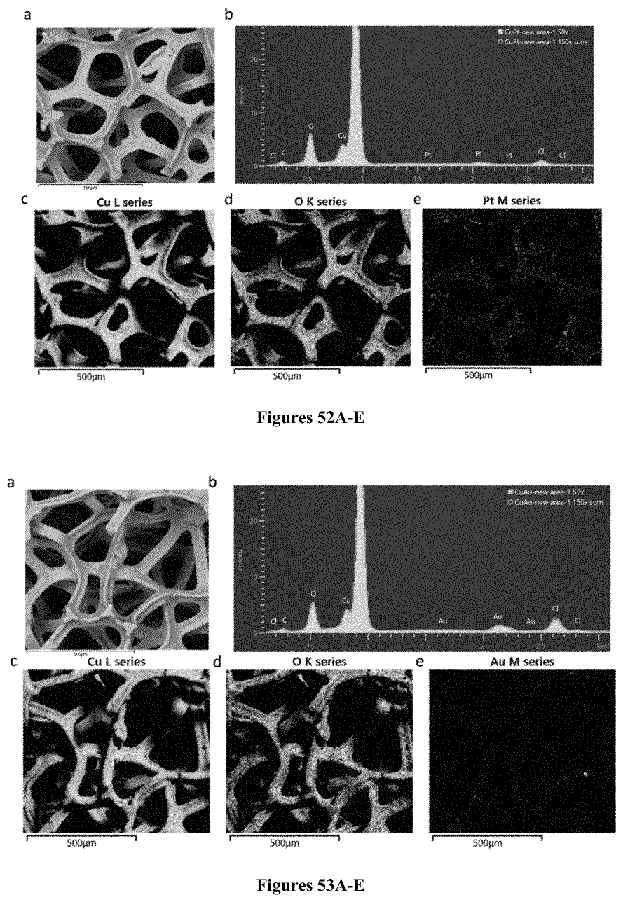

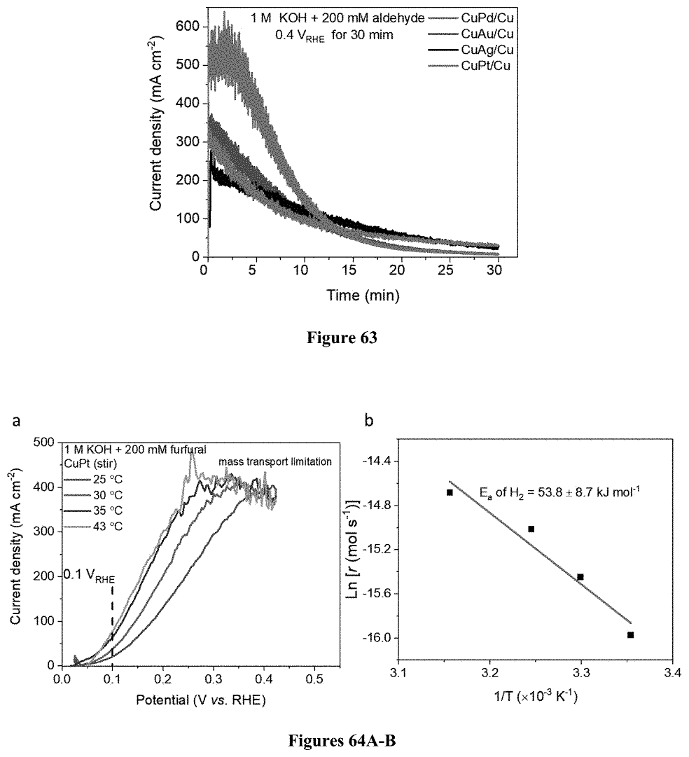

Despite a slight H₂ FE decrease on the CuPt/Cu catalyst, especially at more positive potentials, the key advantage of CuPt/Cu is its strong synergistic effect between Cu and Pt for EOD. In terms of the j_{A-H}_{₂}, CuPt/Cu showed the highest values of 239 and 357 mA cm⁻² at 0.2 and 0.4 V_{RHE}, respectively, among all four CuM/Cu catalysts (FIG. 50 right y-axis). It is worth noting that the partial current density at the early stage of steady-state EOD (i.e., 3 min) was accounted for to avoid the mass transport limitation, which resulted from the furfural consumption during electrolysis in the batch reactor (15 mL) that caused a gradual decrease in the current density (FIG. 63). Moreover, electrokinetic studies were carried out and the apparent activation energy (Eₐ) was fitted on CuPt/Cu electrode to be 53.8±8.7 kJ mol⁻¹ at 0.1 V_{RHE}, by changing the temperature between 25 to 43° C. (FIGS. 64A-B).

To compare the intrinsic activities of the catalysts considering their distinct surface areas, j_{A-H}_{₂} was normalized to roughness factor (i.e., RF-j_{A-H}_{₂}) (FIG. 50 left y-axis). Importantly, CuPt/Cu with the lowest roughness factor (i.e., 4.75±0.18) displayed the highest RF-j_{A-H}_{₂} at both 0.2 and 0.4 V_{RHE}, following the order of CuPt/Cu>CuAg/Cu>Cu foam >CuAu/Cu>CuPd/Cu. Supported by previous DFT calculation of EOD pathway on different metals (Liu et al., “Ultra-Low Voltage Bipolar Hydrogen Production from Biomass-Derived Aldehydes and Water in Membrane-Less Electrolyzers,” Energy Environ. Sci. 15:4175-4189 (2022), which is hereby incorporated by reference in its entirety), it was proposed that the strong synergistic effects on CuPt/Cu catalyst take advantage of the favorable furfural binding on Pt sites with a binding energy of −2.11 eV compared to that on Cu (−1.06 eV) and other metals (e.g., Au, −0.96 eV), and the favorable C—H cleavage on Cu sites as opposed to that on Pt (limited by CO poisoning) and Au (limited by slow C—H activation). Besides, the CuAu/Cu showed a high absolute j_{A-H}_{₂} because of its highest surface roughness (RF=22.3) among four bimetallic catalysts. However, the RF-j_{A-H}_{₂} on CuAu and CuPd is greatly minimized and lower than that on Cu foam, resulting from the inactive EOD property on Au and Pd metals (Liu et al., “Ultra-Low Voltage Bipolar Hydrogen Production from Biomass-Derived Aldehydes and Water in Membrane-Less Electrolyzers,” Energy Environ. Sci. 15:4175-4189 (2022), which is hereby incorporated by reference in its entirety). In such a manner, the incorporation of Au and Pd occupied surface Cu sites, leading to a decrease in EOD performance and lower than that on a monometallic Cu surface (i.e., Cu foam). In contrast, CuAg/Cu exhibited a second high RF-j_{A-H}_{₂} because of the catalytic EOD activity on both Cu and Ag metals, but the lower j_{A-H}_{₂} and RF-j_{A-H}_{₂} on CuAg than that on CuPt could be due to the minimal synergistic effect between Cu and Ag. It is worth noting that the experimentally screening of different metals for EOD was also reported in our previous work metals (Liu et al., “Ultra-Low Voltage Bipolar Hydrogen Production from Biomass-Derived Aldehydes and Water in Membrane-Less Electrolyzers,” Energy Environ. Sci. 15:4175-4189 (2022), which is hereby incorporated by reference in its entirety). These results clearly demonstrated that the superior EOD performance on CuPt/Cu is not only from its high surface area, but also from the synergistic effects of Cu and Pt with higher intrinsic activity.

4. Bipolar H₂ Production Flow Systems

Based on the facile EOD kinetics on Cu-based electrodes and the optimized bimetal combinations, an MEA-based flow cell for bipolar H₂ production was implemented (FIGS. 51A-B). The MEA contained a Pt/C cathode, an anion exchange membrane (AEM, Tokuyama A201), and a CuM/Cu anode in a zero-gap configuration. 1.0 M KOH with and without furfural was used as the anolyte and catholyte, respectively, with each volume of 250 mL.

LSV measurement of the HER-EOD paired bipolar H₂ production displayed ultra-low cell voltages (FIG. 51C). At the current density of 100 mA cm⁻, the cell voltages are below 0.3 V for all four Cu-based bimetals, following the order of CuPt/Cu<CuAu/Cu<CuPd/Cu<CuAg/Cu. At steady-state electrolysis at 0.6 V (FIG. 51D), the j_{A-H}_{₂} attained 498 mA cm⁻¹ on CuPt/Cu electrode, with anodic H₂ FE of 80.5%. These high performances benefit from the facile EOD kinetics on Cu-based bimetals and the largely facilitated mass transport by flow cell implementation. The observed ultra-low cell voltages and industrial-relevant current densities for bipolar H₂ production with valuable 2-FA co-producing have outperformed recently reported values (Wang et al., “Combined Anodic and Cathodic Hydrogen Production from Aldehyde Oxidation and Hydrogen Evolution Reaction,” Nat. Catal. 5(1):66-73 (2022), which is hereby incorporated by reference in its entirety). Besides, this work's cell voltages and current densities are also superior to conventional ECO-HER paired systems (e.g., organic ECO-HER (Yang et al., “Interfacial Engineering of MoO2-FeP Heterojunction for Highly Efficient Hydrogen Evolution Coupled with Biomass Electrooxidation,” Adv. Mater. 32(17):2000455 (2020); Wang et al., “Regulating the Local Charge Distribution of Ni Active Sites for the Urea Oxidation Reaction,” Angew. Chem. 133(19):10671-10676 (2021); Zhang et al., “Coupling Glucose-Assisted Cu (I)/Cu (II) Redox with Electrochemical Hydrogen Production,” Adv. Mater. 33(48):2104791 (2021); Zhao et al., “Raw Biomass Electroreforming Coupled to Green Hydrogen Generation,” Nat. Commun. 12(1):1-10 (2021); Geng et al., “Nickel Ferrocyanide as a High-performance Urea Oxidation Electrocatalyst,” Nat. Energy 6(9):904-912 (2021); Liu et al., “Efficient Electrochemical Production of Glucaric Acid and H2 Via Glucose Electrolysis,” Nat. Commun. 11(1):1-11 (2020); which are hereby incorporated by reference in their entirety), inorganic ECO-HER (Qian et al., “Artificial Heterointerfaces Achieve Delicate Reaction Kinetics Towards Hydrogen Evolution and Hydrazine Oxidation Catalysis,” Angew. Chem., 133(11):6049-6058 (2021); Wang et al., “Coupling Electrocatalytic Nitric Oxide Oxidation Over Carbon Cloth with Hydrogen Evolution Reaction for Nitrate Synthesis,” Angew. Chem., 133(46):24810-24816 (2021); Dresp et al., “Efficient Direct Seawater Electrolysers Using Selective Alkaline NiFe-LDH as OER Catalyst in Asymmetric Electrolyte Feeds,” Energy Environ. Sci., 13(6):1725-1729 (2020); which are hereby incorporated by reference in their entirety)) for cathodic H₂ production: in those cases, the cell voltages are >1.0 V with current densities <100 mA cm^{-p}.

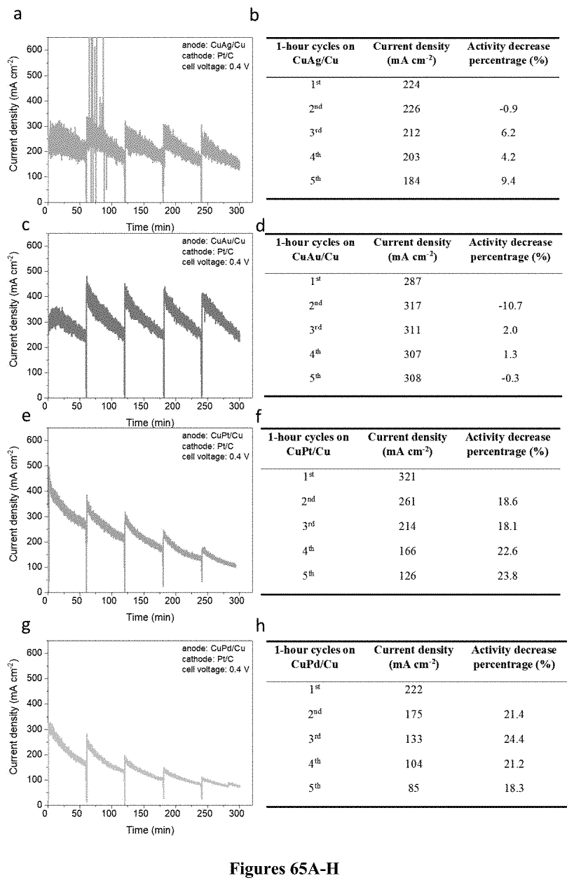

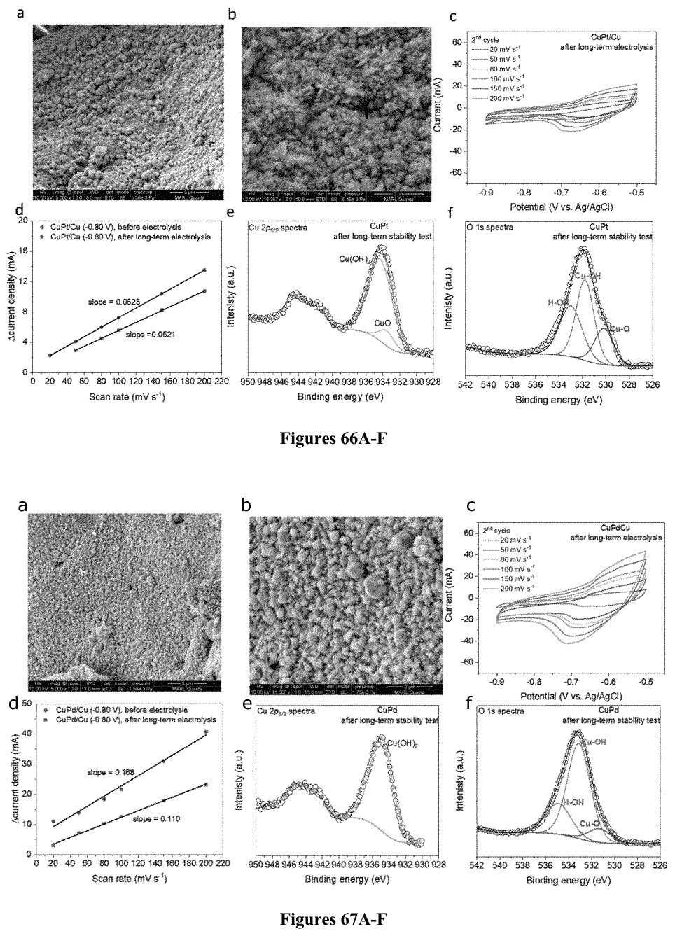

Finally, durability tests were performed for bipolar H₂ production with these bimetallic anodes in the MEA-based flow electrolyzers (FIGS. 65A-H). After 5 successive cycles of 1-hour electrolysis at the cell voltage of 0.4 V, CuAu/Cu showed the best durability with only a 4.5% performance decrease. Indeed, a slight increase in activity was noticed on CuAu/Cu (10.7%) and CuAg/Cu (0.9%) during the second 1-hour cycle, benefiting from the surface reconstruction-induced roughness increase. Relatively poor durability of CuPt/Cu and CuPd/Cu electrodes was observed, which is not because of the surface roughness decrease since RF only showed a slight change after 5-hour electrolysis (FIGS. 66A-F and FIGS. 67A-F). The primary reason for catalysts deactivation could be due to the complete phase transformation of metallic Cu toward Cu(OH)₂ (as supported by XPS Cu 2p and O is spectra in FIGS. 66A-F and FIGS. 67A-F), which is not the reactive phase for EOD (Liu et al., “Ultra-Low Voltage Bipolar Hydrogen Production from Biomass-Derived Aldehydes and Water in Membrane-Less Electrolyzers,” Energy Environ. Sci. 15:4175-4189 (2022), which is hereby incorporated by reference in its entirety).

Conclusion

In summary, this work reported a simple galvanic replacement method to prepare Cu-based bimetallic catalysts for EOD toward practical rate, bipolar H₂ production. Taking advantage of the thermodynamic driving force between Cu and other metals (M), the Cu foam surface can be etched and oxidized, resulting in a significant increase in surface area and a well-dispersion of M. In particular, the CuPt/Cu catalyst has shown a strong synergistic effect for EOD, benefiting from the favorable furfural binding on Pt and the unique C—H cleavage on Cu. In this regard, a j_{A-H}_{₂} of 357 mA cm⁻² at 0.4 V_{RHE} has been achieved in the batch reactor and 498 mA cm⁻² at the cell voltage of 0.6 V in the MEA-based flow electrolyzer. This work presented ultra-low cell voltages and industrial-current densities toward bipolar H₂ generation in a sustainable manner, with the co-production of valuable carboxylic acid, which will bring exciting new opportunities for distributed manufacturing of green hydrogen and carbon chemicals with low energy consumption and low carbon footprint in the future.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A system for generating hydrogen (H-z) from an aldehyde, said system comprising:
an anode comprising a metal-based alloy catalyst;
a cathode comprising Ni₂P or Pt/C; and
a separator positioned between the anode and the cathode.

2. The system according to claim 1, wherein the anode comprises Copper (Cu).

3. The system according to claim 1 or claim 2, wherein the anode comprises Silver (Ag).

4. The system according to any one of claims 1-3, wherein the anode comprises Copper (Cu) and Silver (Ag).

5. The system according to any one of claims 1-4, wherein the anode comprises CuAg/Cu foam.

6. The system according to claim 1, wherein the anode comprises an alloy of any two or more metals selected from the group consisting of Platinum (Pt), Palladium (Pd), Gold (Au), Copper (Cu), and Silver (Ag).

7. The system according to claim 6, wherein the anode comprises CuPt/Cu foam.

8. The system according to any one of claims 1-7, wherein the separator is a dialysis membrane.

9. The system according to claim 8, wherein the dialysis membrane comprises a pore size of 50 nm to 1 μm.

10. The system according to any one of claims 1-9, wherein the separator comprises an alkaline tolerable material.

11. A method of producing hydrogen (H₂), said method comprising:
providing a system comprising:
an anode comprising a metal-based alloy catalyst;
a cathode comprising Ni₂P or Pt/C; and
a separator positioned between the anode and the cathode and
adding to the system an aldehyde under conditions effective to produce hydrogen (H₂) from electrocatalytic oxidative dehydrogenation of the aldehyde at the anode and water reduction at the cathode.

12. The method according to claim 11, wherein the method is carried out under conditions of an overall electrolytic cell voltage of about 0.5 V at 100 m A/cm².

13. The method according to claim 11 or claim 12, wherein the aldehyde is selected from the group consisting of furfural, 5-hydroxymethylfurfural (HMF), formaldehyde, and acetaldehyde.

14. The method according to any one of claims 11-13, wherein the anode comprises Copper (Cu).

15. The method according to any one of claims 11-14, wherein the anode comprises Silver (Ag).

16. The method according to any one of claims 11-15, wherein the anode comprises Copper (Cu) and Silver (Ag).

17. The method according to any one of claims 11-16, wherein the anode comprises CuAg/Cu foam.

18. The method according to any one of claims 11-13, wherein the anode comprises an alloy of any two more metals selected from the group consisting of Platinum (Pt), Palladium (Pd), Gold (Au), Copper (Cu), and Silver (Ag).

19. The method according to claim 18, wherein the anode comprises CuPt/Cu foam.

20. The method according to any one of claims 11-19, wherein the separator is a dialysis membrane.

21. The method according to claim 20, wherein the dialysis membrane comprises a pore size of 50 nm to 1 μm.

22. The method according to any one of claims 11-21, wherein the separator comprises an alkaline tolerable material.
